(19) United States
(12) Patent Application Publication
(10) Pub. No.: US 2002/0048268 A1
(43) Pub. Date: Apr. 25, 2002

(54) Wireless local loop system supporting voice/IP

(75) Inventors: Narayan P. Menon, Colorado Springs, CO (US); Izzet M. Bilgic, Colorado Springs, CO (US); Steven D. Ledsham, Colorado Springs, CO (US); Ismail I. Sola, Colorado Springs, CO (US)

Correspondence Address: Siemens Corporation, Intellectual Property Department, 186 Wood Avenue South, Iselin, NJ, 08830, US

(73) Assignee: OPUSWAVE NETWORKS, INC.

(21) Appl. No.: 09/855,988

(22) Filed: May 15, 2001

Related U.S. Application Data
(63) Continuation of application No. 09/219,539, filed on Dec. 23, 1998.

(51) Int. Cl. H04L 12/56

(52) U.S. Cl. 370/349; 370/352

(57) ABSTRACT

A telecommunications network supporting wireless access to one or more public packet data networks, including, but not limited to, the Internet, and to one or more public switched circuit networks, for example, but not limited to, the Public Switched Telephone Network (PSTN). A voice access unit, for example, a telephone, may be connected to a Customer Premise Radio Unit (CPRU) via a wireline interface. The CPRU provides the voice access unit over-the-air, i.e., radio, access to one or more public switched circuit networks. A computing device, for example, a personal computer, may also, or in the alternative, be connected to a CPRU via a wireline interface. The CPRU provides the personal computer over-the-air access to one or more public packet data networks. A facsimile device may also, or in the alternative, be connected to a CPRU via-a wireline interface. The CPRU provides the facsimile device over-the-air access to one or more public switched circuit networks.

The telecommunications network comprises a base station which provides wireless access for CPRUs to one or more public packet data networks and/or public switched circuit networks. The telecommunications network further comprises a Wireless Adjunct InteRnet Platform (WARP), which supports functionality of known base stations. The telecommunications network also comprises one or more access routers, H.323 gateways, H.323 gatekeepers, Internet gateways and fax gateways for supporting subscriber access to public packet data networks and public switched circuit networks.

### FIELD OF THE INVENTION

A telecommunications system, and, more specifically, a system supporting wireless access to public data networks and public switched circuit (telephony) networks.

### DESCRIPTION OF THE TECHNOLOGY

Generally, known telecommunication systems that have attempted to provide both packet data and voice services have used the concept of an overlay network. More specifically, in known communication systems, a network supporting packet data has been overlaid on top of an already existing base system that supports voice. In this manner, voice and packet data transport, i.e., transmissions, follow separate paths beyond a point in the network, e.g., from a base station onwards.

Known systems transmit voice in a circuit-switched mode and packet data in a packet switched mode. In packet switched mode, information is sent in many sections, or packets, over one or more physical transmission routes, and is thereafter reassembled at the receiving end. Because information is sent in packets, transmission resources, e.g., physical transmission interfaces, can be shared among more than one user and/or among more than one data stream at a time.

In contrast, in circuit-switched mode, there is generally a single unbroken connection between the sender and receiver of the voice stream, or transport. In circuit-switched mode, a voice transport is not divided and transmitted in sections, and, thus, once a transmission connection is made to a network, e.g., as for a telephone call, even if there is no voice transport at a particular time, e.g., when a call is on hold, the physical connection remains exclusively dedicated to that transmission, to the exclusion of all other users of the system.

Thus, in known telecommunication systems that attempt to support both packet data and voice, generally resources are either dedicated to packet data support or, alternatively, they are dedicated to voice support. Moreover, in such known systems, resources may be consumed by voice support to the exclusion of packet data. Too, such systems do not integrate packet data and voice support throughout the system, and thus, require the addition of resources to support the added service, e.g., packet data, which is overlaid on the original base system, e.g., voice.

Further, because known systems are switched circuit, i.e., voice, centric, generally end-to-end circuits are assigned for both voice and packet data transmissions. This reduces the flexibility of the system to handle multiple users accessing both switched circuit and packet data services at the same time. Further, such systems have no capability for supporting a “best transmit path” between various sub-components in the network in an end-to-end communication. In such systems, a single communication path, end-to-end, is established for a communication flow, voice or data. Alternative paths between components of the network that could provide better quality or faster transmission for a particular message, voice or data, are not explored or utilized in these systems.

Also, known systems are entirely wireline, or land based, requiring additional infrastructure to provide both voice and packet data support. Too, with systems that are entirely land based, geographic considerations limit where the various components of the network can be located relative to one another.

Thus, it would be advantageous to provide an integrated, flexible wireless system that supports both packet data and voice. Further, it would be advantageous to provide an integrated voice/packet data system based on the Internet protocols that support equivalent message flow handling for voice and packet data throughout the network. Too, it would be advantageous to provide an integrated voice/packet data system that supports both cost-effective packet data services, e.g., for Internet access, and cost-effective switched circuit services, e.g., for access to existing switched circuit (telephony) networks.

### SUMMARY OF THE INVENTION

The invention provides apparatus and mechanisms for furnishing, in an end-to-end fashion, a telecommunications system supporting wireless access that can handle both packet data and voice transmissions.

In an embodiment, a voice access unit, a facsimile device and/or a computing unit are connected to a radio unit that itself provides over-the-air access to a wireless access network. The wireless access network, for its part, provides access to one or more packet data networks and to one or more switched circuit networks.

The computing device is capable of receiving packet data. The voice access device is capable of receiving voice messages. The voice access device is connected to the radio unit in order to receive a voice message transmitted from the wireless access network. The facsimile device is capable of receiving facsimile messages. Like the voice access device, a facsimile device is connected to the radio unit in order to receive a facsimile message transmitted from the wireless access network.

In an embodiment, the wireless access network supports both switched circuit message transmissions and packet data message transmissions to a subscriber of the network. The wireless access network comprises a protocol for packet data message transmissions from a packet data network to a subscriber. The wireless access network also comprises a protocol for voice message transmissions from a switched circuit network to a subscriber. The wireless access network also comprises a protocol for facsimile message transmissions from a switched circuit network to a subscriber.

The wireless access network comprises various network components, including, but not limited to, a base station and a Wireless Adjunct inteRnet Platform (WARP).

Therefore, a general object of the invention is to provide a wireless based telecommunications system that supports access to both packet data services and voice services. A further general object of the invention is to provide a cost effective seamless wireless access network for handling both packet data and voice transports, or transmissions. Other and further objects, features, aspects and advantages of the invention will become better understood with the following detailed description of the accompanying drawings.

### BRIEF DESCRIPTION OF THE DRAWINGS

FIG. 1 is an embodiment wireless access network.

FIG. 2 depicts the transmission path between an H.323 endpoint and an H.323 gatekeeper.

FIG. 3 depicts the procedures executed between an H.323 gatekeeper and an H.323 endpoint.

FIG. 4 depicts the IP voice procedures supported by a wireless access network.

FIG. 5 is an alternative embodiment wireless access network.

FIG. 6 depicts the services of a wireless access network.

FIG. 7 depicts various mechanisms employed as part of the security services of a wireless access system.

FIG. 8 depicts an embodiment of an accounting architecture for use in a wireless access network.

FIG. 9 depicts management platforms within the management structure of a wireless access network.

FIG. 10 depicts the Subscriber Management Platform procedures supported by a wireless access network.

FIG. 11 depicts the terminal authentication network elements in a wireless access network.

FIG. 12 depicts a hierarchy of management platforms within the management structure of a wireless access network.

FIG. 13 depicts a generic management protocol architecture protocol for management of a network node in a wireless access network.

FIG. 14 depicts an embodiment Base Station System (BSS) management architecture for a wireless access system.

FIG. 15 depicts an embodiment BSS management protocol architecture.

FIG. 16 depicts an embodiment terminal management architecture.

FIG. 17 depicts an embodiment Customer Premise Radio Unit (CPRU) management protocol architecture.

FIG. 18 depicts the communication protocol planes in a wireless access network.

FIG. 19 depicts procedures executed in the packet data signaling plane of a wireless access network.

FIG. 20 depicts procedures executed in the voice/fax signaling plane of a wireless access network.

FIG. 21 depicts an embodiment packet data signaling plane architecture.

FIG. 22 depicts Logical Link Control (LLC) procedures supported in a signaling plane of a wireless access network.

FIG. 23 depicts Terminal Management Protocol (TMP) procedures supported in a wireless access network.

FIG. 24 depicts an alternative embodiment packet data signaling plane architecture.

FIG. 25 depicts an embodiment packet data bearer plane architecture.

FIG. 26 depicts LLC procedures supported in a bearer plane of a wireless access network.

FIG. 27 depicts an alternative embodiment packet data bearer plane architecture.

FIG. 28 depicts an embodiment voice/fax signaling plane architecture.

FIG. 29 depicts an alternative embodiment voice/fax signaling plane architecture.

FIG. 30 depicts an embodiment voice bearer plane architecture.

FIG. 31 depicts an alternative embodiment voice bearer plane architecture.

FIG. 32 depicts an embodiment fax bearer plane architecture.

FIG. 33 depicts an alternative embodiment fax bearer plane architecture.

### DESCRIPTION OF THE PREFERRED EMBODIMENTS

### Related Patent Applications

U.S. patent application Ser. No. 09/128,553 entitled “Plug And Play Wireless Architecture Supporting Packet Data And IP Voice/Multimedia Services” is related to this application, as both concern wireless telecommunications systems. U.S. patent application Ser. No. 09/128,553 is included herein by reference, in its entirety, for all that is disclosed therein.

### Wireless Access System

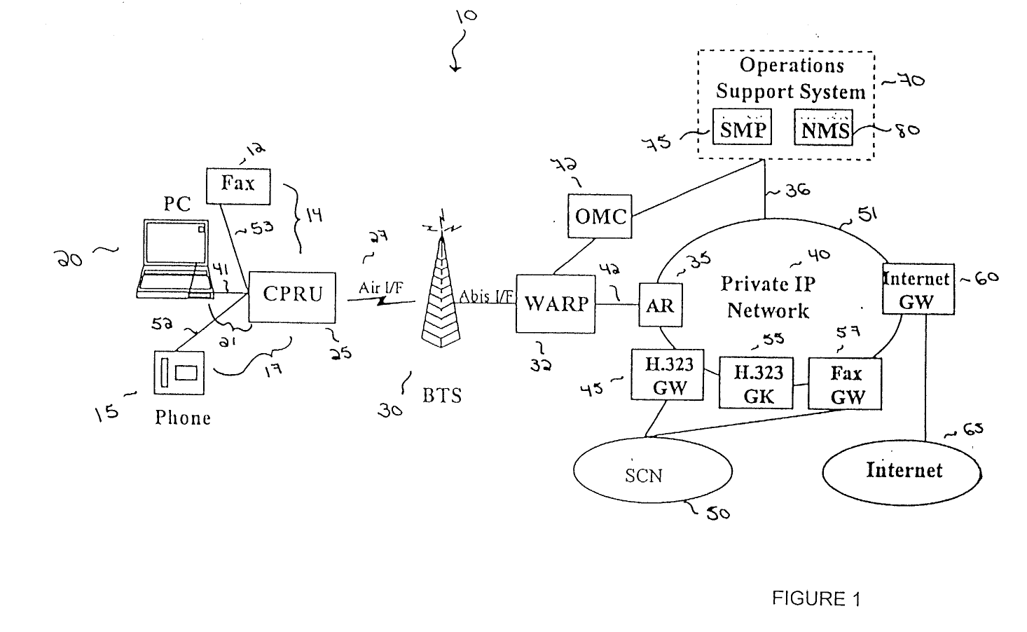

An embodiment of a system, or network, 10 for supporting wireless access to one or more external data networks, for example, but not limited to, the Internet, and to one or more external switched circuit networks, for example, but not limited to, a Public Switched Telephone Network (PSTN), is shown in FIG. 1. In an embodiment, the network 10 comprises a wide area network (WAN). In an embodiment, the system 10 comprises four sub-networks.

The first sub-network is a core packet data network. In an embodiment, the core packet data network is comprised of one or more computing devices 20, for example, but not limited to, personal computers (PCs), smart terminals, work stations or any combination thereof. In an embodiment, the core packet data network is also comprised of one or more Customer Premise Radio Units (CPRUs) 25. In an embodiment, a network subscriber terminal 21, or simply terminal 21, comprises a PC and a CPRU 25.

In an embodiment, the core packet data network also comprises one or more base transceiver stations (BTSs) 30, also referred to as base stations. In an embodiment, the core packet data network also comprises one or more Wireless Adjunct inteRnet Platforms (WARPs) 32. In an embodiment, the core packet data network further comprises one or more access routers 35, an Internet Protocol (IP) network 40, for example, but not limited to, a private IP network, a packet data gateway, for example, but not limited to, an Internet gateway 60, and one or more packet data networks, including, the Internet 65.

The second sub-network of the system 10 is an Internet Protocol (IP) packet voice network. In an embodiment, the IP packet voice network comprises one or more voice access devices, for example, but not limited to, telephones 15, one or more CPRUs 25, one or more switched circuit network gateways 45, one or more switched circuit network gatekeepers 55, and one or more external switched circuit networks (SCNs) 50. In an embodiment, a telephone 15 and a CPRU 25 comprise a switched circuit network, or H.323, terminal 17, i.e., a terminal capable of supporting IP packet voice services. In an embodiment, a gateway 45 comprises an H.323 gateway and a gatekeeper 55 comprises an H.323 gatekeeper.

In an embodiment, the IP packet voice network is overlaid on the core packet data network. In this embodiment, the IP packet voice network shares the base station(s) 30, WARP(s) 32, access router(s) 35 and private IP network 40 of the core packet data network.

The third sub-network of the system 10 is an Internet Protocol (IP) facsimile, or fax, network. In an embodiment, the IP fax network comprises one or more facsimile devices 12, one or more CPRUs 25, one or more fax gateways 57 and one or more external switched circuit networks (SCNs) 50. In an embodiment, a facsimile device 12 and a CPRU 25 comprise a fax terminal 14, i.e., a terminal capable of supporting IP fax services.

In an embodiment, the IP fax network is overlaid on the core packet data network. In this embodiment, the IP fax network shares the base station(s) 30, WARP(s) 32, access router(s) 35 and private IP network 40 of the core packet data network.

The fourth sub-network of the system 10 is an Operations Support System (OSS) 70. In an embodiment, the Operations Support System 70 is comprised of a Subscriber Management Platform (SMP) 75 and a Network Management System (NMS) 80. In an embodiment, the Operations Support System 70 is coupled with an Operation and Maintenance Center (OMC) 72, which, among other tasks, is involved in the base station 30 and WARP 32 management support processes.

The computing devices 20, e.g., PCs, the telephones 15 and the facsimile devices 12 of the system 10 each comprise a component, or network node, of the subscriber equipment accessing the wireless access network 10.

To the core packet data network, a terminal 21 appears as an Internet Protocol (IP) destination node. Thus, a terminal 21 has an associated IP address, and supports processing of the termination of the Internet Protocol for data message transmissions within the wireless access network. In an embodiment, a terminal's IP address is dynamically allocated to the CPRU 25 of the respective terminal 21 by the system 10.

To the Internet Protocol (IP) packet voice network, an H.323 terminal 17 appears as an Internet Protocol (IP) destination node. Thus, an H.323 terminal 17 has an associated IP address, and supports processing of the termination of the Internet Protocol for voice message transmissions within the wireless access network 10. In an embodiment, an H.323 terminal's IP address is dynamically allocated to the CPRU 25 of the respective terminal 17 by the system 10.

In an embodiment, to the IP packet voice network, an H.323 terminal 17 acts as a network endpoint. Thus, to support IP packet voice network processing, an H.323 terminal 17 supports the elements necessary for H.323 communication. These elements include an H.323 software protocol stack, for communications processing, vocoding functionality, and line card functionality for the CPRU 25 and respective subscriber telephone 15 interface.

In an embodiment; the vocoding functionality is based on the G.7xx series of recommendations referenced in the H.323 protocol standards. More specifically, in an embodiment, the vocoding functionality is based on one or more of the following standards: the G.711 Pulse Code Modulation (PCM) of voice frequencies standards; the G.722 7 kHz audio-coding within 64 kbits/s standards; the G.723.1 dual rate speech coder for multimedia communications transmitting at 5.3 and 6.3 kbit/s standards; the G.728 coding of speech at 16 kbit/s using low-delay code excited linear prediction standards; and the G.729 coding of speech at 8 kbit/s using conjugate structure algebraic-code-excited linear-prediction (CS-ACELP) standards.

In an embodiment, the H.323 protocol functionality for voice transmissions runs as an application over the core packet data network applications.

To the Internet Protocol (IP) fax network, a fax terminal 14 appears as an Internet Protocol (IP) destination node. Thus, a fax terminal 14 has an associated IP address, and supports processing of the termination of the Internet Protocol for facsimile message transmissions within the wireless access network 10. In an embodiment, a fax terminal's IP address is dynamically allocated to the CPRU 25 of the respective terminal 14 by the system 10.

In an embodiment, the fax protocol functionality uses the same mechanisms for transmission signaling as the IP packet voice network. In an embodiment, IP packet fax message transmissions are supported, or otherwise managed, via the Internet Fax Protocol T.38 standards within the wireless access system 10. In an embodiment, the IP Fax Protocol functionality for facsimile transmissions runs as an application over the core packet data network applications.

A Customer Premise Radio Unit (CPRU) 25 interfaces with one or more computing devices 20, one or more telephones 15, one or more facsimile devices 12 and/or any combination thereof, and provides the functionality for each of these subscriber devices to connect to the wireless access system 10. A CPRU 25 is generally associated with a home or business premise.

In an embodiment, a CPRU 25 interfaces with one or more computing devices 20, for example, but not limited to, e.g., a personal computer (PC), a smart terminal, or a work station, located in or about the respective premise. In an embodiment, a CPRU 25 is connected to the respective computing device(s) 20 via standard wireline cabling 41. A computing device 20 and a CPRU 25 comprise a subscriber terminal, or simply terminal, 21.

In an embodiment, a CPRU 25 interfaces with one or more telephones 15 located in or about the respective premise. In an embodiment, a CPRU 25 is connected to a respective telephone 15 via standard wireline cabling 52. A telephone 15 and a CPRU 25 comprise an H.323 terminal 17.

In an embodiment, a CPRU 25 interfaces with one or more facsimile (fax) machines, or devices, 12 located in or about the respective premise. In an embodiment, a CPRU 25 is connected to a respective fax machine 12 via standard wireline cabling 53. A fax machine 12 and a CPRU 25 comprise a fax terminal 14.

For a packet data transfer, a CPRU 25 functions as a bridge, handling the interworking of packet data transmissions between the computing device 20-CPRU 25 wireline interface 41 and the over-the-air interface 27 between the respective CPRU 25 and the upstream network. For packet data transfers, a CPRU 25 also provides the processing for managing the end point signaling for functions including authentication, encryption setup, address resolution and dynamic IP address allocation.

In an embodiment, on the IP packet voice network, a CPRU 25 appears as an H.323 signaling endpoint. In an embodiment, the respective CPRU 25 for an H.323 terminal 17 performs the signaling and bearer traffic interworking between the line card wireline interface 52 of a telephone 15-CPRU 25 H.323 terminal 17 and the over-the-air interface 27 between the respective CPRU 25 and the upstream network.

In an embodiment, on the IP fax network, a CPRU 25 appears as a fax signaling endpoint, providing a subscriber facsimile device 12 the transparency of communicating with a switched circuit network 50 via the wireless access system 10. In an embodiment, a CPRU 25 of a fax terminal 14 packetizes the fax control and data messages transmitted from the respective facsimile device 12 and transmits them on the over-the-air interface 27 to a base station 30, for further transmission to a fax gateway 57. The fax gateway 57 unpacketizes, thereby regenerating, the original fax control and data messages and forwards them, as appropriate, to a switched circuit network 50.

In this embodiment, in the reverse transmission direction, a fax gateway 57 packetizes fax control and data messages transmitted from a switched circuit network 50 and transmits them, as appropriate, to a base station 30, for further transmission, on an over-the-air interface 27, to a CPRU 25. The CPRU 25 of a fax terminal 14 unpacketizes, thereby regenerating, the original fax control and data messages and forwards them to the respective facsimile device 12.

In an embodiment, a CPRU 25 is dynamically assigned an IP address by the system 10. The CPRU IP address is used for addressing the operations administration maintenance and provisioning functionalities of the system 1 0, as well as for receiving incoming and transmitting outgoing IP control, or signaling, and bearer messages, for data, voice and fax.

A base transceiver station (BTS) 30, or base station, is an integral part of the over-the-air functionality of the system 10. A base station 30 comprises the capability to provide radio coverage to a specific geographical area serviced by the system 10. In an embodiment, a base station 30 communicates with a Wireless Adjunct inteRnet Platform (WARP) 32 via a GSM (Global System for Mobile communication) Abis wireline interface.

A base station 30 comprises the equipment, components, hardware and software necessary for bi-directional communication with one or more CPRUs 25. In an embodiment, cell engineering is used to ensure that the number of base stations 30 deployed in a geographical area is sufficient to provide connectivity for the CPRUs 25 connected to the system 10 from that area. In an embodiment, a base station 30 communicates with a CPRU 25 via a GSM/GPRS (Global System for Mobile communication/General Packet Radio Service) radio, or wireless, interface 27. In an alternative embodiment, the wireless functionality of the system 10 is based on the GSM/Edge (Global System for Mobile communication/Enhanced Data rates for GSM Evolution) protocols.

Further, system 10 can be used with other communication system, or protocol, platforms, or communication standards, for the respective wireless, i.e., radio, or over-the-air, communications including, but not limited to, IS-95, Global System for Mobile communication (GSM), Digital AMPS (DAMPS), DECT, Wideband Code Division Multiple Access (WB-CDMA), Wideband Time Division Multiple Access (WB-TDMA), PHS, IS-661, Personal Communications System (PCS), PACS, and all their derivatives.

A Wireless Adjunct inteRnet Platform (WARP) 32, among other functions, provides a CPRU 25 connectivity to the backbone of the system 10; i.e., to those network nodes, or elements, and respective communications paths that support connectivity to the services of the network, including access to the external packet data and switched circuit networks 50 supported by the system 10. In an embodiment, a WARP 32 is the logical termination point on the user, i.e., CPRU 25, side of the system 10 for functions including, but not limited to, authentication, packet ciphering, address allocation and logical link management.

Use of one or more WARPs 32 in the wireless access system 10 allows the base stations 30 to be much lighter, less complex network components. Use of one or more WARPs 32 in the wireless access system 10 also allows for use of generic base stations 30, which simply provide bridge, or pass-through, functionality for message, both signaling and bearer, transmissions.

On the network side, a WARP 32 interacts with one or more access routers 35, a private IP network 40 and one or more packet data gateways, including an Internet gateway 60, to provide connectivity into one or more external packet data networks, including the Internet 65. A WARP 32 also interacts with one or more access routers 35, a private IP network 40, one or more switched circuit network gatekeepers 55 and one or more switched circuit network gateways 45 and/or one or more fax gateways 57, to provide connectivity into one or more switched circuit networks 50.

A WARP 32 supports transparent relay of end-to-end H.323 voice signaling between a CPRU 25 and an H.323 gateway 45 and/or H.323 gatekeeper 55. A WARP 32 further supports transparent relay of end-to-end fax signaling between a CPRU 25 and a fax gateway 57.

A WARP 32 also provides circuit-packet interworking for the transmission of bearer voice messages through the system 10. In an embodiment, bearer voice messages are transmitted between a CPRU 25 and a WARP 32 using the GSM/GPRS protocols. A WARP 32 interworks the GSM/GPRS bearer voice messages to VolP (voice IP) based messages for transmission towards the network, i.e., towards a switched circuit network 50. In the alternative direction, a WARP 32 interworks VolP based bearer voice messages transmitted from the network into GSM/GPRS protocol messages for transmission on an over-the-air interface 27 to a CPRU 25.

A WARP 32 provides routing functionality to route packet data, voice and fax signaling and bearer messages between a base station 30-WARP 32 interface and the respective WARP 32-system 10 upstream interface.

A WARP 32 further supports the signaling interworking functionality for authentication and subscriber management. A WARP 32 also supports the network's base station management functionality. Too, a WARP 32 supports both the network's local and remote management functionality for the respective WARP 32.

In an embodiment, a WARP 32 and a base station 30 are paired as one Base Station System (BSS) network component. In an alternative embodiment, one Base Station System (BSS) is comprised of one WARP 32 and two or more base stations 30.

An access router 35 provides the WARPs 32 of the system 10 connectivity to the external world, e.g., one or more external packet data networks, including the Internet 65, and one or more external switched circuit networks 50, via an IP. network 40. In an embodiment, an access router 35 supports IP (internet protocol) message routing for signaling and bearer messages, voice, fax and packet data, within the system 10. In an embodiment, an access router further supports firewalling functionality, which manages control of access to the system 10.

In an embodiment, an access router 35 communicates with a WARP 32 via a wireline interface 42. In an embodiment, an access router 35 communicates with other access routers 35, gateways, including H.323 gateways 45, fax gateways 57 and Internet gateways 60, and gatekeepers 55 of the system 10 via wireline interfaces 51 of the IP network 40.

In an embodiment, the IP network 40 comprises a private IP network 40. The private IP network 40 is a managed IP network wherein resource management and Quality of Service (QoS) aspects of the system 10 services are controlled. In an embodiment, the private IP network 40 provides wireline interfaces 51 to one or more access routers 35, one or more H.323 gateways 45, one or more fax gateways 57, one or more packet data gateways, including one or more Internet gateways 60, and one or more H.323 gatekeepers 55 of the system 10.

In an embodiment, the private IP network 40 provides the Operations Support System 70 of the system 10 connectivity to the system 10 components. In an embodiment, the private IP network 40 and Operations Support System 70 communicate via a wireline interface 36.

An Internet gateway 60 provides connectivity to the Internet 65; the private IP network 40 supports network connectivity to the Internet gateway 60, thereby providing end users, i.e., subscribers, of the system 10 access to the Internet 65. In an embodiment, an Internet gateway 60 supports IP message routing for packet data signaling and bearer messages within the system 10. In an embodiment, an Internet gateway 60 further supports firewalling functionality, which manages access control to the system 10.

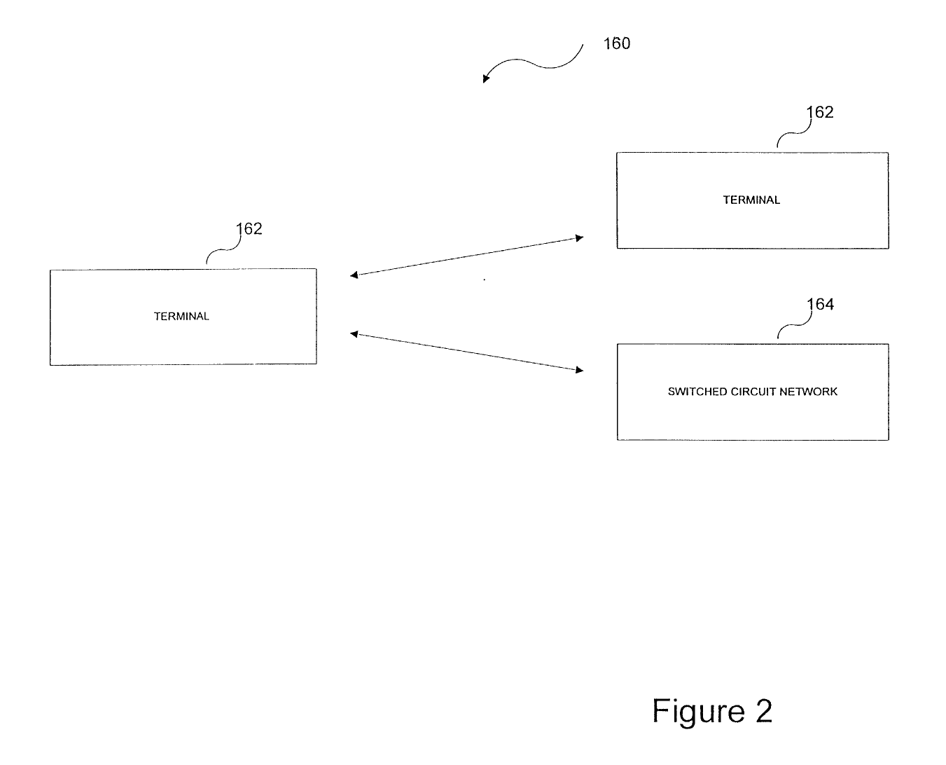

In an embodiment, the system 10 uses the architecture specified in the H.323 protocol standards for provisioning IP packet voice services. Within the wireless access system 10, IP packet voice messages are transmitted between two end points, as shown in FIG. 2. One endpoint 160 is generally an H.323 terminal 162. The other endpoint 160 is either another H.323 terminal 162 or a switched circuit network 164 supported by the wireless access system 10. The switched circuit network 164 routes switched transmission format voice messages created from IP packet voice messages transmitted through the wireless access system 10 to the appropriate non-network destinations. In the alternative direction, the switched circuit network 164 routes switched transmission format voice messages from non-network origins to the wireless access system 10.

Referring again to FIG. 1, an H.323 gateway 45 is a key element for the IP voice services supported by the system 10. An H.323 gateway 45 provides the interworking functionality between the H.323 signaling and transmission formats of the system 10 and the switched circuit network signaling and transmission formats of the external switched circuit network(s) 50.

On the end user, i.e., subscriber, side, an H.323 gateway 45 resides as a peer entity to an H.323 terminal 17 and a WARP 32. An H.323 gateway 45 communicates with a WARP 32 via an access router 35 of a private IP network 40. On the network, i.e., upstream or backhaul, side, an H.323 gateway 45 communicates with a switched circuit network 50 via a Central Office (not shown).

H.323 based VolP (Voice IP) bearer packets, or messages, are transferred in the wireless access system 10 between a CPRU 25 of an H.323 terminal 17 and an H.323 gateway 45. H.323 based signaling messages are also transferred in the wireless access system 10 between a respective CPRU 25 and an H.323 gateway 45.

On the subscriber side, i.e., downstream, an H.323 gateway 45 implements vocoded transmission formats used by the CPRUs 25 of the respective H.323 terminals 17. In an embodiment, the vocoding functionality is based on the G.7xx series of recommendations referenced in the H.323 protocol standards. More specifically, in an embodiment, the vocoding functionality of the system 10 is based on one or more of the following standards: the G.711 Pulse Code Modulation (PCM) of voice frequencies standards; the G.722 7 kHz audio-coding within 64 kbits/s standards; the G.723.1 dual rate speech coder for multimedia communications transmitting at 5.3 and 6.3 kbit/s standards; the G.728 coding of speech at 16 kbit/s using low-delay code excited linear prediction standards; and the G.729 coding of speech at 8 kbit/s using conjugate structure algebraic-code-excited linear-prediction (CS-ACELP) standards.

On the network side, i.e., upstream, an H.323 gateway 45 supports the switched circuit transmission formats of the one or more switched circuit networks 50. Thus, an H.323 gateway 45 provides transcoding functionality between the H.323 and the switched circuit transmission formats for bearer voice messages transmitted within the system 10. Supporting this functionality, an H.323 gateway 45 appears as another H.323 terminal 17 to an H.323 terminal 17. An H.323 gateway 45 translates, in a transparent fashion, vocoded transmission format voice messages from an H.323 terminal 17 into switched circuit format voice messages, for transmission to a switched-circuit network 50. In the alternate direction, an H.323 gateway 45 translates, also in a transparent fashion, switched circuit format voice messages from a switched circuit network 50 into respective vocoded transmission format voice messages, for transmission to an H.323 terminal 17.

In the voice signaling plane, an H.323 gateway 45 provides the interworking between the H.323 call signaling on the subscriber side and the switched circuit signaling towards the Central Office associated with a switched circuit network 50. Supporting this functionality, an H.323 gateway 45 appears as another H.323 terminal 17 to an H.323 terminal 17. An H.323 gateway 45 translates, in a transparent fashion, H.323 call control and capabilities exchange signals from an H.323 terminal 17 into switched circuit call control and capabilities exchange signals for transmission to a Central Office. In the alternate direction, an H.323 gateway 45 translates, also in a transparent fashion, switched circuit call control and capabilities exchange signals from a Central Office into H.323 call control and capabilities exchanges signals for transmission to an H.323 terminal 17.

In an embodiment, an H.323 gatekeeper 55 is another key element for the IP packet voice services supported by the system 10. An H.323 gatekeeper 55 is a logically separate element from an H.323 gateway 45; however, the physical implementation of an H.323 gatekeeper 55 may coexist with an H.323 gateway 45.

A Registration and Admissions and Status (RAS) channel is opened, or established, between a CPRU 25 and an H.323 gatekeeper 55, prior to the establishment of any other channels between two end users' H.323 terminals 17, or an end user's H.323 terminal 17 and a switched circuit network 50, and a respective H.323 gatekeeper, or H.323 gatekeepers, 55.

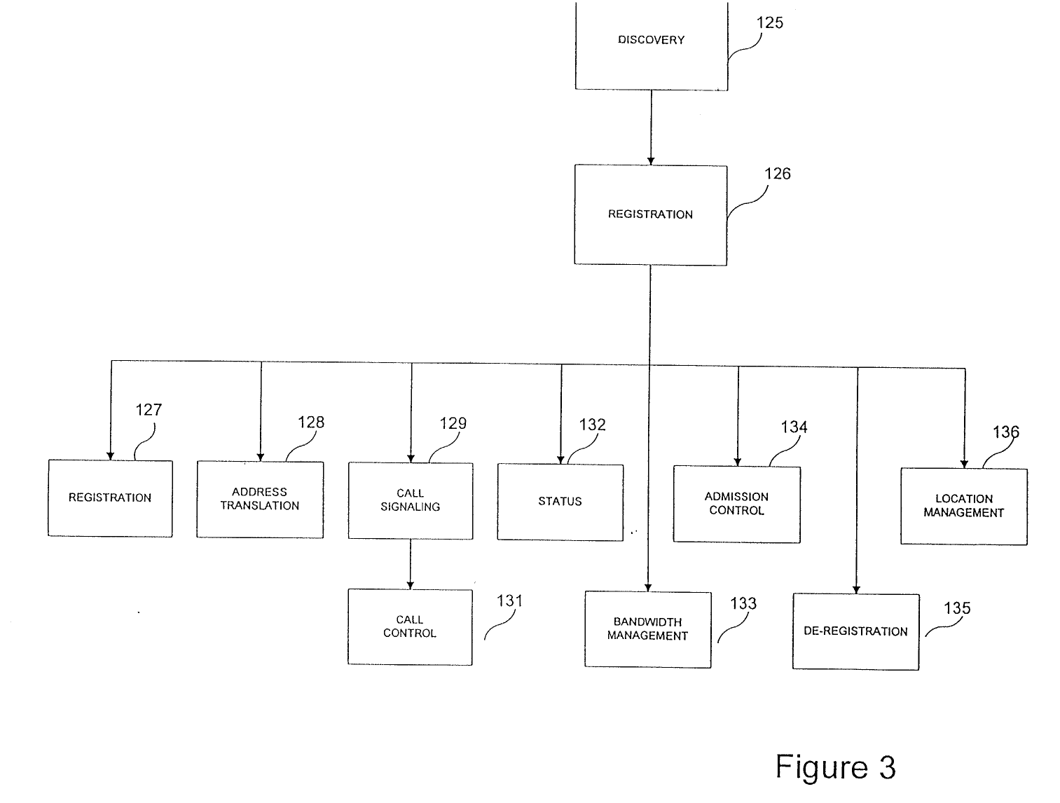

Referring to FIG. 3, the wireless access system 10 supports a discovery procedure 125 executed between an H.323 gatekeeper 55 and one or more endpoints, i.e., end users' H.323 terminals 17. The discovery procedure 125 is used to inform potential endpoints of the existence of the H.323 gatekeeper 55 for voice transmissions. In an embodiment, a manual discovery procedure 125 is used, whereby an H.323 gatekeeper 55 broadcasts its transport, i.e., IP, address to a geographic location, or zone or cell. In an alternative embodiment, an automatic discovery procedure is used, whereby respective endpoints each initiate transmission protocol sequences to discover an H.323 gatekeeper 55 they can become associated with.

Once an H.323 gatekeeper 55 is discovered by an endpoint, the endpoint executes a registration procedure 126 with the H.323 gatekeeper 55. Via the registration procedure 126, an endpoint joins the zone, or cell, managed by a respective H.323 gatekeeper 55, and informs the H.323 gatekeeper 55 of its relevant addresses, i.e., its standard telephone number or E.164 address, and its Internet Protocol (IP) address. The registration procedure 126 is executed between an H.323 terminal 17 and an H.323 gatekeeper 55 before any IP packet voice transmissions between the respective terminal 17 and gatekeeper 55 may commence. Registration establishes a Registration and Admissions and Status (RAS) channel between an H.323 terminal 17 and an H.323 gatekeeper 55.

Among other functions, an H.323 gatekeeper 55 performs alias address, e.g., standard telephone number or E.164 address, to transport, i.e., IP, address, translation 128. This address translation 128 provides a mapping between a telephone number, or E.164 address, and the current IP address of an H.323 terminal 17.

In an embodiment, after an endpoint of the wireless access system 10 registers with a respective H.323 gatekeeper 55, it periodically executes a re-registration procedure 127 with the gatekeeper 55.

Once an endpoint registers with a respective H.323 gatekeeper 55, the H.323 gatekeeper 55 may use the RAS channel established between them for executing a bandwidth management procedure 133. The bandwidth management procedure 133 establishes the bandwidth that an endpoint, i.e., an end user's H.323 terminal 17, may use for its respective packet voice message transmissions.

Once an endpoint registers with a respective H.323 gatekeeper 55, the H.323 gatekeeper 55 may thereafter use the RAS channel established between them for executing a status procedure 132 with the endpoint. The status procedure 132 provides the H.323 gatekeeper 55 status on the respective H.323 terminals 17 registered with it.

Also after registration, an endpoint may execute a de-registration procedure 135 with the respective H.323 gatekeeper 55. The de-registration procedure 135 provides an endpoint a mechanism for disassociating itself with the respective H.323 gatekeeper 55.

After registration, an H.323 gatekeeper 55 and an endpoint may execute a call signaling procedure 129 The call signaling procedure 129 establishes a call signaling channel between the endpoint and the H.323 gatekeeper 55, for maintenance of subsequent IP packet voice transmissions, i.e., an IP-based telephone call, between them. In an embodiment, the call signaling procedure 129 uses the H.225.0 protocol for establishing a call signaling channel between the respective H.323 gatekeeper 55 and an H.323 terminal 17. The established call signaling channel is maintained for the duration of the IP telephone call to or from the H.323 terminal 17. In an embodiment, the symmetrical signaling method of Annex D/Q.931 is used for the call signaling procedure 129; i.e., Q.931 protocol messages are used by the call signaling procedure 129, to establish the call signaling channel between the respective H.323 gatekeeper 55 and an H.323 terminal 17.

The initial call signaling procedure 129 protocol message, i.e., an initial admission message, is transmitted between an H.323 gatekeeper 55 and an H.323 terminal 17 via their previously established RAS channel. In an embodiment, all subsequent call signaling procedure 129 protocol messages are transmitted via the call signaling channel established between the H.323 gatekeeper 55 and the respective H.323 terminal 17.

If the IP packet voice messages, i.e., the IP telephone call, is between two H.323 terminals 17, the respective H.323 gatekeeper(s) 55 routes applicable Q.931 protocol messages between the calling and called H.323 terminals 17. If the IP telephone call is between an H.323 terminal 17 and a switched circuit network 50, the respective H.323 gatekeeper(s) 55 routes switched circuit format messages generated from Q.931 protocol messages of the H.323 terminal 17 to the switched circuit network 50. In the alternate direction, the respective H.323 gatekeeper(s) 55 routes Q.931 protocol messages generated from switched circuit format messages of the switched circuit network 50 to the appropriate H.323 terminal 17.

An H.323 gatekeeper 55 may determine to complete the call signaling procedure 129 with the calling/called endpoints. In the case of an H.323 terminal 17 to switched circuit network 50 voice call, if the H.323 gatekeeper(s) 55 processes the H.323 call signaling, it thereby directs the H.323 call signaling towards a respective H.323 gateway 45. The H.323 gateway 45 then provides the process functionality for interworking the H.323 signaling on the user side to a switched circuit network signaling format for use by the respective switched circuit network 50.

An H.323 gatekeeper 55 may alternatively direct the calling/called endpoints to finalize execution of the call signaling procedure directly with each other, without requiring further intervention of the H.323 gatekeeper 55.

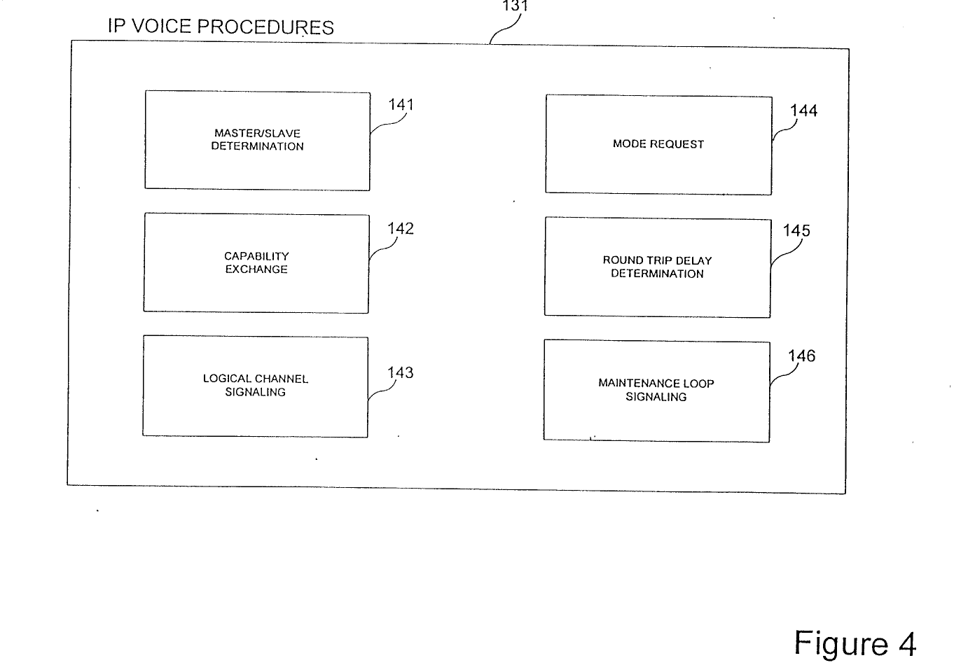

An H.323 gatekeeper 55 also supports a call control procedure 131 for IP packet voice call control. As shown in FIG. 4, the call control procedures 131 comprise procedures including, but not limited to, a master/slave determination procedure 141, a capability exchange procedure 142, a logical channel signaling procedure 143, a mode request procedure 144, a round trip delay determination procedure 145 and a maintenance loop signaling procedure 146.

The master/slave determination procedure 141 comprises functionality to resolve conflicts between two endpoints that are attempting to open a bi-directional voice message channel. Thus, the master/slave determination procedure 141 determines which endpoint is to act as the master of the voice message channel and which is to act as the slave, for subsequent call control purposes.

The capability exchange procedure 142 comprises functionality to support H.323 terminals 17 statusing, or otherwise reporting, their receive and transmit capabilities and their ability to operate in various mode combinations simultaneously to a respective H.323 gatekeeper 55. In an embodiment, the default capabilities of a respective H.323 terminal 17 are a fixed vocoder type operational mode and receive and transmit capabilities. In an alternative embodiment, no default is assumed, and H.323 terminals 17 are required to report their operational mode(s) and their receive and transmit capabilities to an H.323 gatekeeper 55.

The logical channel signaling procedure 143 comprises functionality for the opening, i.e., establishment, and closing, i.e., de-allocation, of logical channels for IP packet voice transmissions. In an embodiment, unidirectional logical channels are opened, or established or allocated, for respective IP packet voice message transmissions, and thus, asymmetrical operation is supported, whereby the number and type of message streams can be different in the two, i.e., calling and called, directions.

The mode request procedure 144 comprises the functionality for an H.323 terminal 17 to indicate its preference for the transmit mode for the other endpoint involved in the IP voice telephone call. The mode request procedure 144 also comprises the functionality for an H.323 terminal 17 to indicate its preference for a respective H.323 gatekeeper's transmit mode. Further, an H.323 gatekeeper 55 uses the mode request procedure 144 to indicate its preference for a respective H.323 terminal's transmit mode. The requested entity, i.e., an H.323 terminal 17 or an H.323 gatekeeper 55, acquiesces to a preferred transmit mode request if it is capable of doing so.

The round trip delay determination procedure 145 comprises functionality for determining the round trip delay, i.e., request and response, between an H.323 terminal 17 and an H.323 gatekeeper 55 involved in an IP telephone call. In an embodiment, the round trip delay determination procedure 145 also comprises functionality for determining the round trip delay between a transmit and a receive H.323 terminal 17 involved in an IP telephone call.

The maintenance loop signaling procedure 146 comprises functionality for establishing and processing maintenance transmission loops, to verify IP packet voice transmission channels in the network 10.

Referring again to FIG. 1, a fax gateway 57 is a key network element in the Internet Protocol (IP) fax sub-network of the wireless access network 10. A fax gateway 57 receives packetized fax control, or signaling, and bearer messages over the air from a CPRU 25, via a WARP 32 and an access router 35. In the alternate direction, a fax gateway 57 transmits packetized fax control and bearer messages over the air to a CPRU 25, via an access router 35 and a WARP 32.

A fax gateway 57 translates, in a transparent fashion, Internet Fax Protocol (IFP) T.38 standards control and capabilities exchange signals from a fax terminal 14 into respective T.30 standards fax control and capabilities exchange signals, for transmission to a Central Office of a switched circuit network 50. A fax gateway 57 also translates, in a transparent fashion, IFP T.38 standards fax bearer messages from a fax terminal 14 into respective T.30 standards fax bearer messages, for transmission to a Central Office. In the alternate direction, a fax gateway 57 translates, in a transparent fashion, T.30 standards fax control and capabilities exchange signals and fax bearer messages from a Central Office of a switched circuit network 50 into respective IFP T.38 standards control and capabilities exchange signals and fax bearer messages, for transmission to a fax terminal 14.

In an embodiment, a Central Office of a switched circuit network 50 is a standard class 5 central office switch that provides interconnection to the switched circuit network 50. The interface between an H.323 gateway 45 and a Central Office represents the point of line interface termination on the network side for wireless access system 10 IP packet voice signaling and bearer messages. The interface between a fax gateway 57 and a Central Office represents the point of line interface termination on the network side for wireless access system 10 IP fax signaling and bearer messages.

A Central Office represents the connection point into a switched circuit network 50 through which telephony and fax calls between a CPRU 25 and a switched circuit network user are routed. In an embodiment, a Central Office of a switched circuit network 50 is also the point in the wireless access system 10 which delivers supplementary telephony, and in some embodiments, fax, service features to a wireless access system 10 subscriber.

A switched circuit network 50 is a network through which voice, i.e., telephony, calls and fax transmissions can be routed. A switched circuit network 50 may comprise, but is not limited to, a Public Switched Telephone Network (PSTN) or an Integrated Services Digital Network (ISDN).

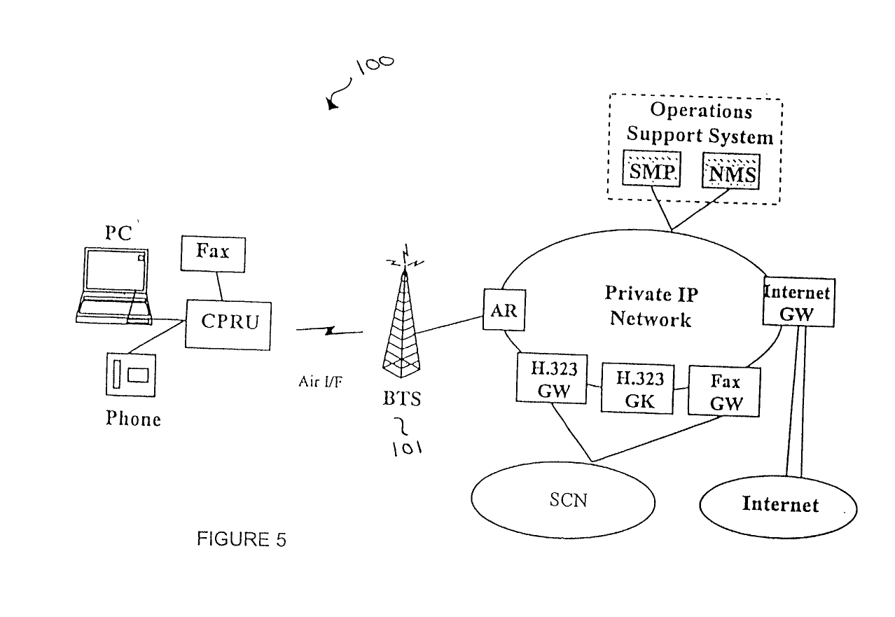

The wireless access system, or network, 100, depicted in FIG. 5, is an alternative embodiment wireless access system, or network. The wireless access system 100 is the same basic system as the wireless access system 10 of FIG. 1, except that there is no WARP 32 elements in the system 100. In the system 100, the base station(s) 101 assumes the combined functionality of the WARP(s) 32 and the base station(s) 30 of the system 10. In this manner, the base station(s) 101 provides the Internet Protocol (IP) interface for the end users, or subscribers, into the system 100.

### Wireless Access System Services

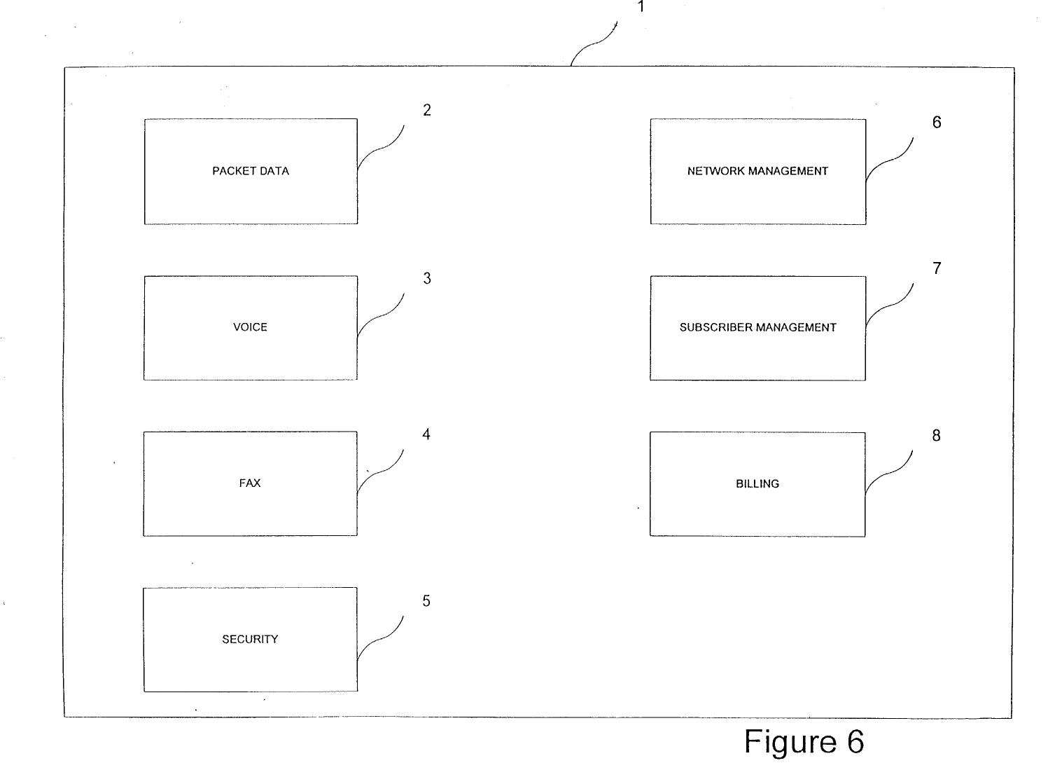

An embodiment of a wireless access network, or system, 10, or 100, comprises a variety of services 1, as shown in FIG. 6, for supporting wireless access voice, data and facsimile (fax) transmissions. More specifically, an embodiment of a wireless access network 10, or 100, comprises services 1 for supporting wireless access to one or more data networks, for example, but not limited to, e.g., a public data network, including the Internet 65, and to one or more switched circuit networks 50, for example, but not limited to, e.g., a Public Switched Telephone Network (PSTN) and/or an Integrated Services Digital Network (ISDN).

The services 1 of the wireless access network 10, or 100, include packet data services 2, voice services 3, fax services 4, security services 5, network management services 6, subscriber management services 7 and billing services 8.

Packet data services 2 of the wireless access network 10, or 100, include point-to-point and point-to-multipoint services. A point-to-point packet data service is a connectionless service of the datagram type in which the messages are generally transferred on an unsecure transmission channel which comprises the functionality for the transmission of one or more packets of data from a single packet data network, for example, the Internet 65, to a single network subscriber. In the alternate direction, the point-to-point packet data service comprises the transmission of one or more packets of data from a single network subscriber to a single packet data network.

In an embodiment, each point-to-point packet data transmission is independent of the preceding and succeeding packet data transmissions. In an embodiment, on the radio, i.e., wireless, or over-the-air, transmission interface 27 of the wireless access network, 10, or 100, the point-to-point packet data service utilizes an acknowledge transfer mechanism for reliable wireless transmission and reception. In an embodiment, the basic network layer protocol for the point-to-point packet data service is the Internet Protocol (IP).

A point-to-multipoint packet data service comprises the functionality for the transmission of messages between participants of an Internet Protocol Multicast (IP-M) group. A point-to-multipoint packet data service is a connectionless service of the datagram type in which the messages are generally transferred on an unsecure transmission channel which comprises the functionality for the transmission of one or more packets of data from a single packet data network, for example, the Internet 65, to two or more network subscribers. In an embodiment, the basic network layer protocol for the point-to-multipoint packet data service is the Internet Protocol (IP).

Voice services 3 of the wireless access network 10, or 100, comprise the establishment, maintenance and release of IP packet voice telephone calls between two subscribers, or between a subscriber and a switched circuit network 50. In an embodiment, voice services 3 are managed via the H.323 protocol standards overlaid on the underlying Internet Protocol (IP)-based packet data transmission planes. In an, embodiment, voice messages, both signaling and bearer, are transmitted within the wireless access network 10, or 100, in an IP packet datagram format.

Fax services 4 of the wireless access network 10, or 100, comprise the establishment, maintenance and release of IP packet fax transmissions between two subscribers, or between a subscriber and a switched circuit network 50. In an embodiment, fax services 4 are managed via the Internet Fax Protocol (IFP) T.38 standards overlaid on the underlying Internet Protocol (IP)-based packet data transmission planes. In an embodiment, fax messages, both signaling and bearer, are transmitted within the wireless access network 10, or 100, in an IP packet datagram format.

Security services 5 support security features including, but not limited to, subscriber authentication, terminal authentication, user identity confidentiality and user information confidentiality. Subscriber authentication and terminal authentication provide network-wide confirmation that the respective subscriber and terminal identities being used to access the system 10, or 100, are proper, i.e., that a subscriber on a respective terminal 21, or H.323 terminal 17, or fax terminal 14, is actually as claimed in the request for network services. Subscriber and terminal authentication procedures protect the network against unauthorized use and against the impersonation of authorized users.

User identity confidentiality provides identity privacy for subscribers using the radio resources of the wireless access network 10, or 100. User identity confidentiality includes providing protection against tracing the location of a subscriber by listening to, or otherwise intercepting, signaling exchanges on the network's wireless interface 27.

User information confidentiality includes encryption and subsequent decryption of voice, fax and data messages transmitted within the network 10, or 100. The user information confidentiality mechanisms protect the confidentiality of messages, voice, fax and data, that are transmitted over the network's wireless interface 27.

The security services 5 of the wireless access network 10, or 100, support functionality to prevent the unauthorized access and use of network nodes, or elements, including CPRUs 25, Wireless Adjunct inteRnet Platforms (WARPs) 32, base stations 30 and 101, access routers 35, gateways 45, 57 and 60, and gatekeepers 55. The security services 5 also support a combination of techniques for ensuring that the public entry points to the wireless access network 10, or 100, are protected against unauthorized access. As the wireless access system 10, or 100, is used as both a management and a service network, additional security is generally required to prevent unauthorized use of the node management procedures and functionalities, further described below.

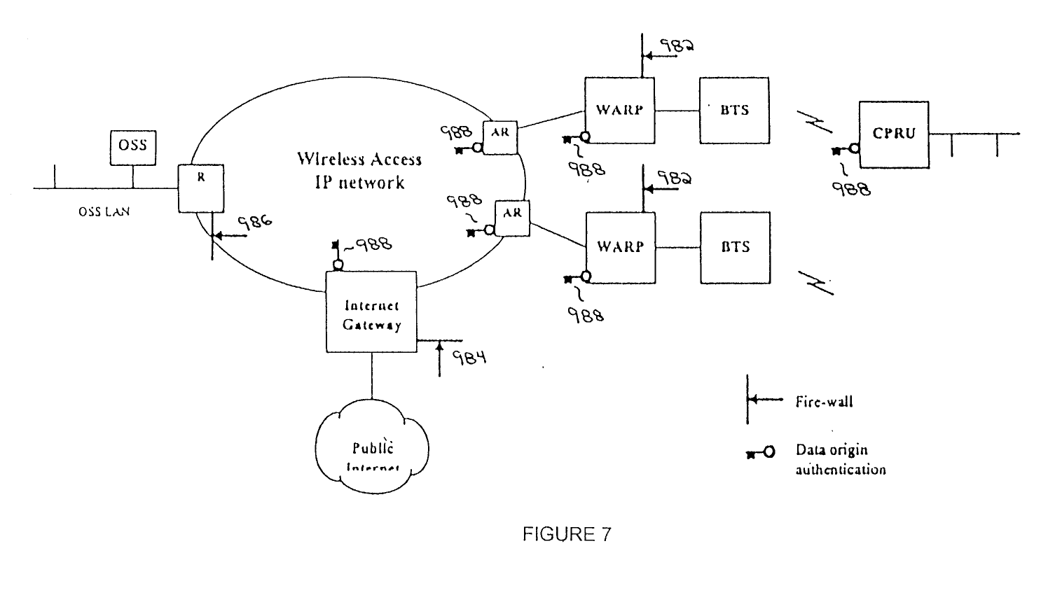

Referring to FIG. 7, various mechanisms are employed as part of the security services 5 of the wireless access system 10, or 100. In an embodiment, a mechanism for security management includes firewalling 982 at the respective WARPs 32 of the system 10. In this manner, unauthorized users are prevented by the respective WARPs 32 from accessing the system 10.

In an embodiment, a mechanism used for security management is firewalling 984 at the Internet gateway(s) 60. In this manner, unauthorized users attempting to access the system 10, or 100, for Internet access, are prevented from doing so by the Internet gateway(s) 60.

In an embodiment, a mechanism for security management is firewalling 986 at the Operations Support System (OSS) 70 LAN (Local Area Network). In this manner, unauthorized users are prevented from accessing the management and service functions of the system 10, or 100, by the access router 35 providing connectivity to the Operations Support System 70.

In an embodiment, a mechanism for security management is data origin authentication 988, which is executed during respective network node management procedures. Using the security features of the Simple Network Management Protocol (SNMP), CPRUs 25, WARPs 32, access routers 35 and gateways, 45 (H.323), 57 (fax) and 60 (Internet), authenticate the origins of data transmitted during node management procedures, to ensure unauthorized users are not accessing the system 10, or 100, via the respective network node management platforms, as further described below.

Referring again to FIG. 6, network management services 6 manage the network elements, or nodes, that comprise the wireless access network 10, or 100, including the CPRUs 25, base stations 30 and 101, WARPs 32, access routers 35, gateways 45, 57 and 60, and gatekeepers 55. The network management services 6 support management functions including configuration management, fault management, performance management and accounting management.

Subscriber management services 7 of the wireless access system 10, or 100, support the management of subscriber profiles. A subscriber profile includes subscription information on services and other parameters assigned to an end user, i.e., subscriber, of the network 10, or 100, for an agreed contractual period. In an embodiment, a subscriber profile comprises a respective subscriber identification, the subscribed for network services and an assigned Quality of Service (QoS) level.

In an embodiment, a particular service request is validated by the network 10, or 100, against the respective subscriber's subscription profile. For example, if a subscriber has contracted for packet data services only, then a packet data request from the subscriber will be validated, and subsequently executed, by the network 10, or 100. However, a voice request from the subscriber will be invalidated, and, therefore, not executed, as voice services are not present in the subscriber's subscription profile as they have not been contracted for.

Billing services 8 of the wireless access network 10, or 100, comprise mechanisms for charging a network subscriber for packet data services, for example, but not limited to, Internet access, for voice services and for fax services. In an embodiment, a centralized accounting system is used to consolidate subscriber billing for all network-provided services.

### Accounting Management

As noted, the wireless access system 10, or 100, supports billing services 8. As also noted, the subscriber services provided by the systems 10 and 100 include voice, fax and packet data transmissions. The wireless access systems 10 and 100 also support wireless access service for transmissions between a subscriber and switched circuit networks 50 and packet data networks.

The wireless access service is a fundamental wireless network service without which the other services cannot be provided. In an embodiment, the wireless access service can be compared with a Public Switched Telephone Network (PSTN) service supported by local telephone companies. Thus, the wireless access service is a mandatory service for all subscribers of the systems 10 and 100. In an embodiment, the mechanism for charging for wireless access service is a flat rate pricing strategy based on a peak throughput level selected by a respective subscriber.

The over-the-air resource in a wireless access network 10, or 100, is generally a limited resource. Thus, in an alternative embodiment, different flat rate charges are associated with a number of subscriber-requested Quality of Service (QoS) levels for wireless access service. This billing scheme for wireless access service protects the over-the-air resources from over use without a requisite need for a complex usage-based billing strategy.

The subscriber services provided by the systems 10 and 100, i.e., voice, fax and packet data services, are not specific to wireless access, and can be offered to end users as subscription options.

In an embodiment, packet data service is a subscriber option. In an embodiment, the mechanism for charging for packet data services is a flat rate scheme. In an alternative embodiment, the mechanism for charging for packet data services is a usage-based scheme. In yet another alternative embodiment, the mechanism for charging for packet data services is a combination flat rate and usage-based scheme.

In an embodiment, the Remote Authentication Dial In User Service (RADIUS) accounting protocol is used for the transfer of accounting information, for, but not limited to, billing purposes, between an external packet data network, e.g., the Internet 65, access server entity and the wireless access network's centralized billing system.

In an embodiment, voice service is also a subscriber option. In an embodiment, the mechanism for charging for voice services is based on traditional telephony schemes, i.e., is based on the call duration and the called party destination address.

In an embodiment, fax service is a subscriber option. In an embodiment, the mechanism for charging for fax services is also based on traditional telephony schemes, i.e., is based on the duration of the fax call and the called destination address.

The accounting architecture of the networks 10 and 100, i.e., who pays whom, is dependent on both the provision of services to a respective subscriber, and also upon a subscriber's use of services provided by third parties, e.g., external transmission networks. For example, in an embodiment, the wireless access service and the Internet Service Provider (ISP) services, for access to the Internet 65, are provided by the same wireless access network 10, or 100, operator. Thus, the billing for a subscriber's use of these services need only take into account the single wireless access network's charges.

As an alternative example, in an embodiment, the wireless access service and the ISP services are provided by different operators. In this scheme, the billing for a subscriber's use of these services must tally, or otherwise reconcile and account for, the requisite charges from both operators.

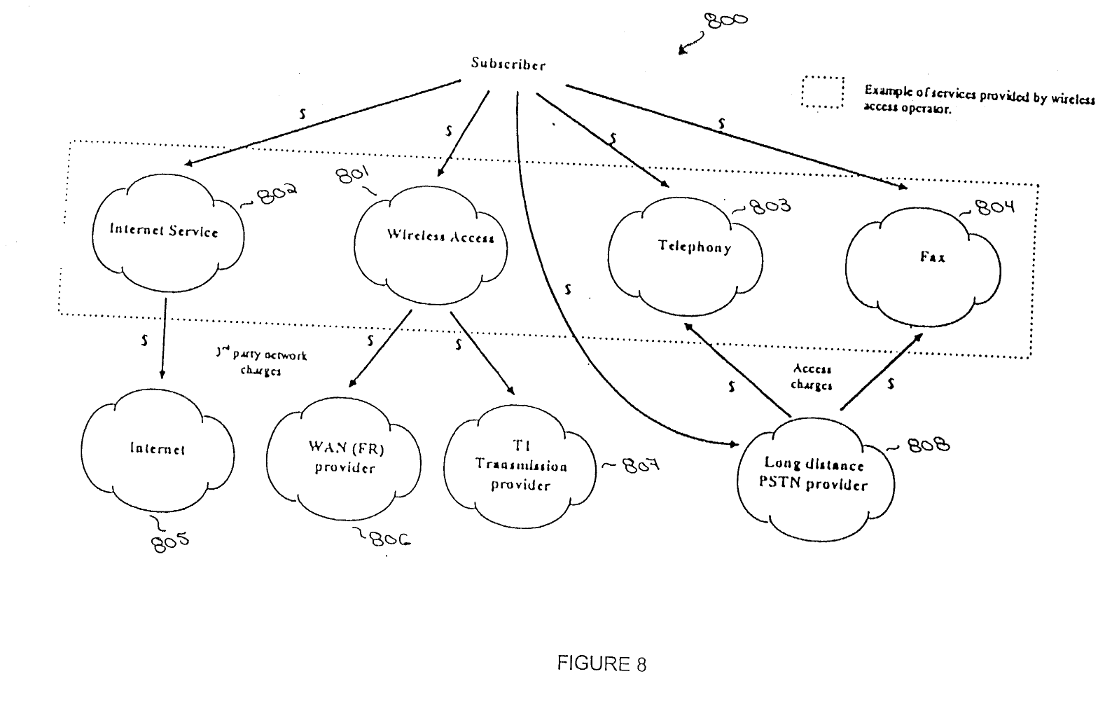

An embodiment of an accounting architecture 800 in terms of payments, shown in FIG. 8, depicts a system architecture in which the operator providing the wireless access service also provides the additional services traditionally accessed via local telephone companies, i.e., voice, fax and packet data services. If any of the subscriber services, i.e., voice, fax and/or packet data, are alternatively provided by one or more external operators, the respective subscribers accessing those services will receive local access charges from each external operator, as well as the wireless access charges generated from use of the wireless access system 10 or 100.

In the accounting architecture 800, a subscriber is charged for each of the services he or she accesses. As all of the services in the accounting architecture 800 are provided by the wireless access system operator, a subscriber receives one centralized bill for his/her wireless access usage 801, Internet service usage 802, voice access usage 803 and fax access usage 804.

In the accounting architecture 800, a subscriber may also be required to pay third party operator charges for his/her actual Internet usage 805, WAN (Wide Area Network) and/or T1 transmission line access and usage 807, for subsequent access to the wireless access system 10, or 100, and/or long distance telephone usage 808, for long distance voice and fax message transmissions.

### Network Management

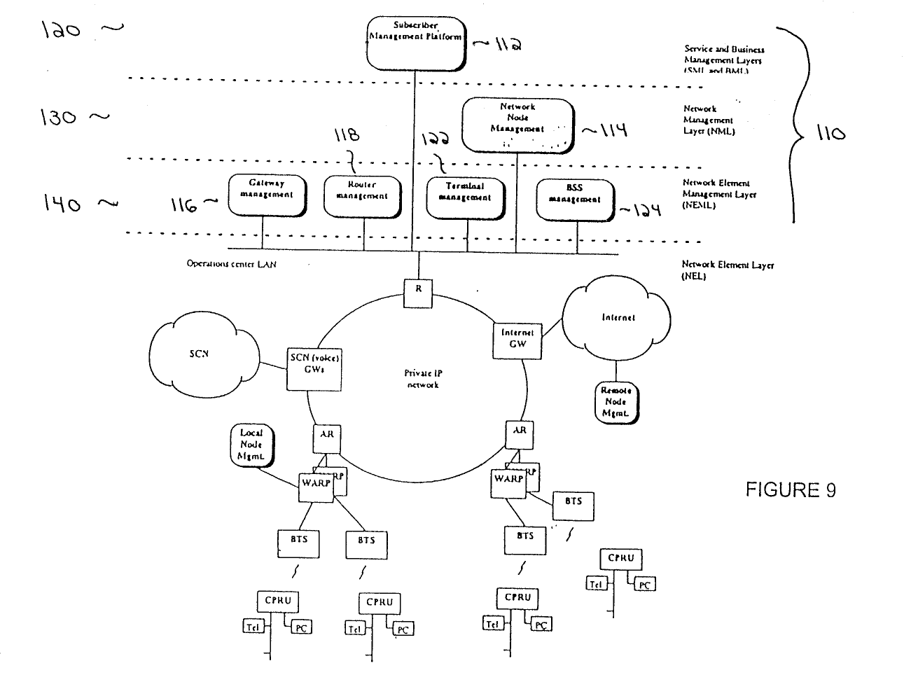

In an embodiment, a centralized Operations Support System (OSS) 70 supports management of a wireless access system 10, or 100, and its various nodes, or elements, including, but not limited to, CPRUs 25, base stations 30 or 101, WARPs 32, access routers 35, Internet gateways 60, H.323 gateways 45, fax gateways 57 and H.323 gatekeepers 55, and the respective protocol platforms. As shown in FIG. 9, in an embodiment, the network management architecture 110 for a wireless access network 10, or 100, is comprised of a Network Element Management Layer (NEML) 140, a Network Management Layer (NML) 130 and a Service Management Layer and (SML) and a Business Management Layer (BML) (collectively 120).

In an embodiment, network element management is provided by a mixture of platforms that function as first level managers of specific domains. In an embodiment, the network element management layer 140 is comprised of a gateway management platform 116, for managing the network's gateway/gatekeeper domain, i.e., the gateways 45 (H.323), 57 (fax) and Internet (60) and the H.323 gatekeepers 55. In this embodiment, the network element management layer 140 further comprises a router management platform 118, for managing the network's router domain, i.e., the access routers 35, a terminal management platform 122, for managing the network's CPRUs 25, and a Base Station System (BSS) management platform 124, for managing the network's base stations 30 and WARPs 32, or, in system 100, for managing the network's base stations 101.

The gateway management platform 116 provides the functionality for provisioning, administration, statusing and performance monitoring of the gateways 45, 57 and 60 of the network 10, or 100. In an embodiment, the gateway management platform 116 also provides the functionality for provisioning, administration, statusing and performance monitoring of the H.323 gatekeepers 55 of the network 10, or 100.

The router management platform 118 provides the functionality for provisioning, administration, statusing and performance monitoring of the access routers 35 of the network 10, or 100.

The terminal management platform 122 is a general purpose management platform for management of the CPRUs 25 of the wireless access system 10, or 100.

The Base Station System (BSS) management platform 124 is a general purpose management platform for management of the base stations 30 and Wireless Adjunct inteRnet Platforms (WARPs) 32 of the wireless access system 10, or the base stations 101 of the system 100. In an embodiment, local node management is also supported for the WARPs 32 and base stations 30 of the system 10, or the base stations 101 of the system 100, to be used for provisioning during deployment of the respective WARPs 32 and base stations 30, or 101, prior to the complete establishment of the network management infrastructure.

The network management layer 130 comprises a scalable Network Node Management (NNM) platform 114 for providing centralized network node management. In an embodiment, the NNM platform 114 consolidates the diverse management requirements of the various gateways 45, 57 and 60, H.323 gatekeepers 55, access routers 35, base stations 30, or 101, CPRUs 25 and WARPs 32 of the wireless access network 10, or 100, into an integrated management view. The NNM platform 114 provides standard network management functionality, including, but not limited to, configuration management, fault statusing and provisioning, and performance management. Additionally, the NNM platform 114 comprises an architecture that supports event management, database control and general network node, or element, security features for the respective wireless access network 10, or 100.

In an embodiment, the NNM platform 114 provides standard APIs (Application Platform Interfaces) which allow attachment of third party applications to the wireless access system elements, for purposes including, but not limited to, trouble-shooting and error management, asset management and system, service and functionality analysis.

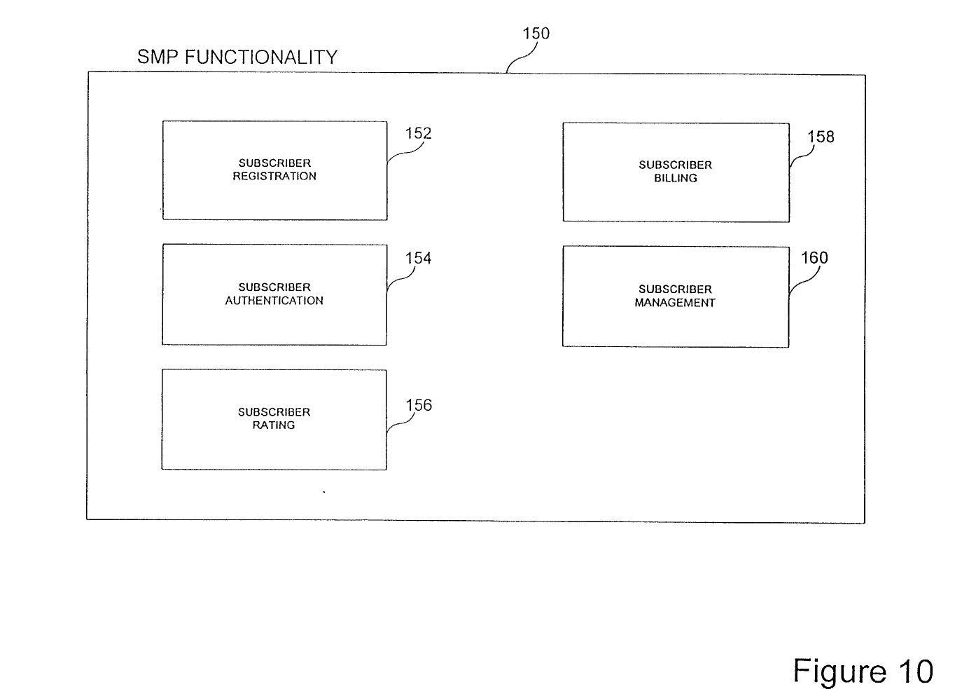

The Service Management and Business Management layers 120 comprise a Subscriber Management Platform (SMP) 112. Referring to FIG. 10, the Subscriber Management Platform (SMP) 112 supports various subscriber-orientated functionality, or procedures, 150. In an embodiment, the SMP 112 supports a subscriber registration procedure 152, a subscriber authentication procedure 154, a subscriber rating procedure 156, a subscriber billing procedure 158 and a subscriber management procedure 160.

The subscriber registration procedure 152 includes, but is not limited to, functionality for the collection, storage and management of subscriber, i.e., customer, data for subscriber provisioning and billing. The subscriber data includes, but is not limited to, a subscriber profile, which includes, but is not limited to, subscription information on the services the subscriber has requested, as well as other parameters that have been assigned the respective subscriber for an agreed contractual period. An example of a parameter associated with a subscriber profile is a Quality of Service (QoS) level subscribed for, or otherwise assigned, the respective subscriber.

The subscriber authentication procedure 154 provides network protection against fraud. Generally, the subscriber authentication procedure 154 authenticates access to the wireless equipment and channels, as well as user-attempted access to specific network-supported services. In an embodiment, the wireless access system 10, or 100, supports both subscriber authentication and terminal authentication functionality.

For packet data services, subscriber authentication is generally performed via the wireless access and Internet Protocol (IP) network nodes in an end-to-end, i.e., flow-through, and generally transparent, fashion. More specifically, in an embodiment, for packet data services, subscriber authentication is supported by a CPRU 25 of a respective terminal 21 and the base station 30, or 101, that the CPRU 25 communicates with.

In an embodiment, for voice and fax services, subscriber authentication is generally performed between an H.323 terminal 17 and an H.323 gatekeeper 55. In an embodiment, a challenge/response process and the Challenge Handshake Authentication Protocol (CHAP) are used for the respective subscriber authentication. In an alternative embodiment, a user id/password technique and the Password Authentication Protocol (PAP) are used for the respective subscriber authentication.

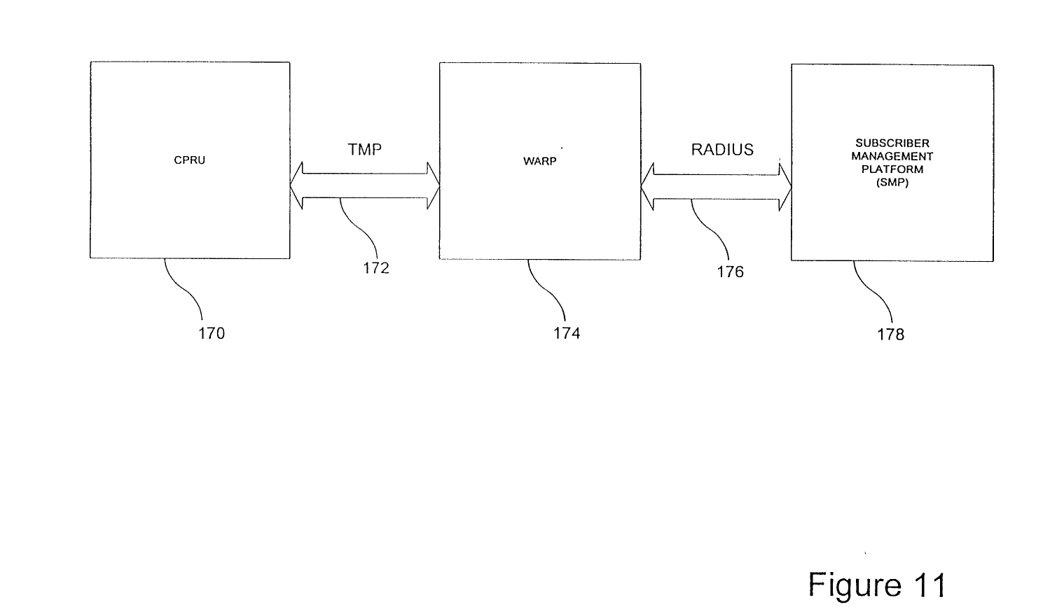

In the wireless access system 10, or 100, terminal authentication is used to authenticate a terminal 21 or H.323 terminal 17 or fax terminal 14. In an embodiment, as shown in FIG. 11, terminal authentication involves three network components: a CPRU 170 of the terminal 21 or H.323 terminal 17 or fax terminal 14, the WARP 174 of the cell, or zone, the CPRU 170 is located in, and the Subscriber Management Platform (SMP) 178 of the wireless access system 10. For system 100, a base station 101 replaces a WARP 32, and thereby supports the WARP's terminal authentication functionality of system 10.

The CPRU 170 automatically initiates the terminal authentication process upon power on. In an embodiment, the CPRU 170 communicates with the respective WARP 174 for terminal authentication via the Terminal Management Protocol (TMP). The CPRU 170 has a secret key installed in the factory; the secret key is associated with the CPRU's unique universal identifier. The CPRU 170 also comprises dedicated circuitry and/or software to compute responses to given terminal authentication challenges issued by the Subscriber Management Platform (SMP), using its secret key.

The WARP 174 acts as a relay between the CPRU 170 and the SMP 178 for terminal authentication purposes. The WARP 174 communicates with the CPRU 170 via the Terminal Management Protocol (TMP), using the secure Logical Link Control (LLC) protocol as the underlying transmission protocol for terminal authentication control messages, as further discussed below.

In an embodiment, the WARP 174 communicates with the SMP 178 of the wireless access network 10 for terminal authentication purposes via the Remote Authentication Dial In Service (RADIUS) protocol, using the unsecure User Datagram Protocol (UDP) as the underlying transmission protocol, as further discussed below.

Upon execution of the terminal authentication protocol between a CPRU 170 and the SMP 178, the respective WARP 174 retains the terminal authentication status of the CPRU 170. The WARP 174 thereafter uses the CPRU's terminal authentication status for admitting or denying the CPRU 170 subsequent access to the wireless access system 10. For example, the WARP 174 will deny system access to a CPRU 170 that was not previously properly authenticated via the terminal authentication procedure.

The Subscriber Management Platform (SMP) 178 stores pairs of CPRU 170 identities and respective secret keys. When an “Access Request” message is received by the SMP 178, via a WARP 174, from a CPRU 170, requesting access to the network, the SMP 178 replies with an “Access Challenge” message. In an embodiment, the “Access Challenge” message includes a random number. Upon receiving the “Access Challenge” message, the CPRU 170 responds accordingly. If the CPRU's response is valid, the SMP 178 transmits an “Access Accept” message to the CPRU 170. If not, the SMP 178 transmits an “Access Reject” message to the CPRU 170.

Referring again to FIG. 10, the subscriber rating procedure 156 includes, but is not limited to, the creation and maintenance of flexible pricing plans.

The subscriber billing procedure 158 supports the generation of flexible customer billings, including, but not limited to, real time and invoice-based payment requests. The subscriber billing procedure 1 58 further supports billing customers in one or more of multiple currencies.

The subscriber management procedure 160 generates and supports network management access to subscriber information including, but not limited to, subscription profiles, subscription activity and subscriber account balances. In an embodiment, subscription profiles include, but are not limited to, customer identification, customer service support requests and the Quality of Service (QoS) subscribed for, or otherwise assigned. In an embodiment, subscription activity information includes, but is not limited to, respective subscribers' usage, in time, of services supported by the wireless access system 10, or 100. In an embodiment, subscriber account balances include, but are not limited to, the monetary amount a respective subscriber owes for the services used on the system 10, or 100.

In an embodiment, a direct node management approach is used that allows management of any network node, i.e., CPRUs 25, base stations 30, or 101, WARPs 32, access routers 35, gateways 45, 57 and 60, and H.323 gatekeepers 55, having an Internet Protocol (IP) address. The management of the respective network nodes is accomplished using Internet-based protocols including, but not limited to, the Simple Network Management Protocol (SNMP) and the File Transfer Protocol (FTP). Network node management may be accommodated, or otherwise accomplished, from a variety of locations including a remote network operations center which supports a main centralized management location, the Internet, which provides limited remote management capabilities generally due to Internet firewalls, and/or a local management center, which can support management provisioning at node installation.

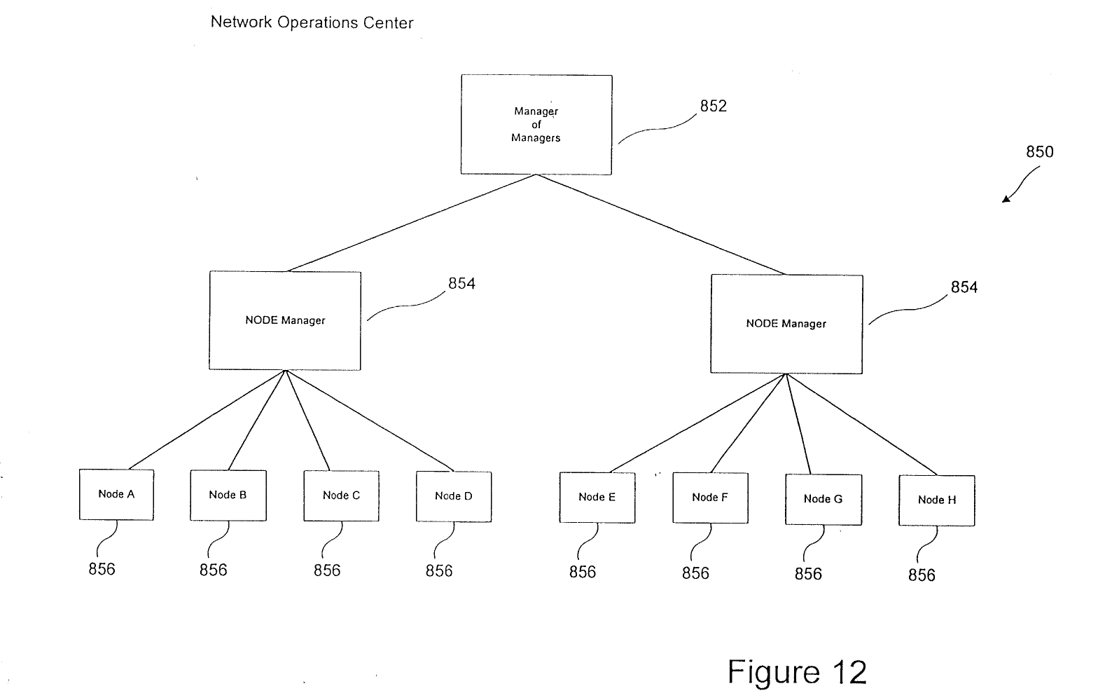

Use of a direct management scheme from a centralized network operations location can lead to a heavy processing load on the Network Node Management (NNM) platform 114. The processing load on the NNM platform 114 may be further increased due to the simplicity of the mechanisms used in the Simple Network Management Protocol (SNMP), and the need for frequent polling to detect SNMP failures. An embodiment solution to the processing load problem is the maintenance of a hierarchy of management platforms for network node management, as shown in FIG. 12.

In the management hierarchy system 850 of FIG. 12 one manager of managers 852 is designated. In an embodiment, the manager of managers 852 is the Network Node Management (NNM) platform 114. The manager of managers 852 manages two or more node managers 854. In an embodiment, a node manager 854 comprises a gateway management platform 116, a router management platform 118, a terminal management platform 122 or a BSS management platform 124. Each node manager 854, in turn, manages two or more network nodes 856. The network nodes 856 comprise the CPRUs 25, base stations 30, or 101, WARPs 32, access routers 35, gateways 45, 57 and 60 and H.323 gatekeepers 55 of the wireless access system 10, or 100.

In an embodiment, the management of two or more gateways 45, 57 and/or 60 and/or H.323 gatekeepers 55 is performed from a common node manager 854 platform. In an embodiment, the management of two or more access routers 35 is also performed from a common node manager 854 platform.

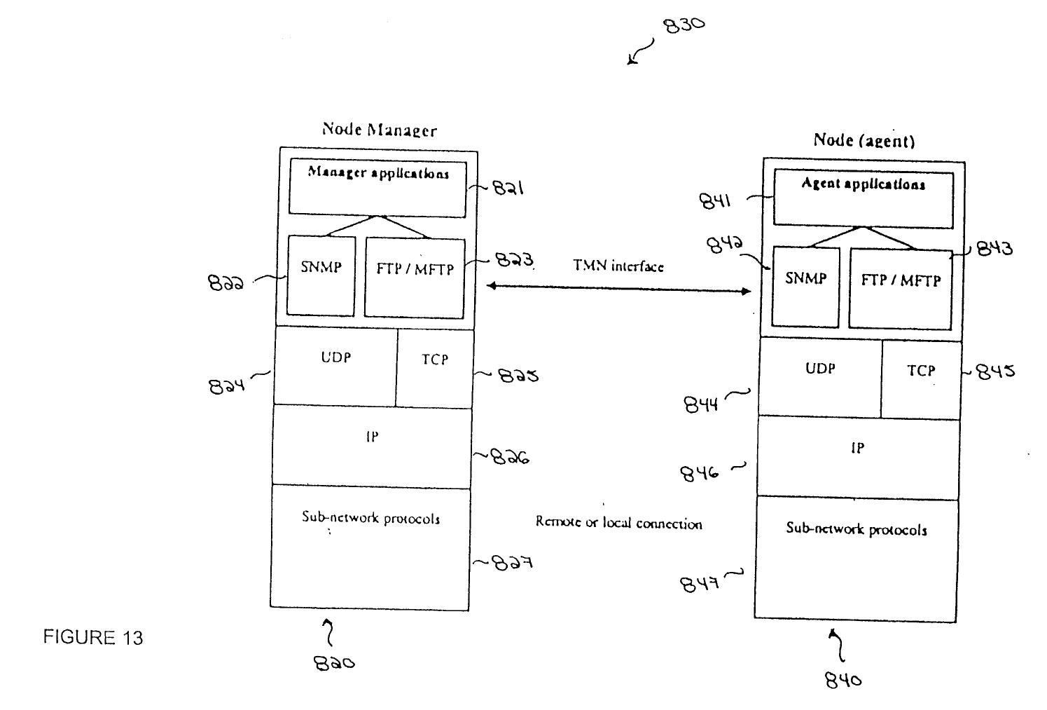

An embodiment of a generic management protocol architecture 830, as shown in FIG. 13, includes a node manager protocol stack 820, for either remote or local management processing, and a node element protocol stack 840. In an embodiment, the node manager protocol stack 820 is for the common node manager 854. In an embodiment, the node element protocol stack 840 is for the access routers 35, H.323 gateways 45, fax gateways 57, Internet gateways 60 and H.323 gatekeepers 55 of the wireless access system 10, or 100.

The manager applications layer 821 of the node manager protocol stack 820 supports the application functionality for network node management, including, but not limited to, configuration management, fault management, performance management, accounting management and security management. Likewise, the agent applications layer 841 of the node element protocol stack 840 supports the application functionality for network node management, including, but not limited to, configuration management, fault management, performance management, accounting management and security management.

The node manager protocol stack 820 and the node element protocol stack 840 comprise respective Simple Network Management Protocol (SNMP) layers 822 and 842 for managing the SNMP for the respective node management. The File Transfer Protocol (FTP)/Multicast File Transfer Protocol (MFTP) layer 823 of the node manager protocol stack 820 and the FTP/MFTP layer 843 of the node element protocol stack 840 support a choice of either FTP or MFTP for file transfers between the node manager 854 and the respective node 856.

Underlying, and thereby supporting, the network node management protocols, i.e., SNMP, FTP and MFTP, is a Transmission Control Protocol (TCP)/Internet Protocol (IP) channel, or connection, for the transfer of management data requiring a secure, i.e., reliable, transmission path. The TCP layer 825 and IP layer 826 of the node manager protocol stack 820 and the TCP layer 845 and IP layer 846 of the node element protocol stack 840 support secure TCP/IP channels for the transmission of management messages between the node manager 854 and the node 856.

Also underlying the network node management protocols is a User Datagram Protocol (UDP)/Internet Protocol (IP) channel, or connection, for the transfer of management data that can be transmitted over an unreliable transmission path. The UDP layer 824 and IP layer 826 of the node manager protocol stack 820 and the UDP layer 844 and IP layer 846 of the node element protocol stack 840 support unsecure UDP/IP channels for the transmission of management messages between the node manager 854 and the node 856.

The sub-network protocol layers 827 of the node manager protocol stack 820 and the sub-network protocol layers 847 of the node element protocol stack 840 support underlying transmission protocols for managing the physical interfaces for transmission of node management messages between the node manager 854 and the node 856.

In an embodiment, in the wireless access system 10 each base station 30 is paired with a Wireless Adjunct inteRnet Platform (WARP) 32, which together form a Base Station System (BSS). In an alternative embodiment of a wireless access system 10, one WARP 32 is paired with two or more base stations 30 to comprise a BSS. In an embodiment, in the wireless access system 100 each base station 101 comprises a BSS. Each BSS in the wireless access system 10, or system 100, is managed independently.

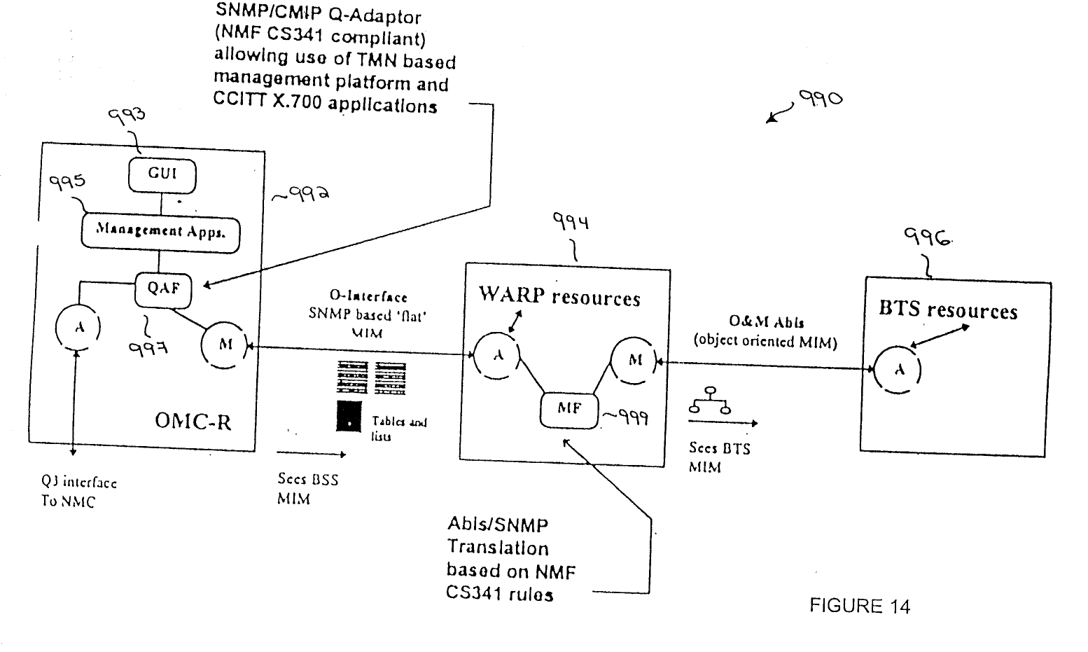

In an embodiment, the management architecture for a BSS is based on the ETSI GSM (Global System for Mobile communication) 12 series standard, such that the management functionality is cascaded as shown in FIG. 14. An embodiment BSS management architecture 990 for a wireless access system 10 generally results from supporting a GSM Abis interface between a WARP 32 and a base station 30. In an embodiment, a BSS is managed by a BSS management platform 124 supported by the Operation and Maintenance Center (OMC) 72 of the system 10, or 100.

In an embodiment, the Simple Network Management Protocol (SNMP) is used for managing the WARPs 32 and base stations 30 from the OMC 72 of the wireless access system 10. In an embodiment, SNMP is also used for managing the base stations 101 from the OMC 72 of the wireless access system 100. Among other benefits, SNMP helps avoid the complexity, memory and processing requirements associated with support of a TMN Q3 interface between the OMC 72 and the Network Management System (NMS) 80 of the Operations Support System (OSS) 70.

The use of SNMP in this manner requires interworking between object oriented management information protocols supported on the NMS 80 and the SNMP functions supported within the respective WARPs 32 and base stations 30. In an embodiment, use of the TMN-based management protocols, or platform, for Base Station System (BSS), i.e., a WARP 32-base station 30 pair, management includes the adaptation of SNMP structures to object oriented management protocols, such as, but not limited to, GDMO and CORBA IDL. In an embodiment, the interworking between the TMN-based object oriented management information protocols and SNMP is accomplished via the NMF CS341 standards, and is performed by the BSS management platform 124.

In the wireless access system 10, and system 100, the BSS management platform 124 and the terminal management platform 122 are structured around the TMN model and implement the systems management functions defined within the CCITT X.700 series standards. SNMP is used for the CPRU 25, base station 30, or 101, and WARP 32 node management, in part, due to the extensive use of IP networking within the system 10, or 100. While SNMP adheres to the basic tenants of TMN, it cannot be used directly with generic TMN platforms. Thus, in an embodiment, adaptation, or mediation, protocol layers are included in the BSS and terminal management platforms 124 and 122. These adaptation protocol layers provide the interworking between the TMN protocols supported by the NMS 80 and SNMP supported by the CPRUs 25, base stations 30 and 101, and WARPs 32.

In the BSS management architecture 990, an Operation and Maintenance Center (OMC) management platform 992 interfaces with each of the WARP node management platforms 994 supported by respective WARPs 32 of the system 10. The OMC platform 992 also interfaces with each of the base station node management platforms 996 supported by respective base stations 30 of system 10, or base stations 101 of system 100. In the system 10, the OMC platform 992 interfaces with each of the base station node management platforms 996 via the WARP node management platform 994 of the WARP 32 comprising the respective Base Station System (BSS).

In an embodiment, the OMC management platform 992 comprises a Graphical User Interface (GUI) 993 for operator interaction in the network management functionality. The OMC management platform 992 further comprises management applications support and functionality 995 for processing the management functionality with the respective BSSs of the system 10, or 100. The OMC management platform 992 also comprises a Simple Network Management Protocol (SNMP)/CMIP Q-Adaptor functionality 997, which supports use of a TMN-based BSS management platform and CCITT X.700 applications within the system 10. The SNMP/CMIP Q-Adaptor functionality 997 supports the interworking between the TMN-based object oriented management information protocols supported by the NMS 80 and SNMP supported by the CPRUs 25, base stations 30 and 101, and WARPs 32.

In an embodiment, a WARP node management platform 994 comprises an Abis interface/SNMP translation functionality 999 based on the NMF CS341 protocol rules. The Abis interface/SNMP translation functionality 999 supports management protocols transmitted on the GSM Abis interface between a WARP 32 and a base station 30.

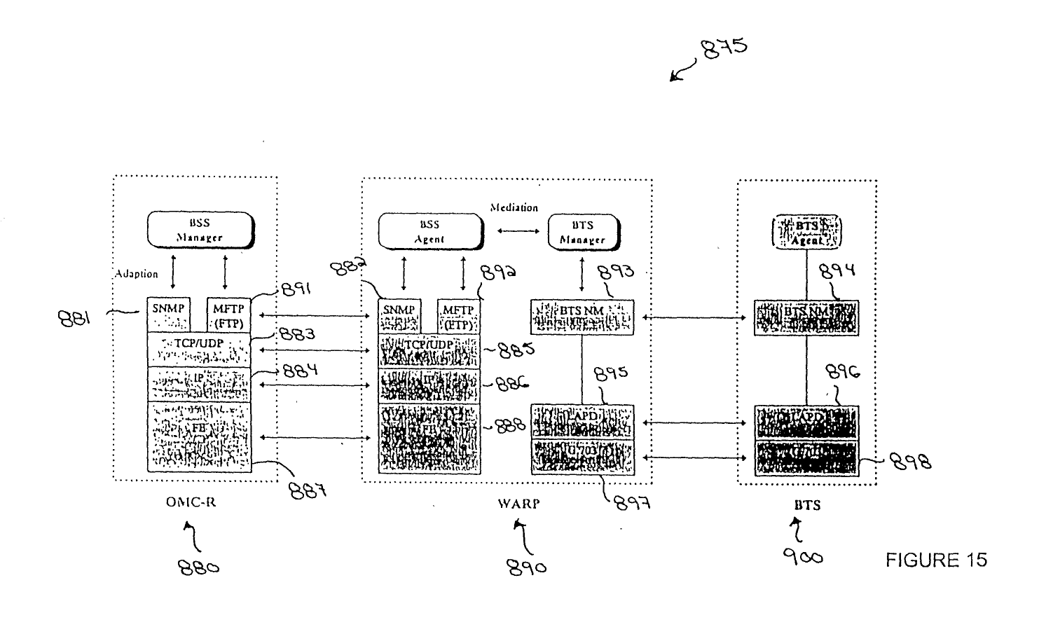

An embodiment of a BSS management protocol architecture 875, as shown in FIG. 15, includes an Operation and Maintenance Center (OMC) protocol stack 880, a WARP protocol stack 890 and a base station protocol stack 900. In the BSS management protocol architecture 875, the OMC 72 supports the BSS management platform 124. In the BSS management protocol architecture 875, the WARP 32 of a BSS supports both BSS WARP agent management functionality and BSS base station manager functionality. In the BSS management protocol architecture 875, the base station 30 of a BSS supports base station agent management functionality.

In the BSS management protocol architecture 875, the Simple Network Management Protocol (SNMP) is used for management protocols. Critical SNMP-based management procedures are acknowledged at the respective application layers.

In the BSS management protocol architecture 875, SNMP relies on underlying unreliable User Datagram Protocol (UDP)/Internet Protocol (IP) transport channels, or connections, for the transmission of management protocols for the management of BSSs. The OMC protocol stack 880 comprises an SNMP layer 881, a TCP/UDP layer 883 supporting UDP functionality and an IP layer 884. Likewise, the WARP protocol stack 890 comprises an SNMP layer 882, a TCP/UDP layer 885 supporting UDP functionality and an IP layer 886.

In an embodiment, file transfers between the OMC 72 and a WARP 32 of a BSS are accomplished via the Multicast File Transfer Protocol (MFTP). MFTP relies on Internet Protocol (IP)-Multicast networking and the User Datagram Protocol (UDP) for file transfers, and the reliable Transmission Control Protocol (TCP) for negative acknowledgements, to achieve reliable management file transfers within the wireless access system 10. Thus, the OMC protocol stack 880 comprises an MFTP layer 891, which also encompasses the File Transfer Protocol (FTP) functionality. The TCP/UDP layer 883 of the OMC protocol stack 880 supports the TCP functionality used in node management file transfers. The WARP protocol stack 890 also comprises an MFTP layer 892, which encompasses the FTP functionality. The TCP/UDP layer 885 of the WARP protocol stack 890 supports the respective TCP functionality.

Generally, greater efficiency for multicast file transfers is achieved by use of broadcast within the final subnetwork layer between the OMC 72 and a WARP 32; therefore, in an embodiment, the broadcast capabilities of fast ethernet are used for file transfers between the OMC 72 and a WARP 32. The OMC protocol stack 880 and the WARP protocol stack 890 comprise respective fast ethernet layers 887 and 888.

The operation and maintenance of the GSM Abis interface between a respective WARP 32 and a base station 30, together comprising a BSS, is based on the GSM 12.21 standards for base station management; the GSM 12.21 standards themselves are aligned with the principles of the TMN model and the CCITT.X.700 series Service Management Functionalities (SMFs). Thus, the WARP protocol stack 890 and the base station protocol stack 900 comprise respective base station network management layers 893 and 894 for supporting GSM Abis interface operation and maintenance functionality.

In an embodiment, the underlying protocol for management control between a WARP 32 and a base station 30 is the Link Access Procedures for the D-Channel (LAPD) protocol. Thus, the WARP protocol stack 890 and the base station protocol stack 900 comprise respective LAPD protocol layers 895 and 896.

In an embodiment, the G.703 protocol is the physical interface protocol for the transmission of management control messages between a WARP 32 and a base station 30. Thus, the WARP protocol stack 890 and the base station protocol stack 900 comprise respective G.703 protocol layers 897 and 898.

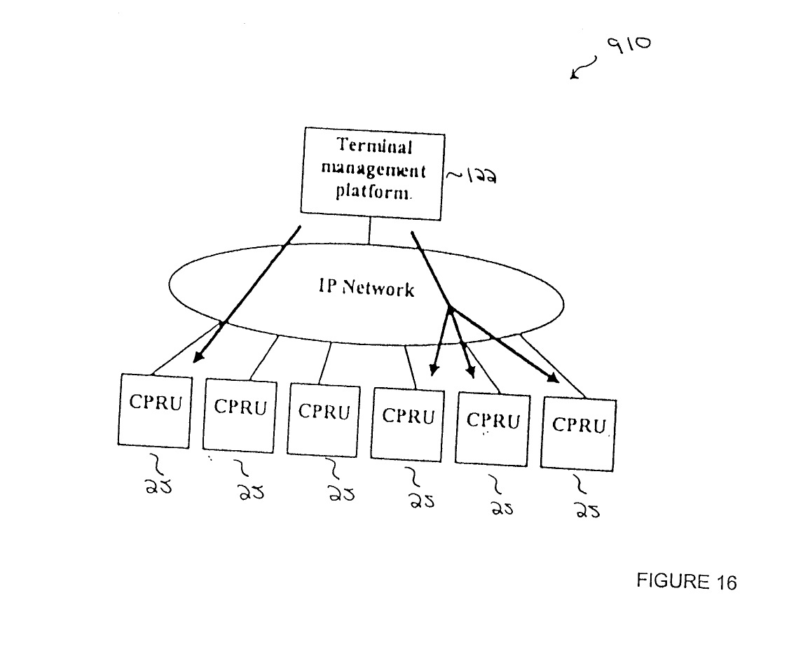

An embodiment of a terminal management architecture 910, as shown in FIG. 16, manages the CPRUs 25 of the wireless access system 10, or 100, from the terminal management platform 122. In an embodiment, the CPRUs 25 of the system 10, or 100, are managed using the Internet Protocol (IP)-based Simple Network Management Protocol (SNMP) and the Multicast File Transfer Protocol (MFTP). In an embodiment, due to the generally large number of CPRUs 25 in the system 10, or 100, CPRU management interactions are minimized.

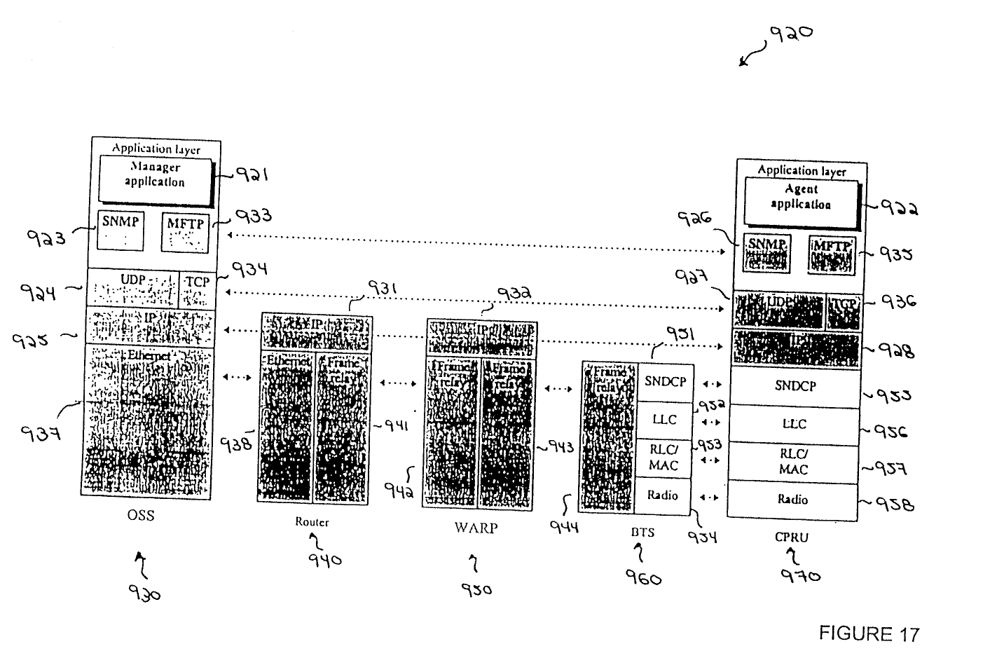

An embodiment of a terminal, or CPRU, management protocol architecture 920, as shown in FIG. 17, includes an Operations Support System (OSS) protocol stack 930, an access router protocol stack 940, a WARP protocol stack 950, a base station protocol stack 960 and a CPRU protocol stack 970. In the CPRU management protocol architecture 920, the OSS 70 supports the terminal management platform 122, and each CPRU 25 supports the CPRU agent management applications and functionality 922, for CPRU network management processes.

In the CPRU management protocol architecture 920, the Simple Network Management Protocol (SNMP) is used for management protocols. Critical SNMP-based management procedures are acknowledged at the respective application layers.

In the CPRU management protocol architecture 920, SNMP relies on underlying unreliable User Datagram Protocol (UDP) and Internet Protocol (IP) transport channels, or connections, for the transmission of management protocols for the management of CPRUs 25. Thus, the OSS protocol stack 930 comprises an SNMP layer 923, a UDP layer 924 and an IP layer 925. Likewise, the CPRU protocol stack 970 comprises an SNMP layer 926, a UDP layer 927 and an IP layer 928.

As the management protocols used in the CPRU management protocol architecture 920 rely on the underlying Internet Protocol (IP), the access router protocol stack 940 and the WARP protocol stack 950 also comprise respective IP layers 931 and 932.

In an embodiment, file transfers between the OSS 70 and a CPRU 25 are accomplished via the Multicast File Transfer Protocol (MFTP). MFTP relies on Internet Protocol (IP)-Multicast networking and the User Datagram Protocol (UDP) for file transfers, and the reliable Transmission Control Protocol (TCP) for negative acknowledgements, to achieve reliable management file transfers within the wireless access system 10, or 100. Thus, the OSS protocol stack 930 comprises an MFTP layer 933 and a TCP layer 934. The CPRU protocol stack 970 also comprises an MFTP layer 935 and a TCP layer 936.

Generally, greater efficiency for multicast file transfers is achieved by use of broadcast within the final subnetwork layer between a CPRU 25 and the Base Station System (BSS) the CPRU 25 communicates with; therefore, the broadcast capabilities of GPRS (General Packet Radio Service) PTM (Point-To-Multipoint) functionality are used for file transfers between a BSS and one or more CPRUs 25. In an embodiment, the Point-To-Multipoint routing is performed at the respective Internet Protocol (IP) layers 932 and 928 of the WARP 32 of the BSS and the CPRU 25 in the system 10.

In an embodiment, the subnetwork layer for management message transports between the OSS 70 and an access router 35 providing connectivity to the CPRUs 25 of the system 10, or 100, is ethernet. Thus, the OSS protocol stack 930 and the access router protocol stack 940 comprise respective ethernet layers 937 and 938.

In an embodiment, the subnetwork layer for management message transports in the CPRU management protocol architecture 920 between an access router 35 and a BSS, comprising a WARP 32-base station 30 pair, is frame relay. Thus, the access router protocol stack 940 comprises a frame relay layer 941, the WARP protocol stack 950 on the network-side comprises a frame relay layer 942 and on the user-side comprises a frame relay layer 943, and the base station protocol stack 960 comprises a frame relay layer 944.

In an embodiment, communications between a base station 30 and a CPRU 25 for network node management is supported by the SubNetwork Dependent Convergence Protocol (SNDCP), which relies on the underlying Logical Link Control (LLC) protocol. In an embodiment, the subnetwork layer for management communications between a base station 30 and a CPRU 25 is provided by the Radio Link Control (RLC)/Medium Access Control (MAC) protocols. Further, a radio physical interface is used for the transport of management messages between a base station 30 and a CPRU 25. Thus, the base station protocol stack 960 comprises an SNDCP layer 951, an LLC layer 952, an RLC/MAC layer 953 and a radio physical interface layer 954. Likewise, the CPRU protocol stack 970 comprises an SNDCP layer 955, an LLC layer 956, an RLC/MAC layer 957 and a radio physical interface layer 958.

In an embodiment, the CPRUs 25, WARPs 32 and base stations 30 and 101 of wireless access systems 10 and 100 status their own hardware resources to the respective Operation and Maintenance Center (OMC) 72, including, but not limited to, a unique resource description that identifies the respective resource, i.e., the resource type, the version of the particular resource type, and the location of the resource. The hardware resource information of a respective CPRU 25, WARP 32 or base station 30 or 101 is provided to the system's OMC 72 upon the respective CPRU's, WARP's or base station's power on or reset. The hardware resource information of a respective CPRU 25, WARP 32 or base station 30 or 101 is also provided to the OMC 72 as part of a hardware failure status report.

In an embodiment, the CPRUs 25, WARPs 32 and base stations 30 and 101 of wireless access systems 10 and 100 status their own software and firmware resources to the respective OMC 72, including, but not limited to, a resource type identification and the version of the software and/or firmware executing on the respective CPRU 25, WARP 32 or base station 30 or 101. The software/firmware resource information of a CPRU 25, WARP 32 or base station 30 or 101 is provided to the system's OMC 72 upon the respective CPRU's, WARP's, or base station's power on or reset.

In an embodiment, at least one version of all software and firmware files required for base station operation is located in non-volatile memory of each respective base station 30 of the system 10, or base station 101 of the system 100. Likewise, in an embodiment, at least one version of all software and firmware files required for Customer Premise Radio Unit (CPRU) operation is located in non-volatile memory of each respective CPRU 25 of the system 10 or 100. Too, in an embodiment, at least one version of all software and firmware files required for Wireless Adjunct inteRnet Platform (WARP) operation is located in non-volatile memory of each respective WARP 32 of the system 10.

In an embodiment, CPRUs 25, WARPs 32 and base stations 30 and 101 of wireless access systems 10 and 100 each support updating their respective individual software and/or firmware files. CPRUs 25, WARPs 32 and base stations 30 and 101 also each support complete respective software/firmware version updates.

The software and firmware files of the respective CPRUs 25, WARPs 32 and base stations 30 and 101 each comprise customization parameters that support customization of the respective CPRUs 25, WARPs 32 and base stations 30 and 101.

The CPRUs 25, WARPs 32 and base stations 30 and 101 of wireless access systems 10 and 100 each generate and maintain hardware/software/firmware status, and provide this status to the respective system OMC 72. The hardware/software/ firmware status of a CPRU 25, WARP 32 and base station 30 and 101 comprises the ability of the respective CPRU 25, WARP 32 or base station 30 or 101 to support wireless access services within the system 10 or 100.

Self-testing is performed by each CPRU 25, WARP 32 and base station 30 and 101 on power on and reset, to verify their respective correct operations. A self-test for each base station 30 and 101 comprises a loop test for verification of the respective base station's over-the-air interface. A self-test for each CPRU 25 comprises a loop test for verification of the respective CPRU's over-the-air interface.

Each CPRU 25, WARP 32 and base station 30 and 101 in wireless access systems 10 and 100 supports self-supervision functionality to detect failures due to equipment, processing, communications, quality of service and environment conditions. The respective self-supervision functionality further supports providing failure information to the system's OMC 72, via hardware status failure reports. In an embodiment, reported failures include the type of failure, the severity of the failure and the identity of any failing component of the respective CPRU 25, WARP 32 or base station 30 or 101. The self-supervision functionality of each CPRU 25, WARP 32 and base station 30 and 101 also comprises determining when a previously detected failure has ceased, or otherwise corrected itself.

In an embodiment, whenever a base station 30 of the wireless access system 10 or a base station 101 of the wireless access system 100 is operational, it performs a measurement collection functionality. In an embodiment, the measurement collection functionality includes, but is not limited to, a determination of the uplink radio quality and signal strength on each base station 30 or 101 for all used, i.e., busy, over-the-air channels, the signal strength on idle, i.e., not used, over-the-air channels, the success rate of over-the-air interface procedures, and the availability and usage of the base station's over-the-air resources.

The base stations' measured, and/or collected values, or results, are reported to the wireless access system 10 or 100, based on a network configurable reporting period. Any base station 30 and 101 may also be requested by the respective system 10 or 100 to cease measurement value reporting. Further, any base station 30 or 101 that was previously requested to cease measurement value reporting may be instructed to resume measurement value reporting.

### Communications Processing

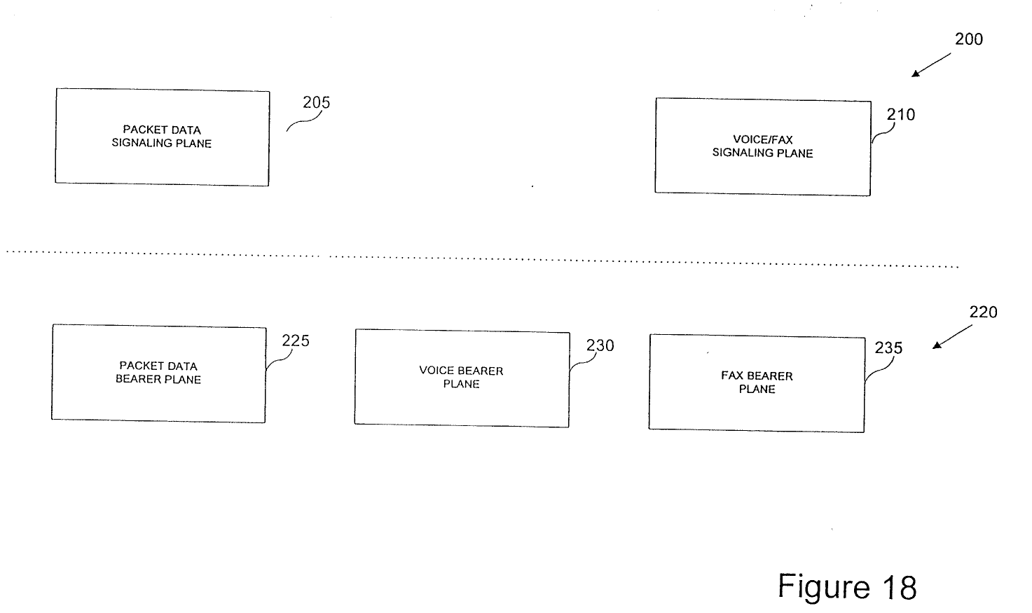

The wireless access networks 10 and 100 comprise five planes for communication, as shown in FIG. 18. A signaling plane 200 includes a packet data signaling plane 205 for communications signaling for packet data transfers, or transmissions. The signaling plane 200 also comprises a voice/fax signaling plane 210 for communications signaling for packet voice and fax transfers, or transmissions.

A bearer plane 220 includes a packet data bearer plane 225 for packet data transmissions. The bearer plane 220 also comprises a voice bearer plane 230 for IP packet voice transmissions. The bearer plane 220 further comprises a fax bearer plane 235 for IP packet fax transmissions.

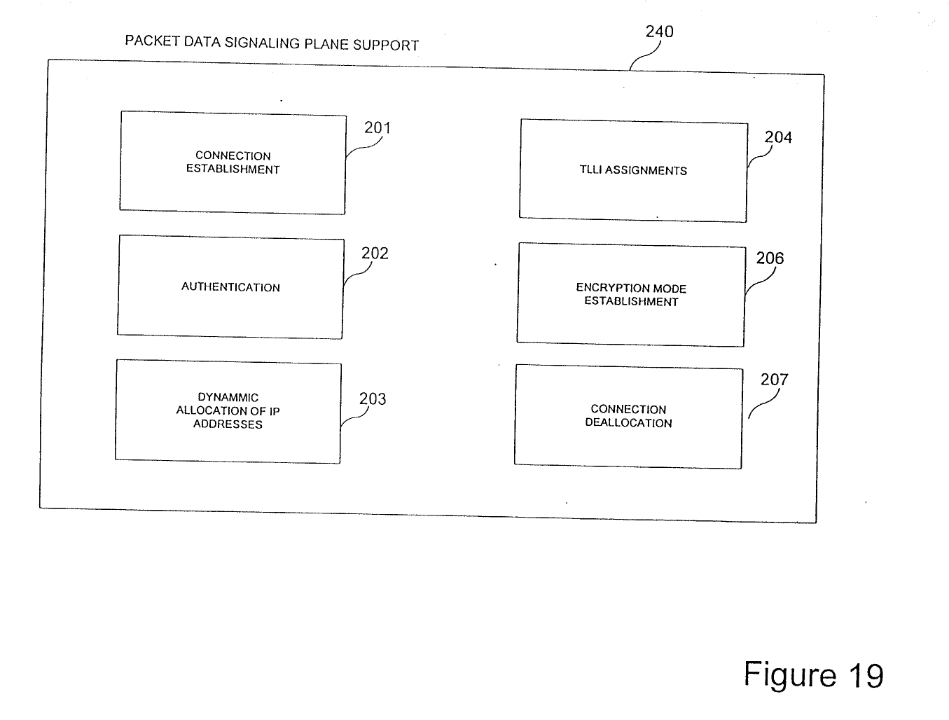

In an embodiment, in the packet data signaling plane 205 functions, or procedures, 240 are executed, or otherwise processed, for the control, support and maintenance of the packet data bearer plane 225 functionality, as shown in FIG. 19.

The packet data signaling plane procedures 240 comprise a procedure 201 for the initial connection establishment of a CPRU 25 to the system 10 or 100, for subsequent receipt and transmission of packet data messages. More specifically, the connection establishment procedure 201 comprises functionality for the establishment of a physical transmission path, or connection, or communication channel, from a CPRU 25, through a base station 20 and WARP 32, or base station 101, for the subsequent receipt and transmission of packet data.

The packet data signaling plane procedures 240 also comprise a procedure 207 for the subsequent de-allocation, or release, of an established packet data transmission path.

The packet data signaling plane procedures 240 also comprise a procedure 202 for terminal authentication, as previously discussed. Further, the packet data signaling plane procedures 240 comprise a procedure 203 for the wireless access network's dynamic allocation of Internet Protocol (IP) addresses to subscriber terminals 21. In an embodiment, the WARP 32 that a CPRU 25 communicates in the system 10 with allocates an IP address to the CPRU 25 of a respective terminal 21. In an alternative embodiment, the base station 101 that a CPRU 25 communicates in the system 100 with allocates an IP address to the CPRU 25 of a respective terminal 21.

The packet data signaling plane procedures 240 also comprise a procedure 204 for the network's assignment of temporary logical link layer addresses, i.e., a Temporary Logical Link Identity (TLLI), to the CPRUs 25, for terminal communication addressing within the wireless access network 10, or 100. A TLLI is a temporary terminal identity that provides subscriber confidentiality; i.e., with the use of TLLIs, the user identity on the over-the-air interface 27 of the wireless access network 10 or 100 is protected from disclosure to unauthorized individuals, entities or processes.

A TLLI identifies a network terminal 21. In an embodiment, in the wireless access system 10, the relationship between the TLLI and the fixed address of a terminal, i.e., the terminal's International Mobile Subscriber Identity (IMSI), is known only to the respective CPRU 25 of the terminal 21 and the WARP 32 that the terminal communicates with. In an alternative embodiment, in the wireless access system 100, the relationship between the TLLI and the fixed address of a terminal is known only to the respective CPRU 25 of the terminal 21 and the base station 101 that the terminal communicates with. In a presently preferred embodiment, the IMSI of a terminal 21 is used as its wireless access subscriber authentication value and its billing identity.

The IMSI of a terminal 21 is structured into a Mobile Country Code (MCC) plus (+) a Mobile Network Code (MNC) plus (+) a Mobile Station Identification Number (MSIN). A specific, unique Mobile Network Code is associated with a wireless access network 10 and a wireless access network 100.

In an embodiment, a TLLI is allocated to a CPRU 25 at the CPRU's power up by a WARP 32. A TLLI is allocated via Terminal Management Protocol (TMP) signaling between the respective CPRU 25 and the WARP 32 it communicates with. In an alternative embodiment, a TLLI is allocated to a CPRU 25 at the CPRU's power up by a base station 101, using TMP signaling between the respective base station 101 and the CPRU 25.

The packet data signaling plane procedures 240 also comprise a procedure 206 for the establishment of an encryption mode for packet data transmissions. In an embodiment, encryption is based on a public key scheme using the RC4 algorithm. In an embodiment, the encryption scheme requires a key exchange procedure to be executed as a signaling exchange between a CPRU 25 and a WARP 32, upon power on of the CPRU 25. In an alternative embodiment, the encryption scheme requires a key exchange procedure to be executed as a signaling exchange between a CPRU 25 and a base station 101, upon power on of the CPRU 25. The Terminal Management Protocol (TMP) is used to support encryption signaling.

In an embodiment, the encryption mode establishment procedure 206 includes, but is not limited to, enabling and disabling encryption for packet data transmissions on the over-the-air interface 27 between a CPRU 25 and a base station 30 and between the respective base station 30 and a WARP 32. In an alternative embodiment, the encryption mode establishment procedure 206 includes, but is not limited to, enabling and disabling encryption for packet data transmissions on the over-the-air interface 27 between a CPRU 25 and a base station 101.

The encryption mode establishment procedure 206 also supports the derivation of keys to be used to encrypt and decrypt messages, if encryption is enabled. In an embodiment, if encryption is enabled, the encryption keys are supplied to the Logical Link Control (LLC) layers, as further discussed below, of the respective CPRU 25 and WARP 32 protocol stacks. In an alternative embodiment, if encryption is enabled, the encryption keys are supplied to the LLC layers of the respective CPRU 25 and base station 101 protocol stacks.

The packet data bearer, or transmission, plane 225 of FIG. 18 is a wireless subnetwork operating via Internet Protocols (IPs). In an embodiment, the packet data bearer plane 225 comprises a layered protocol structure that supports user information, i.e., packet data transmissions, and associated user information data transmit control processing. The user information data transmit control processing includes, but is not limited to, packet data transmission flow control functionality, and data transmission error detection and error correction/recovery functionality.

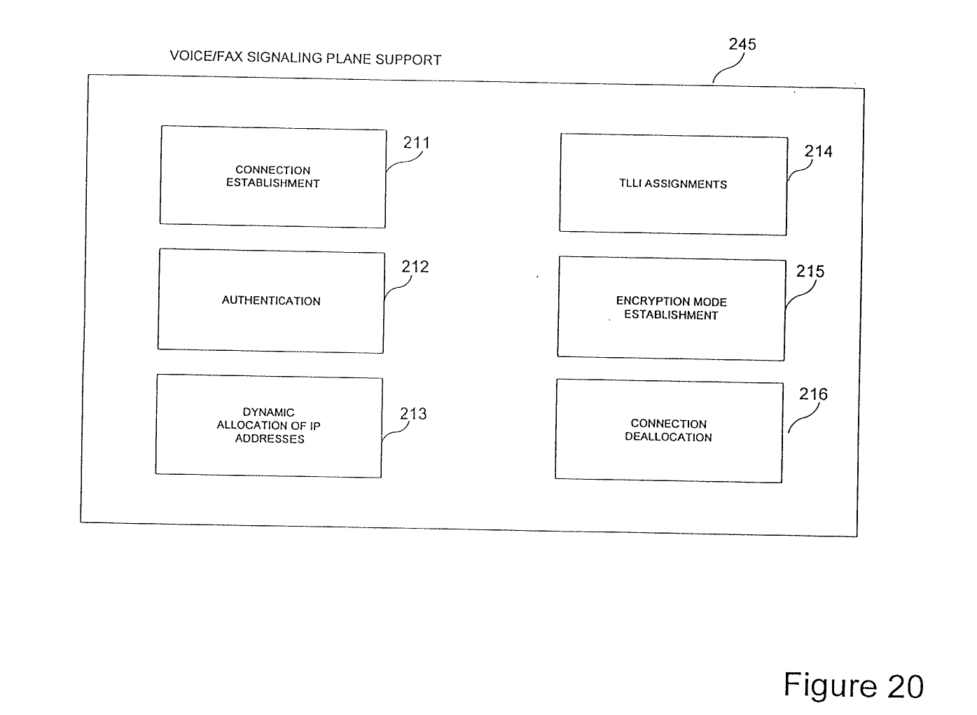

In an embodiment, the voice/fax signaling plane 210 comprises functions, or procedures, 245 as shown in FIG. 20, for the control, support and maintenance of the voice bearer plane 230 and the fax bearer plane 235.

The voice/fax signaling plane procedures 245 comprise a procedure 211 for the initial connection establishment of an H.323 terminal 17 or fax terminal 14 to the system 10 or 100. In an embodiment, the connection establishment procedure 211 comprises functionality for the establishment of a physical transmission path, or connection, or communication channel, from the CPRU 25 of an H.323 terminal 17 or fax terminal 14 to the WARP 32 of the cell the CPRU 25 is located in, for the subsequent receipt and transmission of IP packet voice and/or IP packet fax messages. In an alternative embodiment, the connection establishment procedure 211 comprises functionality for the establishment of a physical transmission path from the CPRU 25 of an H.323 terminal 17 or fax terminal 14 to the base station 101 of the cell the CPRU 25 is located in, for the subsequent receipt and transmission of IP packet voice and/or IP packet fax messages.

The voice/fax signaling plane procedures 245 also comprise a procedure 216 for the subsequent de-allocation, or release, of an established IP packet voice or fax transmission path.

The voice/fax signaling plane procedures 245 also comprise procedures 212 for subscriber and terminal authentication, as previously discussed. The voice/fax signaling procedures 245 also comprise a procedure 213 for the wireless access network's dynamic allocation of Internet Protocol (IP) addresses to the CPRUs 25 of H.323 terminals 17 and fax terminals 14. In an embodiment, the WARP 32 that a CPRU 25 communicates in the system 10 with allocates an IP address to the CPRU 25 of a respective terminal 17 or 14. In an alternative embodiment, the base station 101 that a CPRU 25 communicates in the system 100 with allocates an IP address to the CPRU 25 of a respective terminal 17 or 14.

The voice/fax signaling plane procedures 245 further comprise a procedure 214 for the system's assignment of temporary logical link layer addresses, i.e., a Temporary Logical Link Identity (TLLI), to the CPRUs 25, for terminal communication addressing within the wireless access system 10, or 100. A TLLI identifies the respective network H.323 terminal 17 or network fax terminal 14. In an embodiment, in the wireless access system 10, the relationship between the TLLI and the fixed address of an H.323 terminal 17 or fax terminal 14, i.e., the respective terminal's International Mobile Subscriber Identity (IMSI), is known only to the CPRU 25 of the terminal 17 or 14 and the WARP 32 that the terminal communicates with. In an alternative embodiment, in the wireless access system 100, the relationship between the TLLI and the fixed address of an H.323 terminal 17 or fax terminal 14 is known only to the respective CPRU 25 and the base station 101 that the terminal communicates with.

In an embodiment, a TLLI is allocated to a CPRU 25 at the respective CPRU's power up by a WARP 32. A TLLI is allocated via Terminal Management Protocol (TMP) signaling between the respective CPRU 25 of the H.323 terminal 17 or fax terminal 14 and the WARP 32 it communicates with. In an alternative embodiment, a TLLI is allocated to a CPRU 25 at the CPRU's power up by a base station 101, using TMP signaling between the respective base station 101 and the CPRU 25.

The voice/fax signaling plane procedures 245 also comprise a procedure 215 for the establishment of an encryption mode for packet voice and fax message transmissions. In an embodiment, the encryption mode establishment procedure 215 includes, but is not limited to, enabling and disabling encryption for packet voice and fax message transmissions on the over-the-air interface 27 between a CPRU 25 and a base station 30 and between the respective base station 30 and a WARP 32. In an alternative embodiment, the encryption mode establishment procedure 215 includes, but is not limited to, enabling and disabling encryption for packet voice and fax message transmissions on the over-the-air interface 27 between a CPRU 25 and a base station 101.

The encryption mode establishment procedure 215 also supports the derivation of keys to be used to encrypt and decrypt messages, if encryption is enabled. In an embodiment, if encryption is enabled, the encryption keys are supplied to the Logical Link Control (LLC) layers, as further discussed below, of the respective CPRU 25 and WARP 32 protocol stacks. In an alternative embodiment, if encryption is enabled, the encryption keys are supplied to the LLC layers of the respective CPRU 25 and base station 101 protocol stacks.

The voice bearer, or transmission, plane 230 of FIG. 18 is a wireless subnetwork operating via underlying Internet Protocols (IPs). In an embodiment, the voice bearer plane 230 comprises a layered protocol structure that supports user information, i.e., voice message transmissions, and associated user information voice transmit control processing. The user information voice transmit control processing includes, but is not limited to, IP packet voice transmission flow control functionality and voice transmission error detection and error correction/recovery functionality.

The fax bearer, or transmission, plane 235 of FIG. 18 is a wireless subnetwork operating via Internet Protocols (IPs). In an embodiment, the fax bearer plane 235 comprises a layered protocol structure that supports user information, i.e., fax message transmissions, and associated user information fax transmit control processing. The user information fax transmit control processing includes, but is not limited to, IP packet fax transmission flow control and fax transmission error detection and error correction/ recovery functionality.

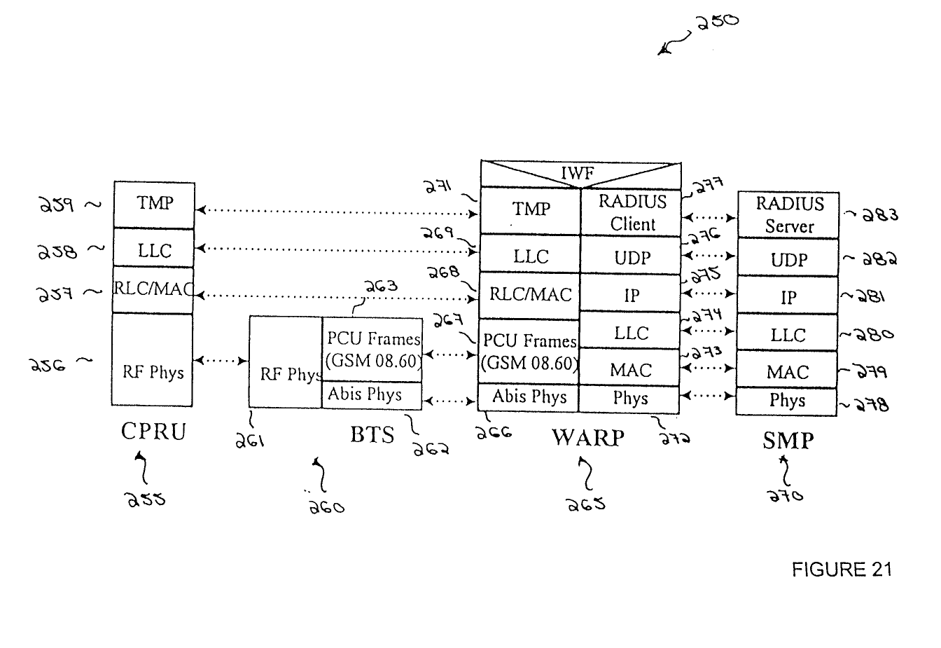

An embodiment of a packet data signaling plane architecture 250, shown in FIG. 21, for use in a wireless access system 10, comprises a protocol stack 255 for a CPRU 25, a protocol stack 260 for a base station, or base transceiver station (BTS), 30, a protocol stack 265 for a WARP 32, and a protocol stack 270 for a Subscriber Management Platform (SMP) 75 of the respective system's Operations Support System (OSS) 70.

In an embodiment, the CPRU protocol stack 255 comprises a radio physical layer 256, a Radio Link Control/Medium Access Control (RLC/MAC) layer 257, a Logical Link Control (LLC) layer 258 and a Terminal Management Protocol (TMP) layer 259.

In an embodiment, on the CPRU side, the base station protocol stack 260 comprises a radio physical layer 261.

In an embodiment, the radio physical layer 256 of the CPRU protocol stack 255 and the radio physical layer 261 of the base station protocol stack 260 each support, or otherwise comprise, a GSM/GPRS (Global System for Mobile communication/General Packet Radio Service) radio interface. In an alternative embodiment, the radio physical layers 256 and 261 each support, or otherwise comprise, a GSM/Edge (Global System for Mobile communication/Enhanced Data rates for GSM Evolution) radio interface. The respective radio physical layers 256 and 261 each conceptually consist of two sub-layers, defined by their respective functionality.

The first sub-layer, the physical RF sub-layer, performs the modulation of the physical waveform signals for signaling traffic, for subsequent transmission on the over-the-air interface 27 between a CPRU 25 and a base station 30. The modulation is based on the sequence of bits received from the second sub-layer, the physical link sub-layer. The physical RF sub-layer also performs the demodulation of received waveform signals for signaling traffic into sequences of bits, which are then transferred to the physical link sub-layer for interpretation.

The second sub-layer, the physical link sub-layer, provides the services for the signal traffic transmissions over a physical, wireless channel between a CPRU 25 and a base station 30. The physical link sub-layer functionality involves signal traffic transmissions and includes, but is not limited to, signal message transmissions, data unit framing, data coding and the detection and correction of physical medium transmission errors, for example, but not limited to, parity errors. The physical link sub-layer utilizes the services of the respective physical RF sub-layer to perform its functions.

In an embodiment, on the network side, the base station protocol stack 260 comprises an Abis physical layer 262 and a PCU (Packet Control Unit) frames layer 263.

In an embodiment, on the subscriber, or end user, side, the WARP protocol stack 265 comprises an Abis physical layer 266, a PCU frames layer 267, a Radio Link Control/Medium Access Control (RLC/MAC) layer 268, a Logical Link Control (LLC) layer 269 and a Terminal Management Protocol (TMP) layer 271.

The Abis physical layer 262 of the base station protocol stack 260 and the Abis physical layer 266 of the WARP protocol stack 265 each comprise functionality for managing the physical GSM Abis wireline interface between the respective base station 30 and WARP 32. The PCU frames layer 263 of the base station protocol stack 260 and the PCU frames layer 267 of the WARP protocol stack 265 each comprise the functionality for managing the framing of packet data signaling messages transmitted between a respective base station 30 and a WARP 32. In an embodiment, the respective PCU frames layers 263 and 267 support the GSM (Global System for Mobile communication) 8.60 standards.

The RLC/MAC layer 257 of the CPRU protocol stack 255 and the RLC/MAC layer 268 of the WARP protocol stack 265 each comprise a radio link control function and a medium access control function. In an embodiment, the RLC/MAC layers 257 and 268 employ the GPRS (General Packet Radio Service) protocols. In an alternative embodiment, the RLC/MAC layers 257 and 268 employ the GSM/Edge (Global System for Mobile communication/ Enhanced Data rates for GSM Evolution) protocols.

The Medium Access Control (MAC) layers of the respective RLC/MAC layers 257 and 268 are responsible for the radio, i.e., over-the-air, resource management functions of the wireless access system 10. The MAC layers provide data and signal multiplexing on both uplink and downlink channels of the over-the-air interface 27 between the respective CPRU 25 and base station 30. In an embodiment, the control for the multiplexing function resides with the WARP 32 that the respective base station 30 communicates with.

For CPRU-originated channel access, the MAC layer of the CPRU protocol stack 255 provides contention resolution functionality between channel access attempts. For CPRU-originated channel access, the MAC layer of the WARP protocol stack 265 provides contention resolution functionality between two or more CPRUs 25 attempting to gain access to the same base station channel(s).

For network-originated channel access, the MAC layer of the WARP protocol stack 265 is responsible for scheduling the various CPRU 25 access attempts. Thus, the MAC layer of the WARP protocol stack 265 coordinates respective CPRU system access attempts when the wireless access system 10 desires to establish a communication channel with a CPRU 25 of a terminal 21.

The MAC layer of the WARP protocol stack 265 also comprises functionality for the priority management and handling of bearer packet data traffic, i.e., packet data message transmissions.

The Radio Link Control (RLC) layers of the CPRU protocol stack 255 and the WARP protocol stack 265 provide a radio-dependent reliable link on the respective CPRU 25/system 10 transmission interface. The RLC layer of the CPRU protocol stack 255 is responsible for the transfer, or transmission, of Logical Link Control (LLC) frames of packet data signaling messages on the over-the-air interface 27 between the respective CPRU 25 and a base station 30. The RLC layer of the CPRU protocol stack 255 is also responsible for the segmentation of LLC frames into one or more Radio Link Control (RLC) blocks, for physical transmission on the over-the-air interface 27 to a base station 30. The RLC layer of the CPRU protocol stack 255 also provides the functionality for assembly of RLC blocks, which are transmitted to the CPRU 25 on the over-the-air interface 27 from a base station 30, into respective LLC frames.

The RLC layer of the WARP protocol stack 265 is responsible for the transfer, or transmission, of Logical Link Control (LLC) frames of packet data signaling messages on the over-the-air interface 27 between a base station 30 paired with the respective WARP 32 and a CPRU 25. The RLC layer of the WARP protocol stack 265 is also responsible for the segmentation of LLC frames into one or more Radio Link Control (RLC) blocks, for physical transmission on the over-the-air interface 27 from a base station 30 paired with the respective WARP 32 to a CPRU 25. The RLC layer of the WARP protocol stack 265 also provides the functionality for assembly of RLC blocks, which are transmitted on the over-the-air interface 27 to the base station 30 paired with the respective WARP 32 from a CPRU 25, into LLC frames.

The RLC layers of the CPRU protocol stack 255 and WARP protocol stack 265 are also responsible for maintaining and executing backward error correction procedures that enable selective retransmission of uncorrectable Radio Link Control (RLC) blocks transmitted between a base station 30 paired with the respective WARP 32 and the CPRU 25. Further, the RLC layers of the CPRU protocol stack 255 and WARP protocol stack 265 each support packet data signaling transmission flow control.

The RLC layer of the WARP protocol stack 265 also supports the execution of algorithms for radio resource management functions of the system 10, including, but not limited to, over-the-air channel management and scheduling.

The Logical Link Control (LLC) layer 258 of the CPRU protocol stack 255 provides a reliable, radio-independent, logical link for communications between the respective CPRU 25 and a WARP 32. Likewise, the Logical Link Control (LLC) layer 269 of a WARP protocol stack 265 provides a reliable, radio-independent, logical link for communications between the respective WARP 32 and a CPRU 25. Logical Link Control (LLC) links are used to transfer packet data signaling traffic between a CPRU 25 and a WARP 32 in the packet data signaling plane 205. Thus, an LLC link is first established between a CPRU 25 and a WARP 32, for subsequent packet data signaling transmissions between them.

In an embodiment, the LLC protocol employed in the Logical Link Control (LLC) layers 258 and 269 is specified in the GPRS (General Packet Radio Service) Specification 04.64. This LLC protocol is designed to be independent of the underlying radio protocols for over-the-air interface transmissions. A Temporary Logical Link Identity (TLLI) assigned to a CPRU 25 by a WARP 32 is used for addressing at the LLC layers 258 and 269.

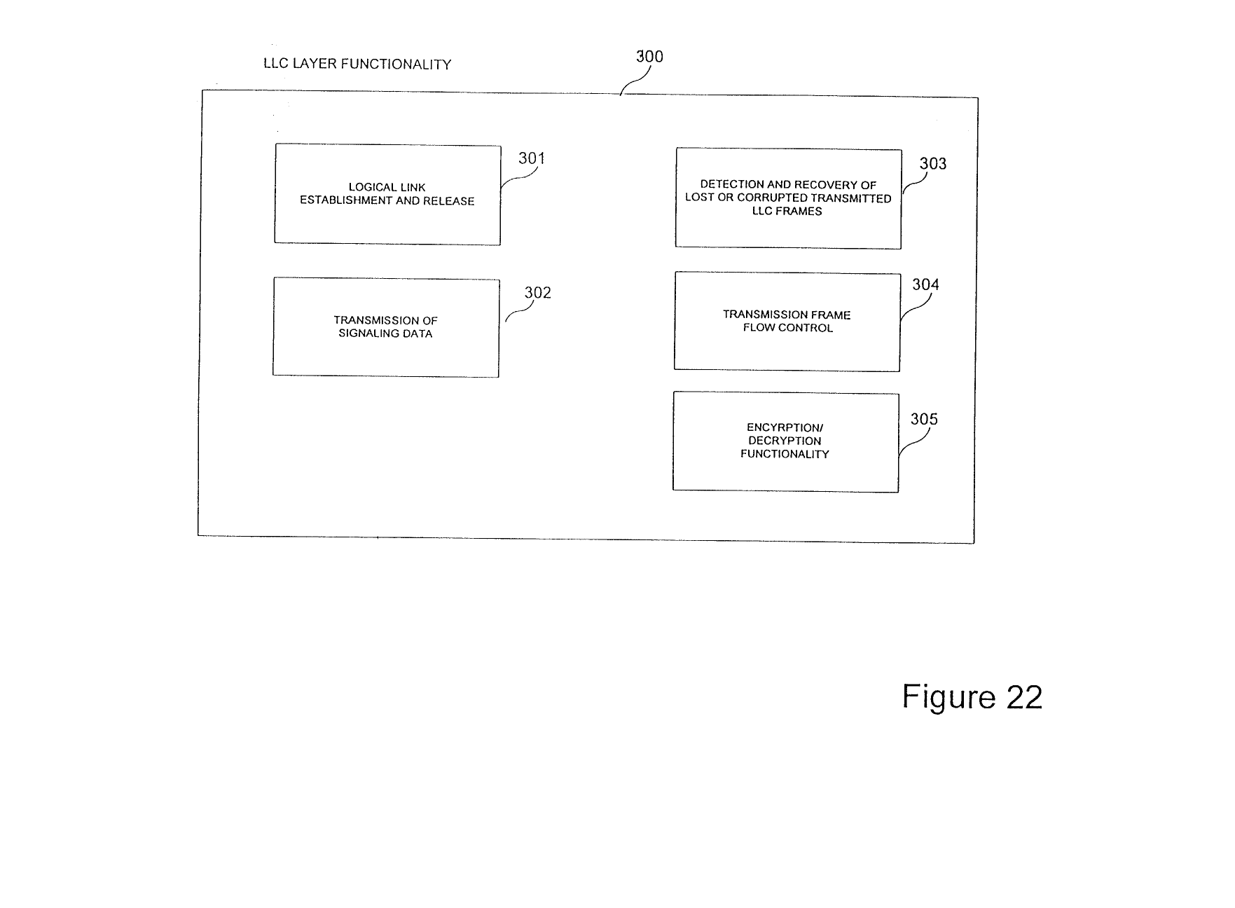

The LLC layers 258 and 269 of the respective CPRU protocol stack 255 and WARP protocol stack 265 support a variety of procedures, or functions, 300 for logical link control, as shown in FIG. 22. The respective LLC layers functionality 300 comprises a procedure 301 for the establishment, and subsequent release, of LLC links between a CPRU 25 and a WARP 32. LLC links are used for transmitting signaling messages between a CPRU 25 and a WARP 32, for the management of packet data transmissions.

The LLC layers functionality 300 also comprises a procedure 302 for the transfer, or transmission, of signaling messages for packet data communication channel establishment, maintenance, statusing and release, between a CPRU 25 and a WARP 32. In an embodiment, the procedure 302 for the transmission of packet data signaling traffic supports unacknowledged point-to-point signaling message transmissions. In an embodiment, the procedure 302 for the transmission of packet data signaling traffic also supports acknowledged, reliable, point-to-point signaling message transmissions.

The LLC layers functionality 300 further comprises a procedure 303 for detecting and recovering from lost or corrupted transmitted Logical Link Control (LLC) frames of packet data signaling messages. The LLC layers functionality 300 also comprises a procedure 304 for controlling the transmission flow of LLC frames of packet data signaling messages. Too, the LLC layers functionality 300 comprises a procedure 305 for supporting encryption and decryption of LLC frames of packet data signaling messages transmitted between a CPRU 25 and a WARP 32.

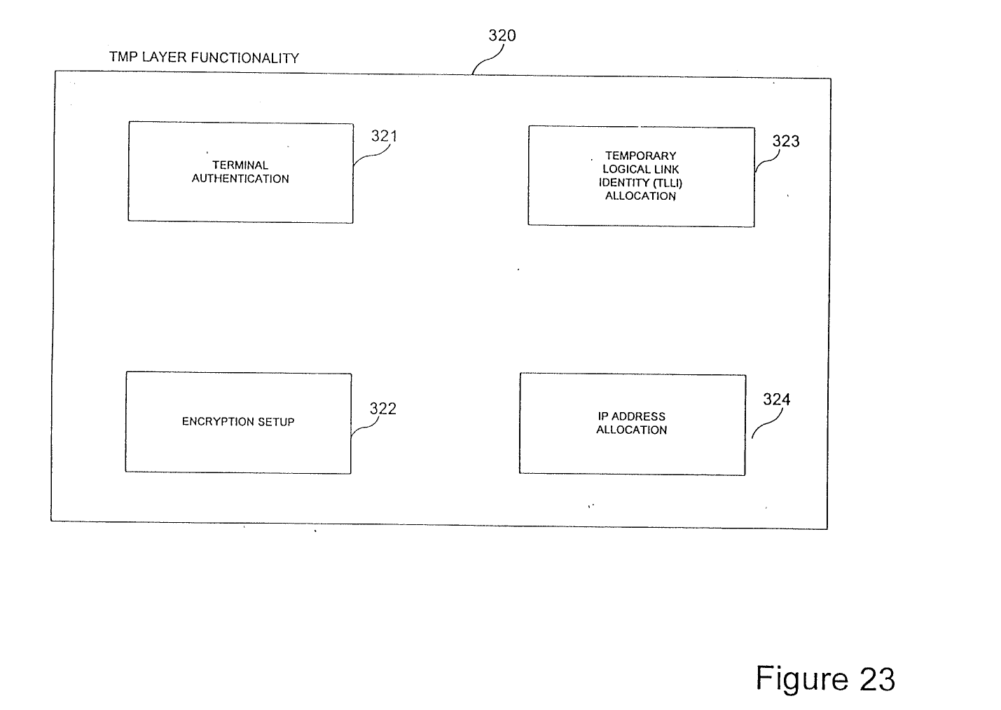

Referring to FIG. 21, the Terminal Management Protocol (TMP) layer 259 of the CPRU protocol stack 255 and the TMP layer 271 of the WARP protocol stack 265 each provides peer-to-peer procedures between the respective CPRU 25 and WARP 32 to support network terminal management. The TMP layers 259 and 271 support a variety of procedures, or functions, 320, as shown in FIG. 23.

The TMP layers functionality 320 comprises a procedure 321 for terminal authentication. Generally, the terminal authentication procedure 321 prevents the unauthorized use of the respective wireless access system 10 services. The terminal authentication procedure 321 is also used to prevent fraudulent impersonations of valid subscribers on the system 10. An embodiment of a terminal authentication procedure 321 is previously described, with reference to FIG. 11.

The TMP layers functionality 320 further comprises a procedure 322 for the establishment of encryption functionality for subsequent bearer packet data traffic transmissions. The respective TMP layers 259 and 271 support key exchange signaling transmissions between the respective CPRU 25 and WARP 32, for encryption and decryption of bearer packet data traffic transmissions between them. In an embodiment, the encryption establishment functionality 322 terminates on the WARP 32 that the CPRU 25 communicates with, and, therefore, requires no interworking within the WARP 32 for further upstream network management or control.

The TMP layers functionality 320 also comprises procedures 323 for the signaling transmissions required for the allocation of a Temporary Logical Link Identity (TLLI) to a CPRU of a respective terminal 21, for subsequent terminal communication addressing purposes. A TLLI is used for addressing a terminal 21 at the LLC layer 258 of the CPRU protocol stack 255 and the LLC layer 269 of the WARP protocol stack 265. The assigned TLLI is provided to the respective LLC layers 258 and 269 by the respective TMP layers 259 and 271. In an embodiment, the TLLI allocation signaling is between a CPRU 25 and a WARP 32, and the TLLI is allocated to the CPRU 25 by the WARP 32.

The TMP layers functionality 320 also comprises a procedure 324 for managing the signaling transmissions required for the network's dynamic allocation of IP (Internet Protocol) addresses to CPRUs 25 and computing devices 20 of the wireless access system 10.

In an embodiment, the over-the-air address resolution signaling for dynamic IP address allocation is based upon the Reverse Address Resolution Protocol (RARP). The network signaling for dynamic IP address allocation thereby establishes a bridge through a WARP 32 for the subsequent transport, or transmission, of packet data between a terminal 21 and an access router 35 of the wireless access system 10.

Referring again to FIG. 21, in an embodiment, a WARP 32 supplies the interworking functionality between a CPRU 25 of a terminal 21 and the Subscriber Management Platform (SMP) 75 of the respective Operations Support System (OSS) 70. In an embodiment, the protocol stack 265 for a WARP's interworking with the SMP 75 comprises a physical interface layer 272, a Medium Access Control (MAC) layer 273, a Logical Link Control (LLC) layer 274, an Internet Protocol (IP) layer 275, a User Datagram Protocol (UDP) layer 276 and a Remote Authentication Dial In User Service (RADIUS) client layer 277.

In an embodiment, the protocol stack 270 for an SMP 75 comprises a physical layer 278, a MAC layer 279, an LLC layer 280, an IP layer 281, a UDP layer 282 and a RADIUS server layer 283.

RADIUS is an Internet-based protocol used for carrying authentication and configuration information between a client entity and a shared authentication server on the network. In an embodiment, a WARP 32 acts as the proxy RADIUS client on behalf of all the CPRUs 25 located in the cell it services, and executes the RADIUS protocol with the SMP 75 of the respective OSS 70 of the wireless access system 10. The SMP 75, for its part, acts as the RADIUS server for the system 10.

The RADIUS client layer 277 of the WARP protocol stack 265 uses the RADIUS protocol to transmit and receive signaling information, or packets or messages, for the terminal authentication procedure for the terminals 21 of the system 10. The RADIUS server layer 283 of the SMP protocol stack 270 uses the RADIUS protocol to transmit and receive signaling information for the terminal-authentication procedure executed with the WARPs 32 of the system 10.

A WARP 32 interworks the over-the-air terminal authentication protocols between the respective WARP 32 and the CPRUs 25 of the terminals 21 in its cell, with the RADIUS client-server protocols executed between the WARP 32 and the SMP 75, acting as the RADIUS server of the system 10. In an embodiment, the system 10 uses the MD5 authentication algorithm. The two endpoints, or network nodes, in the wireless access system 10 that execute the MD5 authentication algorithm are a CPRU 25 and the SMP 75.

The RADIUS client layer 277 of the WARP protocol stack 265, using the RADIUS protocol, and the RADIUS server layer 283 of the SMP protocol stack 270, also using the RADIUS protocol, further support the SMP's transmission and reception of subscriber profile information to and from a WARP 32.

As noted, the WARP protocol stack 265 comprises a User Datagram Protocol (UDP) layer 276 and the SMP protocol stack 270 comprises a UDP layer 282. Generally, the UDP layers 276 and 282 each provide the primary mechanism for the respective network entities to transmit and receive unsecure datagrams, i.e., unsecure signaling messages, to and from their peer entities. In the packet data signaling plane, the UDP layers 276 and 282 support the transport of RADIUS protocol packet data signaling messages between the respective WARP 32 and SMP 75.

Further, the UDP layers 276 and 282 support the transport of Simple Network Management Protocol (SNMP) packet data signaling messages between the respective WARP 32 and SMP 75. As previously discussed, SNMP is used for network management, including network node management. Too, the UDP layers 276 and 282 support the transport of Multicast File Transport Protocol (MFTP) packet data signaling messages between the respective WARP 32 and SMP 75. As previously discussed, MFTP is used for transporting files required for network management, including network node management.

The Internet Protocol (IP) layer 275 of the WARP protocol stack 265 and the IP layer 281 of the SMP protocol stack 270 support the connectionless network transmission layer protocol for routing RADIUS protocol and SNMP signaling messages between the SMP 75 and the WARPs 32 of the wireless access system 10. In an embodiment, the respective IP layers 275 and 281 support IP version 4. In an alternative embodiment, the respective IP layers 275 and 281 support IP version 6.

In an embodiment, each WARP 32 is provisioned with its own external IP address, for among other functions, supporting the transmission and reception of RADIUS protocol and SNMP signaling messages to and from the SMP 75 for BSS (Base Station System) management functionality. In an embodiment, a WARP 32 is provisioned with an IP address by the OSS 70 of the network 10.

The Logical Link Control (LLC) layers 274 and 280 of the respective WARP protocol stack 265 and SMP protocol stack 270 provide a reliable, logical link for communications between the respective WARP 32 and SMP 75. LLC links are used to transfer packet data signaling traffic between a WARP 32 and the SMP 75 in the packet data signaling plane 205. Thus, an LLC link is first established between a WARP 32 and the SMP 75, for subsequent packet data signaling transmissions between them.

The LLC layers 274 and 280 support a variety of procedures, or functions, 300 for logical link control, as previously discussed with reference to FIG. 22.

The Medium Access Control (MAC) layers 273 and 279 of the WARP protocol stack 265 and SMP protocol stack 270 are responsible for resource management functions for the transmission interface between the respective WARP 32 and SMP 75. The MAC layers 273 and 279 each provide data and signal multiplexing on the transmission interface between the respective WARP 32 and SMP 75. In an embodiment, the control for the multiplexing function resides with the SMP 75.

The MAC layer 279 of the SMP protocol stack 270 further comprises functionality for the priority management and handling of subsequent bearer packet data traffic, i.e., packet data message transmissions between the WARPs 32 of the system 10 and the SMP 75.

The physical layers 272 and 278 of the WARP protocol stack 265 and the SMP protocol stack 270 support the functionality for managing the physical transmission interface between the respective WARP 32 and SMP 75. In an embodiment, the physical transmission interface between a WARP 32 and the SMP 75 is a wireline interface. In an embodiment, the physical transmission interface between a WARP 32 and the SMP 75 supports fast ethernet.

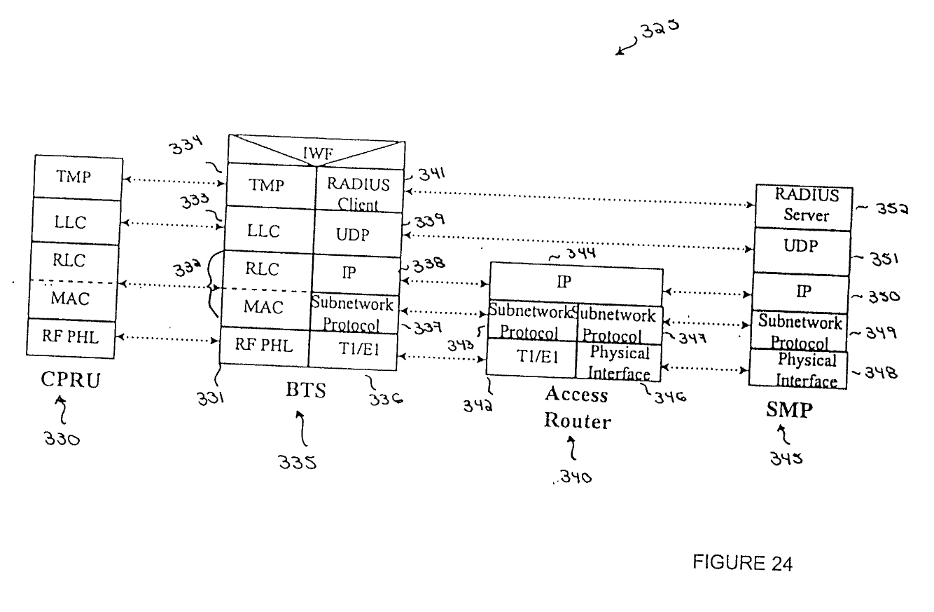

As previously discussed, in an alternative embodiment, a wireless access system 100, as shown in FIG. 5, has a base station 101, and does not use Wireless Adjunct inteRnet Platforms (WARPs). In a system 100, a base station 101 combines the functionality of a base station 30 and a WARP 32 of a system 10. An embodiment of a packet data signaling plane architecture 325, as shown in FIG. 24, for use in a system 100, comprises a CPRU protocol stack 330, a base station protocol stack 335, an access router protocol stack 340 and a Subscriber Management Platform (SMP) protocol stack 345. The CPRU protocol stack 330 of FIG. 24, for use in a system 100, is equivalent to the CPRU protocol stack 255 of FIG. 21, for use in a system 10.

On the subscriber side, the base station protocol stack 335 comprises a radio physical layer (RF PHL) 331, a Radio Link Control (RLC)/Medium Access Control (MAC) layer 332, a Logical Link Control (LLC) layer 333 and a Terminal Management Protocol (TMP) layer 334.

The radio physical layer 331 of the base station protocol stack 335 is equivalent to the radio physical layer 261 of the base station protocol stack 260 of FIG. 21. The RLC/MAC layer 332, the LLC layer 333 and the TMP layer 334 of the base station protocol stack 335 are equivalent to the RLC/MAC layer 268, the LLC layer 269 and the TMP layer 271 of the WARP protocol stack 265 of FIG. 21, except that their respective functionalities are now handled in a base station 101 rather than a WARP 32.

On the network side, the base station protocol stack 335 comprises a T1/E1 layer 336, a subnetwork protocol layer 337, an Internet Protocol (IP) layer 338, a User Datagram Protocol (UDP) layer 339 and a Remote Authentication Dial In User Service (RADIUS) client layer 341.

The Radius client layer 341 of the base station protocol stack 335 is equivalent to the Radius client layer 277 of the WARP protocol stack 265 of FIG. 21, except the RADIUS client functionality is handled in the system 100 by a base station 101 rather than a WARP 32. Likewise, the UDP layer 339 of the base station protocol stack 335 is equivalent to the UDP layer 276 of the WARP protocol stack 265, except the UDP functionality is now performed by a base station 101.

The IP layer 338 of the base station protocol stack 335 is equivalent to the IP layer 275 of the WARP protocol stack 265 of FIG. 21, except the IP functionality is managed by a base station 101 in the system 100, rather than a WARP 32. Further, in the system 100, the base station 101 communicates at the Internet Protocol (IP) level with an intermediary access router 35, which, in turn, forwards the IP signaling messages to the SMP 75.

In an embodiment, the subnetwork protocol layer 337 of the base station protocol stack 335 supports fast ethernet transmissions. In the system 100, the base stations 101 communicate at the subnetwork protocol layer with the SMP 75 via an intermediary access router 35.

In an embodiment, the T1/E1 protocol layer 336 of the base station protocol stack 335 supports the protocols and procedures for managing a physical T1/E1 communication interface between the respective base station 101 and an access router 37. The T1/E1 communication interface is a standard wireline interface. In the packet data signaling plane 205 specifically, the T1/E1 protocol layer 336 of the base station protocol stack 335 manages the physical transmission of signaling information, or messages, between the respective base station 101 and the SMP 75, via an access router 35.

On the subscriber side, the access router protocol stack 340 comprises a T1/E1 protocol layer 342 and a subnetwork protocol layer 343 for communicating with the base stations 101 of the system 100 in the packet data signaling plane 205.

On the network side, the access router protocol stack 340 comprises a physical interface protocol layer 346 and a subnetwork protocol layer 347 for communicating with the SMP 75 of the system 100. In an embodiment, the physical interface protocol layer 346 supports a standard wireline protocol interface between the respective access router 35 and the SMP 75.

The access router protocol stack 340 further comprises an Internet Protocol (IP) layer 344. In the packet data signaling plane 205 of the system 100, an access router 35 passes IP signaling messages between respective base stations 101 of the system 100 and the SMP 75.

The SMP protocol stack 345 comprises a physical interface protocol layer 348, a subnetwork protocol layer 349, an IP layer 350, a UDP layer 351 and a RADIUS server layer 352. The Radius server layer 352 and the UDP layer 351 of the SMP protocol stack 345 are equivalent to the respective Radius server layer 283 and UDP layer 282 of the SMP protocol stack 270 of FIG. 21. The IP layer 350 of the SMP protocol stack 345 is equivalent to the IP layer 281 of the SMP protocol stack 270, except that the SMP 75 of the system 100 transports Internet Protocol (IP) packet data signaling messages to the base stations 101 of the system 100 via respective access routers 35.

The subnetwork protocol layer 349 and the physical interface protocol layer 348 of the SMP protocol stack 345 support the SMP's transmissions in the packet data signaling plane 205 with an access router 35 in the system 100. In an embodiment, the physical interface protocol layer 348 supports a standard wireline protocol interface between the SMP 75 and an access router 35.

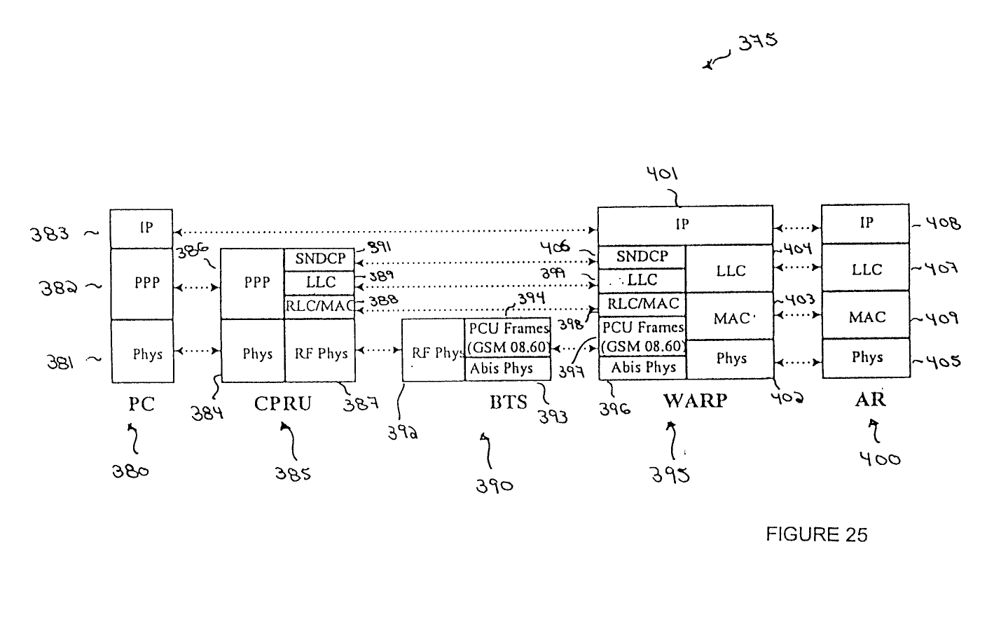

An embodiment of a packet data bearer plane architecture 375, shown in FIG. 25, for use in a system 10, comprises a personal computer (PC) protocol stack 380, a CPRU protocol stack 385, a base station, or base transceiver station (BTS), protocol stack 390, a WARP protocol stack 395, and an access router protocol stack 400.

In the packet data bearer plane architecture 375, the PC functions as an IP endpoint, with the respective CPRU 25 performing as a bridge and a WARP 32 and access router 35 functioning as IP routers. The CPRU protocol stack 385, base station protocol stack 390 and WARP protocol stack 395 support reliable packet data transfers between the respective CPRUs 25 and WARPs 32 of the system 10. The packet data bearer plane architecture 375 supports interfacing multiple PCs to a CPRU 25 in a home-LAN (Local Area Network) arrangement.

In an embodiment, the PC protocol stack 380 comprises a physical interface layer 381, a point-to-point (PPP) protocol layer 382, and an Internet Protocol (IP) layer 383. In an embodiment, on the subscriber, or end user, side, the CPRU protocol stack 385 comprises a physical interface layer 384 and a PPP protocol layer 386.

The physical interface protocol layers 381 and 384 each comprise functionality for managing the physical wireline interface between the respective PC and CPRU 25, which together comprise a network subscriber terminal 21. In an embodiment, the physical transmission interface between a PC and a CPRU 25 is an RS-233 interface.

The point-to-point (PPP) protocol layers 382 and 386 each comprise functionality for transporting Internet Protocol (IP) datagram across the communications interface between the respective PC and CPRU 25. IP frames of data messages are encapsulated at the PPP protocol layers 382 and 386 to form PPP datagrams.

The IP layer 383 of the PC protocol stack 380 in the packet data bearer plane 225 supports the network IP for transmitting packet data messages between the terminal 21 the respective PC is a part of and an access router 35 in the system 10. The respective access router 35, for its part, transmits IP packet bearer messages from external packet data networks, including, but not limited to, the Internet 65, to destination terminals 21. The access router 35 also transmits IP packet bearer messages from terminals 21 to the respective destination external packet data networks.

On the network side, a CPRU protocol stack 385 for the packet data bearer plane architecture 375 comprises a Subnetwork Dependent Convergence Protocol (SNDCP) layer 391, a Logical Link Control (LLC) layer 389, a Radio Link Control (RLC)/Medium Access Control (MAC) layer 388 and a radio physical layer 387.

On the subscriber, or end user, side, a base station protocol stack 390 comprises a radio physical layer 392. On the network side, a base station protocol stack 390 comprises a Packet Control Unit (PCU) Frames layer 394 and an Abis physical layer 393.

On the subscriber side, a WARP protocol stack 395 comprises an SNDCP layer 406, an LLC layer 399, an RLC/MAC layer 398, a PCU Frames layer 397 and an Abis Physical layer 396.

The radio physical layer 387 of the CPRU protocol stack 385 and the radio physical layer 392 of the base station protocol stack 390 are equivalent to the respective radio physical layer 256 of the CPRU protocol stack 255 and the radio physical layer 261 of the base station protocol stack 260 of FIG. 21, except that the radio physical layers 387 and 392 manage the transmission of packet data rather than packet data signaling messages.

The PCU Frames layers 394 and 397 of the respective base station protocol stack 390 and WARP protocol stack 395 are equivalent to the PCU Frames layers 263 and 267 of the respective base station protocol stack 260 and WARP protocol stack 265 of FIG. 21, except that the PCU Frames layers 394 and 397 support the transmission of packet data messages rather than packet data signaling messages. Too, the Abis physical layers 393 and 396 of the respective base station protocol stack 390 and WARP protocol stack 395 are equivalent to the Abis physical layers 262 and 266 of the respective base station protocol stack 260 and WARP protocol stack 265, except that the Abis physical layers 393 and 396 support transmission of packet data rather than packet data signaling messages.

The RLC/MAC layers 388 and 398 of the respective CPRU protocol stack 385 and WARP protocol stack 395 are equivalent to the RLC/MAC layers 257 and 268 of the CPRU protocol stack 255 and WARP protocol stack 265 of FIG. 21, except that the RLC/MAC layers 388 and 398 manage the transmission of packet data rather than packet data signaling messages. Too, the LLC layers 389 and 399 of the respective CPRU protocol stack 385 and WARP protocol stack 395 are equivalent to the LLC layers 258 and 269 of the CPRU protocol stack 255 and WARP protocol stack 265, except that the LLC layers 389 and 399 support the transmission of packet data rather than packet data signaling messages.

The Subnetwork Dependent Convergence Protocol (SNDCP) layer 391 of the CPRU protocol stack 385 and the SNDCP layer 406 of the WARP protocol stack 395 each comprise part of the wireless middleware functionality that plugs, or otherwise connects or overlaps, the system functionality onto the system's physical radio interfaces. SNDCP is executed between a CPRU 25 and a WARP 32.

The SNDCP layers 391 and 406 each support the mapping of network level, i.e., Internet Protocol (IP), data packets and characteristics onto the underlying system protocols. The respective SNDCP layers 391 and 406 support the adaptation of IP data packets to over-the-air Logical Link Control (LLC) frames for transmission between a CPRU 25 and a WARP 32, via a base station 30. Further, the SNDCP layer 406 of the WARP protocol stack 395 supports the adaptation of LLC frames to respective IP data packets, for subsequent transmission to Internet gateways 60, via an access router 35.

The SNDCP layers 391 and 406 support the compression and decompression of message headers, including, but not limited to, Internet Protocol (IP) message headers, of packet data sent and received on the over-the-air interface between the respective CPRU 25 and WARP 395, via a base station 30.

The SNDCP layers 391 and 406 further provide a mechanism for determining the length of a data message and its individual data packets, for subsequent use in the compression/decompression message header algorithms. Too, the SNDCP layers 391 and 406 support the functionality for providing the packet type, including, but not limited to, normal IP packet, full header packet and context state packet, to the requisite compression and decompression algorithms.

The SNDCP layers 391 and 406 also support the Quality of Service (QoS) functionality for packet data transmissions. In an embodiment, the QoS profile for bearer data traffic, i.e., packet data message transmissions, is a non real-time profile.

The IP layer 401 of the WARP protocol stack 395 supports IP packet data bearer traffic transmissions between a PC of a terminal 21 and an access router 35. In an embodiment, the WARP 32 that the terminal 21 communicates with acts as a bridge for IP packet data bearer messages transmitted between the respective terminal 21 and an external packet data network, via an access router 35.

On the network side, the WARP protocol stack 395 comprises a Logical Link Connect (LLC) layer 404, a Medium Access Control (MAC) layer 403 and a physical layer 402. The access router protocol stack 400 for the packet data bearer plane architecture 375 comprises an IP layer 408, an LLC layer 407, a MAC layer 409 and a physical layer 405.

The IP layer 408 of the access router protocol stack 400 supports the connectionless network transmission layer protocol for routing IP packet data messages between the respective access router 35 and a PC of a terminal 21. In an embodiment, the IP layer 383 of the PC protocol stack 380, the IP layer 401 of the WARP protocol stack 395, and the IP layer 408 of the access router protocol stack 400 support IP version 4. In an alternative embodiment, the respective IP layers 383, 401 and 408 support IP version 6.

A WARP 32 of the system 10 performs IP level routing functionality that relays IP packet data messages between a PC of a terminal 21 and the WARP 32 and between the WARP 32 and an access router 35. On a CPRU 25/WARP 32 interface, each CPRU 25 is instantiated at the LLC layer 389 via a Temporary Logical Link Identity (TLLI) assigned to the CPRU 25 by the respective WARP 32. Each PC connect to a CPRU 25 is instantiated at the network layer, i.e., IP layer 383, via an Internet Protocol (IP) address assigned to the PC. It is the function of the WARPs 32 of the system 10 to maintain the mapping between TLLIs assigned to a CPRU 25 and IP addresses assigned to the one or more PCs attached to a respective CPRU 25. This mapping, or bridging, is dynamically established at the time an IP address is allocated to a PC of a terminal 21.

The logical link control (LLC) layers 404 and 407 of the respective WARP protocol stack 395 and access router protocol stack 400 provide a reliable, logical link for packet data message transmissions between the respective WARP 32 and access router 35. LLC links are used to transfer packet data messages between a WARP 32 and an access router 35 in the packet data bearer plane 225. Thus, an LLC link is first established between a WARP 32 and an access router 35, for subsequent packet data message transmissions between them.

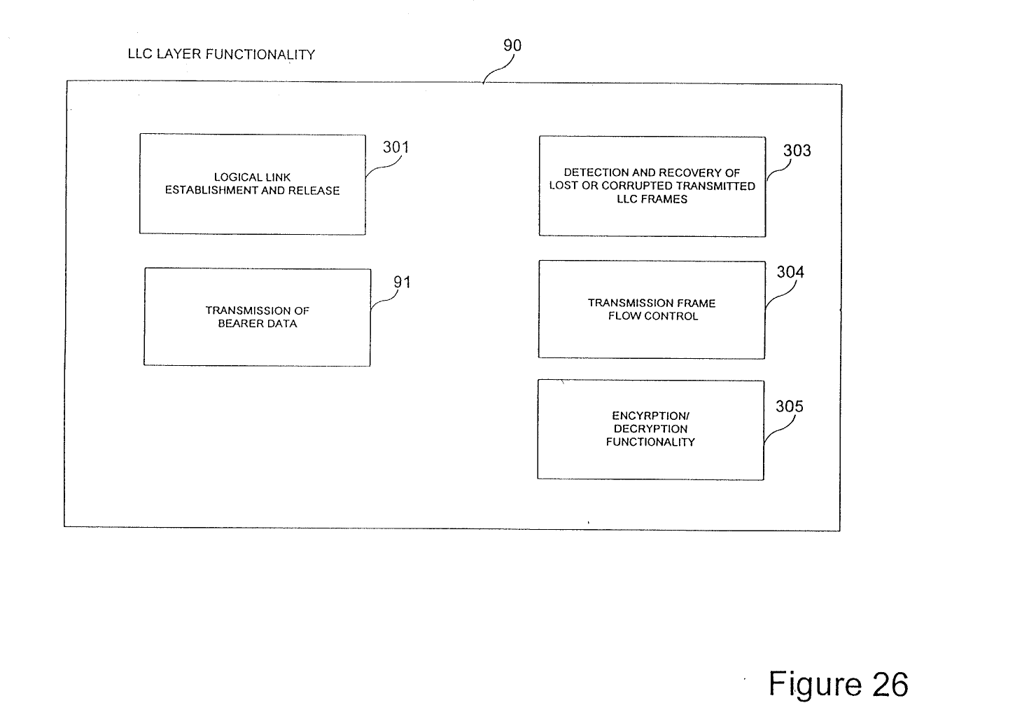

The LLC layers 404 and 407 of the respective WARP protocol stack 395 and access router protocol stack 400 support a variety of procedures, or functions, 90 for logical link control, as shown in FIG. 26. The LLC layers functionality 90 comprises a procedure 301 for the establishment, and subsequent release, of LLC links between a CPRU 25 and an access router 35, via a WARP 32. The LLC layers functionality 90 also comprises a procedure 303 for detecting and recovering from lost or corrupted transmitted LLC frames of packet data bearer messages.

The LLC layers functionality 90 comprises a procedure 304 for controlling the transmission flow of LLC frames of packet data bearer messages between a CPRU 25 and an access router 35, via a WARP 32. The LLC layers functionality 90 also comprises a procedure 305 for supporting encryption and decryption of LLC frames of packet data bearer messages transmitted between a CPRU 25 and an access router 35, via a WARP 32.

The LLC layers functionality 90 also comprises a procedure 91 for the transfer, or transmission, of LLC frames of packet data bearer messages between a CPRU 25 and an access router 35, via a WARP 32. In an embodiment, the procedure 91 for the transmission of LLC frames of packet data bearer traffic supports unacknowledged point-to-point transmissions between a CPRU 25 and an access router 35. In an embodiment, the procedure 91 for the transmission of LLC frames of packet data bearer traffic also supports acknowledged, reliable, point-to-point transmissions between a CPRU 25 and an access router 35.

The Medium Access Control (MAC) layers 403 and 409 of the WARP protocol stack 395 and access router protocol stack 400 are responsible for resource management functions for the transmission interface between the respective WARP 32 and access router 35. The MAC layers 403 and 409 support data multiplexing on the transmission interface between the respective WARP 32 and access router 35; in an embodiment, the control for the multiplexing function resides with the access router 35.

For WARP-originated transmissions, the MAC layer 403 of the WARP protocol stack 395 provides contention resolution functionality between transmission access attempts. For WARP-originated transmissions, the MAC layer 409 of the access router protocol stack 400 provides contention resolution functionality between two or more WARPs 32 attempting to transmit to the respective access router 35 at the same time.

For network-originated transmissions, the MAC layer 409 of the access router protocol stack 400 is responsible for scheduling the various WARP transmission accesses. Thus, the MAC layer 409 coordinates, or schedules, WARP access to the respective access router 35.

The MAC layer 409 of the access router protocol stack 400 also comprises functionality for the priority management and handling of packet data bearer traffic between the WARPs 32 of the system 10 and the respective access router 35.

The physical layers 402 and 405 of the respective WARP protocol stack 395 and access router protocol stack 400 support the functionality for managing the physical transmission interface between the respective WARP 32 and access router 35. In an embodiment, the physical transmission interface between a WARP 32 and an access router 35 is a wireline interface.

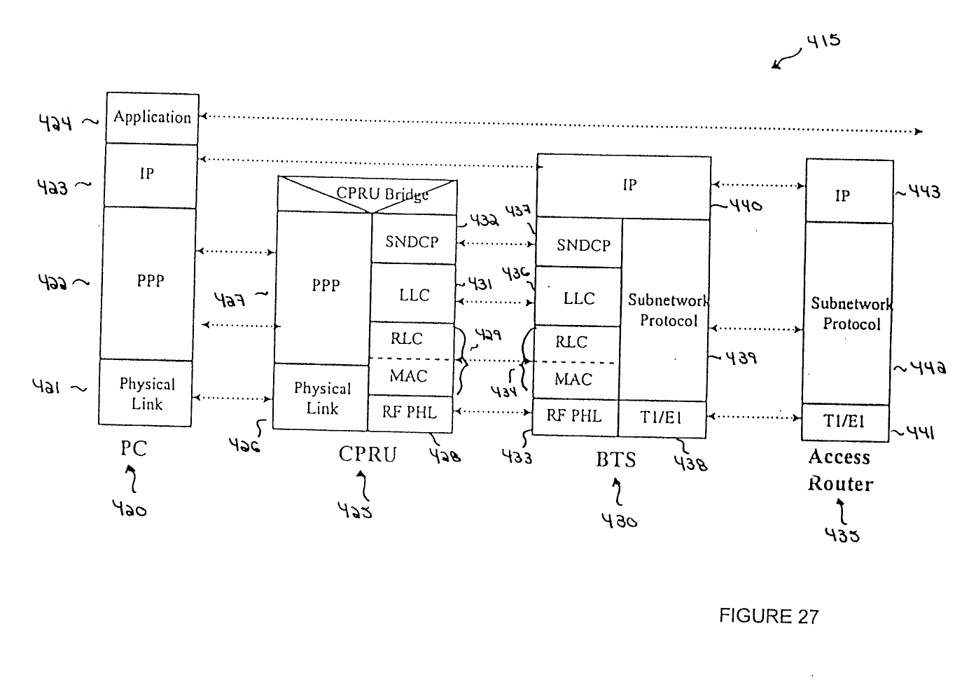

As previously discussed, in an alternative embodiment, a wireless access system 100 has a base station 101, and does not use Wireless Adjunct inteRnet Platforms (WARPs) 32. An embodiment of a packet data bearer plane architecture 415, as shown in FIG. 27, for use in a system 100, comprises a PC protocol stack 420, a CPRU protocol stack 425, a base station protocol stack 430 and an access router protocol stack 435.

The PC protocol stack 420 of FIG. 27, for use in a system 100, is equivalent to the PC protocol stack 380 of FIG. 25, for use in a system 10. The PC protocol stack 420 further depicts an application layer 424, which also exists in the PC protocol stack 380, though is not shown. The application layer 424 manages the overall application functionality for transmitting packet data messages between the respective PC and an external packet data network.

The CPRU protocol stack 425, for use in a system 100, is equivalent to the CPRU protocol stack 385 for use in a system 10. In the packet data bearer plane 225, a CPRU 25 performs as a bridge for transporting network level, i.e., IP, packet data messages between a PC and a WARP 32 of a system 10, or between a PC and a base station 101 of a system 100.

On the end user side, the base station protocol stack 430 comprises a SubNetwork Dependent Convergence Protocol (SNDCP) layer 437, a Logical Link Control (LLC) layer 436, a Radio Link Control/Medium Access Control (RLC/MAC) layer 434 and a radio physical layer 433. On the network side, the base station protocol stack 430 comprises a subnetwork protocol layer 439 and a T1/E1 layer 438. The base station protocol stack further comprises an Internet Protocol (IP) layer 440.

The access router protocol stack 435 for an access router 35 in a system 100 comprises an IP layer 443, a subnetwork protocol layer 442 and a T1/E1 layer 441.

In the packet data bearer plane 225 for system 100, a base station 101 passes IP messages between the PCs and access routers 35. The IP layer 440 of the base station protocol stack 430 supports IP packet data bearer traffic transmissions between a PC of a terminal 21 and an access router 35. In an embodiment, the base station 101 that a PC communicates with acts as a bridge for IP packet data bearer messages transmitted between the respective PC and an external packet data network, via an access router 35.

The IP layer 443 of the access router protocol stack 435 supports the connectionless network transmission layer protocol for routing IP packet data messages between the respective access router 35 and a PC of a terminal 21.

In an embodiment, the IP layer 423 of the PC protocol stack 420, the IP layer 440 of the base station protocol stack 430, and the IP layer 443 of the access router protocol stack 435 support IP version 4. In an alternative embodiment, the respective IP layers 423, 440 and 443 support IP version 6.

The radio physical layer 433 of the base station protocol stack 430 is equivalent to the radio physical layer 392 of the base station protocol stack 390 of FIG. 25; the radio physical layer 433 supports transmission on the over-the-air interface 27 between the respective base station 101 and a CPRU 25. The RLC/MAC layer 434, the LLC layer 436 and the SNDCP layer 437 of the base station protocol stack 430 are equivalent to the respective RLC/MAC layer 398, LLC layer 399 and SNDCP layer 406 of the WARP protocol stack 395 of FIG. 25, except that the RLC/MAC functionality, LLC protocol functionality and SNDCP functionality between a CPRU 25 and the system 100 is now handled in a base station 101, rather than a WARP 32.

The subnetwork protocol layer 439 of the base station protocol stack 430 and the subnetwork protocol layer 442 of the access router protocol stack 435 support the functionality for the subnetwork transmission protocols for packet data message transmissions between the respective base station 101 and access router 35. In an embodiment, the subnetwork protocol layers 439 and 442 support fast ethernet transmissions.

The T1/E1 layers 438 and 441 of the respective base station protocol stack 430 and access router protocol stack 435 each comprise the protocols and procedures for managing a physical T1/E1 communication interface between the respective base station 101 and access router 35. The T1/E1 communication-interface is a standard wireline interface. In the packet data bearer plane 225, the T1/E1 layers 438 and 441 manage the physical transmission interface for transmitting packet data messages between the respective base station 101 and access router 35.

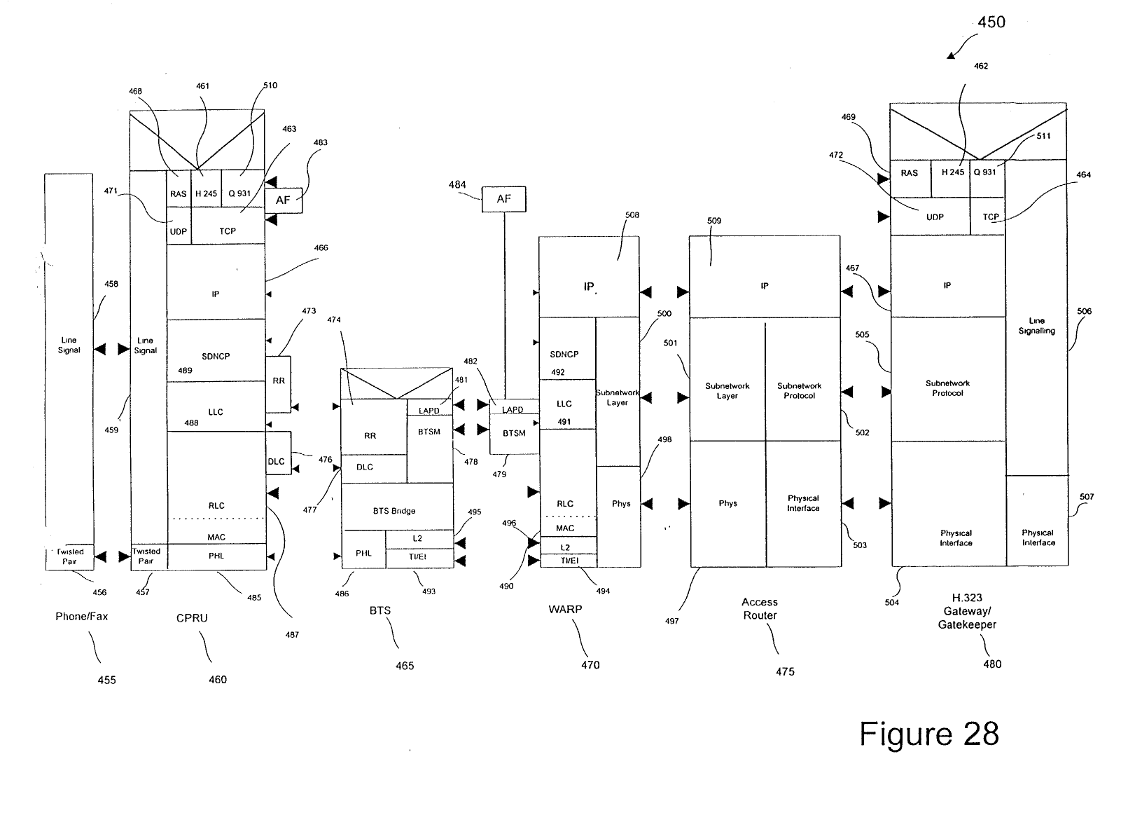

An embodiment of a voice/fax signaling plane architecture 450, as shown in FIG. 28, for use in a system 10, comprises a phone/fax protocol stack 455, a CPRU protocol stack 460, a base station protocol stack 465, a WARP protocol stack 470, an access router protocol stack 475 and a gateway/gatekeeper protocol stack 480.

The phone/fax protocol stack 455 comprises a line signal layer 458 and a physical layer 456. On the end user side, the CPRU protocol stack 460 comprises a line signal layer 459 and a physical layer 457.

In an embodiment, the physical interface between a telephone 15 or facsimile device 12 and a CPRU 25 is a twisted pair wireline interface. In an embodiment, the physical interface between a telephone 15 or facsimile device 12 and a CPRU 25 is an RJ-11 interface. The physical layer 456 of the phone/fax protocol stack 455 and the physical layer 457 of the CPRU protocol stack 460 manage voice and/or fax signal message transmissions on the physical interface between a respective telephone 15 or facsimile device 12 and a CPRU 25.

The line signal layers 458 and 459 of the respective phone/fax protocol stack 455 and CPRU protocol stack 460 support the necessary protocols for managing voice and/or fax signaling messages between the respective telephone 15 or facsimile device 12 and CPRU 25.

One of the key principles of the voice/fax signaling plane architecture for the system 10 or 100 is that voice and fax signaling is transferred end-to-end using underlying packet data transport mechanisms. The Internet Protocol (IP) is used to transport voice and fax signaling messages between a CPRU 25 of an H.323 terminal 17 or fax terminal 14 and a gatekeeper 55 and/or gateways 45 or 57 leading to a switched circuit network 50. The endpoints for IP message transmissions in the voice/fax signaling plane architecture 450 are a CPRU 25 and a gatekeeper 55 or gateway 45 or 57. The access router 35 and WARP 32 in the communications chain for voice and fax signaling messages pass the respective IP based signaling messages along. Thus, the CPRU protocol stack 460, the WARP protocol stack 470, the access router protocol stack 475 and the gateway/gatekeeper protocol stack 480 all have respective IP layers 466, 508, 509 and 467, for managing IP voice/fax signaling message transmissions.

In an embodiment, voice/fax signaling for call or fax transmission control and features management is based on the H.323 standard, i.e., ITU-T Recommendation H.323: Visual telephone systems and equipment for local area networks which provide a non-guaranteed quality of service. Voice and fax signaling messages for call or fax transmission control and features management is transported between a CPRU 25 and a WARP 32 in system 10 using the underlying core packet data bearer plane architecture 375, as discussed with regard to FIG. 25.

The voice/fax signaling plane architecture 450 conforms to the H.323 standard for upper transmission control protocol layers and uses the Transmission Control Protocol (TCP)/Internet Protocol (IP) and User Datagram Protocol (UDP)/Internet Protocol (IP) as the underlying network and transport protocols for voice and fax signaling messages.

In an embodiment, the voice/fax signaling components of the voice/fax signaling plane architecture 450 comprise an H.242 protocol layer, a Q.931 protocol layer and a Registration Admissions and Status (RAS) protocol layer. Each of these voice/fax signaling component layers are implemented in the CPRU protocol stack 460 and the gateway/gatekeeper protocol stack 480.

The H.245 protocol is a standard control protocol for multimedia communications. The Q.931 protocol is the Integrated Services Digital Network (ISDN) user-network interface layer 3 protocol for basic call and fax transmission control. The Integrated Services Digital Network (ISDN) is a vehicle for provisioning a single service that carries all forms of digitally encoded traffic on a common platform; it provides a capability for transmitting speech, data and video traffic on a single interface, and, further, provides a range of transmission rates.

The Registration and Admissions (RAS) protocol is used to support a communications channel between a CPRU 25 and an H.323 gatekeeper 55 for the discovery procedure 125, registration procedures 126 and 127, and the location management procedure 136, as discussed with regards to FIG. 3. The RAS protocol also supports subscriber authentication in the voice/fax signaling plane 210 of the wireless access network 10. In an embodiment, RAS protocol signaling is between the CPRU 25 of an H.323 terminal 17 or fax terminal 14 and an H.323 gatekeeper 55. RAS signaling messages can be transported over an unreliable channel, and, thus, the User Datagram Protocol (UDP)/Internet Protocol (IP) protocols are used for RAS signaling transmissions.

The RAS protocol layers 468 and 469 of the respective CPRU protocol stack 460 and gateway/gatekeeper protocol stack 480 support RAS protocol processing. The UDP layers 471 and 472 and the IP layers 466 and 467 of the respective CPRU protocol stack 460 and gateway/gatekeeper protocol stack 480 manage, or otherwise support, the UDP/IP connections between a CPRU 25 of an H.323 terminal 17 or fax terminal 14 and an H.323 gatekeeper 55, for RAS protocol processing.

The H.245 protocol layers 461 and 462 for the respective CPRU protocol stack 460 and gateway/gatekeeper protocol stack 480 manage the allocation and de-allocation of voice Internet Protocol (VolP) logical channels on the CPRU 25/network 10 interface. The H.245 protocol control messages govern operations including, but not limited to, capabilities exchange signaling, opening, or establishment, of a VolP logical channel, closing, or de-allocation, of a VolP logical channel, mode preference request signaling, flow control signaling, and general command and indication signaling.

In an embodiment, the H.245 protocol signaling between two endpoints, e.g., between two H.323 terminals 17 or two fax terminals 14, or between an H.323 terminal 17 or fax terminal 14 and a switched circuit network 50, is routed through an H.323 gatekeeper 55, with the respective H.245 signaling messages carried via reliable TCP/IP frames.

The TCP layers 463 and 464 and the IP layers 466 and 467 of the respective CPRU protocol stack 460 and gateway/gatekeeper protocol stack 480 manage, or otherwise support, the TCP/IP connections between a CPRU 25 of an H.323 terminal 17 or fax terminal 14 and an H.323 gatekeeper 55, for H.245 protocol processing.

In an embodiment, voice and fax transmission control signaling is further defined within the H.225.0 protocol, which is part of the H.323 protocol suite. The H.225.0 protocol generally supports media stream packetization and synchronization for visual telephone systems on non-guaranteed quality of service local area networks (LANs). The H.225.0 protocol incorporates the DSS-1 recommendation Q.931 protocol and defines the set of mandatory Q.931 voice/fax signaling control messages. Call and fax transmission control signaling between two endpoints, i.e., between two H.323 terminals 17 or two fax terminals 14 or between an H.323 terminal 17 or fax terminal 14 and a switched circuit network 50, is routed via an H.323 gatekeeper 55, with the respective Q.931 signaling messages carried over reliable TCP/IP connections.

The Q.931 protocol layers 510 and 511 of the respective CPRU protocol stack 460 and gateway/gatekeeper protocol stack 480 support Q.931 protocol processing. The TCP layers 463 and 464 and the IP layers 466 and 467 of the respective CPRU protocol stack 460 and gateway/gatekeeper protocol stack 480 manage, or otherwise support, the TCP/IP connections between a CPRU 25 of an H.323 terminal 17 or fax terminal 14 and an H.323 gatekeeper 55, for Q.931 protocol processing.

In an embodiment, a base station 30 communicates with a CPRU 25 via a GSM/GPRS (Global System for Mobile communication/General Packet Radio Service) radio, or wireless, interface 27. Thus, voice bearer messages are transmitted over GSM-managed circuits, and the voice/fax signaling plane architecture 450 must support mechanisms for the establishment, maintenance and release of the GSM-managed circuits.

In an embodiment, the establishment, maintenance and release of GSM-managed circuits on the over-the-air interface 27 between a CPRU 25 and a base station 30 is accomplished via GSM RR and DLC protocol layers. The establishment, maintenance and release of GSM-managed circuits is further accomplished via BTSM and LAPD (Link Access Procedures for the D-channel) protocol layers supported by the base stations 30 and WARPs 32. Thus, the CPRU protocol stack 460 and base station protocol stack 465 support respective RR protocol layers 473 and 474 and respective DLC protocol layers 476 and 477. The base station protocol stack 465 and WARP protocol stack 470 support respective LAPD protocol layers 481 and 482 and respective BTSM protocol layers 478 and 479.

In an embodiment, an adaptation function is used by both CPRUs 25 and WARPs 32, for coordinating, or otherwise interworking, between H.323 voice/fax signaling and the GSM-managed circuit signaling procedures, in order that respective circuit establishment and release procedures are executed at the appropriate times within the overall call or fax transmission establishment and de-establishment control sequences. The CPRU protocol stack 460 and WARP protocol stack 470 each comprise a respective Adaptation Function (AF) layer 483 and 484, for processing the adaptation function.

As previously discussed, the voice/fax signaling plane architecture 450 is overlaid on an underlying core packet data bearer plane architecture. Thus, the radio, i.e., over-the-air, interface between a respective CPRU 25 and base station 30 is managed by radio physical layers 485 and 486 in the respective CPRU protocol stack 460 and base station protocol stack 465. The radio physical layers 485 and 486 manage the physical transmission interface between a CPRU 25 and base station 30 for the transmission of voice and/or fax signaling messages.

Further, using the underlying core packet data bearer plane architecture, the voice/fax signaling plan architecture employs SubNetwork Dependent Convergence Protocol (SNDCP) layers, Logical Link Control (LLC) layers and Radio Link Control/Medium Access Control (RLC/MAC) layers for voice/fax signaling within the system 10. Thus, the SNDCP layers 489 and 492 of the respective CPRU protocol stack 460 and WARP protocol stack 470 are equivalent to the respective SNDCP layers 391 and 406 of FIG. 25, other than SNDCP layers 489 and 492 manage voice/fax signaling messages rather than packet data bearer messages. Too, the LLC layers 488 and 491 of the respective CPRU protocol stack 460 and WARP protocol stack 470 are equivalent to the respective LLC layers 389 and 399 of FIG. 25, other than LLC layers 488 and 491 manage voice/fax signaling messages rather than packet data bearer messages. Also, the RLC/MAC layers 487 and 490 are equivalent to the respective RLC/MAC layers 388 and 398 of FIG. 25, other than RLC/MAC layers 487 and 490 manage voice/fax signaling messages rather than packet data bearer messages.

In an embodiment, for managing the transmission of voice and fax signaling messages between a base station 30 and a WARP 32, the wireless access system 10 uses standard T1/E1 and L2 wireline transmission protocols. Thus, the base station protocol stack 465 comprises an L2 protocol layer 495 and a T1/E1 layer 493. Likewise, the WARP protocol stack 470 comprises an L2 protocol layer 496 and a T1/E1 layer 494.

The physical layers 498 and 497 of the respective WARP protocol stack 470 and access router protocol stack 475 support the functionality for managing voice and fax signaling transmissions on the physical transmission interface between the respective WARP 32 and access router 35. In an embodiment, the physical transmission interface between a WARP 32 and an access router 35 is a wireline interface.

The subnetwork protocol layers 500 and 501 of the respective WARP protocol stack 470 and access router protocol stack 475 support subnetwork transmission protocols for transmitting IP-based voice and fax signaling messages between the respective WARP 32 and access router 35. In an embodiment, the subnetwork layers 500 and 501 are frame relay layers, which support a frame relay link layer transport protocol between the respective WARP 32 and access router 35. Generally, frame relay is used for the transport, i.e., transmission, of both signaling information and bearer traffic messages. In the voice/fax signaling plane 210, the subnetwork protocol layers 500 and 501 manage frame relay transport of IP-based voice and fax signaling messages between the respective WARP 32 and access router 35.

In an embodiment, for voice and fax signaling message transmissions, permanent virtual circuits (PVCs) are used between a WARP 32 and an access router 35, and the frame relay protocols are run under the overlying Internet Protocol (IP).

The physical interface layers 503 and 504 of the respective access router protocol stack 475 and gateway/gatekeeper protocol stack 480 support the functionality for managing the physical transmission interface between the respective access router 35 and H.323 gatekeepers 55 and gateways 45 or 57. In an embodiment, the physical transmission interface between access routers 35 and H.323 gatekeepers 55, H.323 gateways 45 and fax gateways 57 is a wireline interface. In an embodiment, the physical transmission interface between an access router 35 and an H.323 gatekeeper 55 and gateways 45 and 57 is a standard 10BaseT wireline communications interface.

The subnetwork protocol layers 502 and 505 of the respective access router protocol stack 475 and gateway/gatekeeper protocol stack 480 support subnetwork transmission protocols for transmitting IP-based voice and fax signaling messages between the respective access router 35 and an H.323 gatekeeper 55 and gateways 45 and 57. In an embodiment, the subnetwork protocol layers 502 and 505 are ethernet layers, which support an ethernet transport protocol between the respective access router 35 and an H.323 gatekeeper 55 and gateways 45 and 57.

On the switched circuit network side, the gateway/gatekeeper protocol stack 480 for the voice/fax signaling plane architecture 450 comprises a line signal layer 506 and a physical interface layer 507. In an embodiment, the physical interface between an H.323 gatekeeper 55 and gateways 45 and 57 and a switched circuit network 50 is a wireline interface. The physical interface layer 507 of the gateway/gatekeeper protocol stack 480 manages voice and fax signal message transmissions on the physical interface between the respective H.323 gatekeepers 55 and gateways 45 and 57 and a switched circuit network 50. The line signal layer 506 of the gateway/gatekeeper protocol stack 480 supports the necessary protocols for managing voice and fax signaling messages between the respective H.323 gatekeepers 55 and gateways 45 and 57 and a switched circuit network 50.

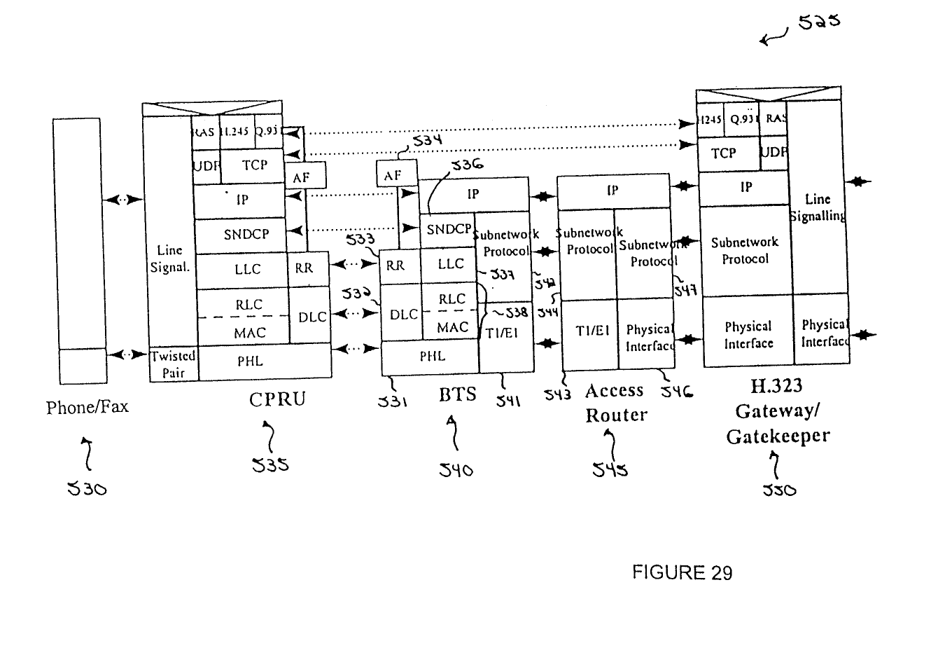

As previously discussed, in an alternative embodiment, a wireless access system 100, as shown in FIG. 5, has a base station 101, and does not use Wireless Adjunct inteRnet Platforms (WARPs) 32. An embodiment of a voice/fax signaling plane architecture 525, as shown in FIG. 29, for use in a system 100, comprises a phone/fax protocol stack 530, a CPRU protocol stack 535, a base station protocol stack 540, an access router protocol stack 545 and a gateway/gatekeeper protocol stack 550.

The phone/fax protocol stack 530 of FIG. 29, for use in a system 100, is equivalent to the phone/fax protocol stack 455 of FIG. 28, for use in a system 10. The CPRU protocol stack 535 of FIG. 29, for use in a system 100, is equivalent to the CPRU protocol stack 460 of FIG. 28, for use in a system 10. Too, the gateway/gatekeeper protocol stack 550 of FIG. 29 is equivalent to the gateway/gatekeeper protocol stack 480 of FIG. 28.

The base station protocol stack 540 of FIG. 29 is a combination of the base station protocol stack 465 and the WARP protocol stack 470 of FIG. 28. On the end user side, the base station protocol stack 540 comprises an Adaptation Function layer 534, an SNDCP layer 536, an RR layer 533, a DLC layer 532, an LLC layer 537, an RLC/MAC layer 538 and a radio physical layer 531.

The RR layer 533, the DLC layer 532 and the radio physical layer 531 of the base station protocol stack 540 are equivalent to the respective RR layer 474, DLC layer 477 and radio physical layer 486 of the base station protocol stack 465 of FIG. 28. The SNDCP layer 536, the LLC layer 537 and the RLC/MAC layer 538 of the base station protocol stack 540 are equivalent to the SNDCP layer 492, LLC layer 491 and RLC/MAC layer 490 of the WARP protocol stack 470 of FIG. 28, except the SNDCP layer 536, LLC layer 537 and RLC/MAC layer 538 are managed in a base station 101, rather than a WARP 32.

On the network side, the base station protocol stack 540 comprises a T1/E1 layer 541 and a subnetwork protocol layer 542. On the end user side, the access router protocol stack 545 comprises a T1/E1 layer 543 and a subnetwork protocol layer 544.

The T1/E1 layers 541 and 543 of the respective base station protocol stack 540 and access router protocol stack 545 support the functionality for managing T1/E1 wireline transmission protocols, for the transmission of voice and fax signaling messages between a respective base station 101 and access router 35.

The subnetwork layers 542 and 544 of the respective base station protocol stack 540 and access router protocol stack 545 support subnetwork transmission protocols for transmitting IP-based voice and fax signaling messages between the base station 101 and access router 35. In an embodiment, the subnetwork layers 542 and 544 are ethernet layers, which support an ethernet transmission protocol between the respective base station 101 and access router 35. The ethernet transmission protocols are run under the overlying Internet Protocol (IP).

In an alternative embodiment, the subnetwork layers 542 and 544 are frame relay layers, which support a frame relay link layer transport protocol between the respective base station 101 and access router 35. In this alternative embodiment, for voice and fax signaling message transmissions, permanent virtual circuits (PVCs) are used between a base station 101 and an access router 35, and the frame relay protocols are run under the overlying Internet Protocol (IP).

On the network side, the access router protocol stack 545 comprises a physical interface layer 546 and a subnetwork protocol layer 547. The physical interface layer 546 and subnetwork protocol layer 547 of the access router protocol stack 545 are equivalent to the respective physical interface layer 503 and subnetwork protocol layer 502 of the access router protocol stack 475 of FIG. 28.

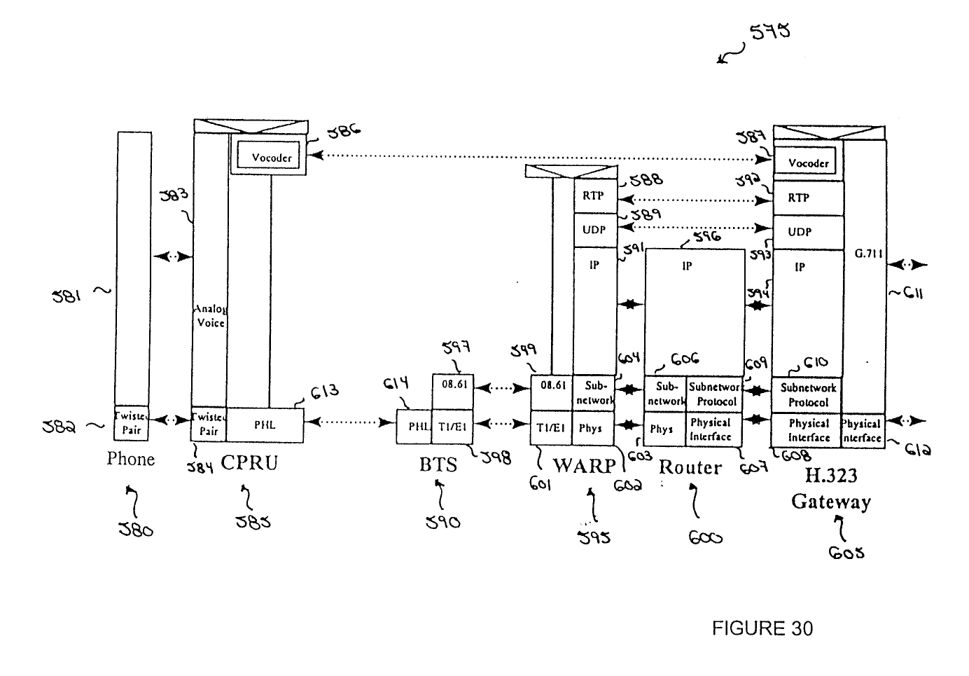

An embodiment of a voice bearer plane architecture 575, as shown in FIG. 30, for use in a system 10, comprises a phone protocol stack 580, a CPRU protocol stack 585, a base station protocol stack 590, a WARP protocol stack 595, an access router protocol stack 600 and an H.323 gateway protocol stack 605.

A phone protocol stack 580 comprises an analog voice protocol layer 581 and a physical layer 582. On the end user side, a CPRU protocol stack 585 comprises an analog voice protocol layer 583 and a physical layer 584.

In an embodiment, the physical interface between a telephone 15 and a CPRU is a twisted pair wireline interface. In an embodiment, the physical interface between a telephone 15 and a CPRU 25 is an RJ-11 interface. The physical layer 582 of the phone protocol stack 580 and the physical layer 584 of the CPRU protocol stack 585 manage voice bearer message transmissions on the physical interface between the respective telephone 15 and CPRU 25.

The analog voice protocol layers 581 and 583 for the respective phone protocol stack 580 and CPRU protocol stack 585 support the protocols necessary for managing the transmission and reception of analog voice messages between the respective telephone 15 and CPRU 25.

As per the H.323 standard, all H.323 terminals 17 have an audio codec. The wireless system 10 can support a variety of coding standards including, but not limited to, G.711 (Pulse Code Modulation (PCM) of voice frequencies); G.722 (7 kHz audio-coding within 64 kbit/s); G.728 (Coding of speech at 16 kbit/s using low-delay code excited linear prediction); G.729 (Coding of speech at 8 kbit/s using conjugate structure algebraic-code-excited linear-prediction (CS-ACELP)); MPEG 1 audio; and G.723.1 (Speech coders: Dual rate speech coder for multimedia communications transmitting at 5.3 and 6.3 kbit/s). The audio algorithm used by the respective H.323 terminal encoders is derived via the capability exchange signaling executed over the previously established H.245 channel between a CPRU 25 of an H.323 terminal 17 and an H.323 gatekeeper 55.

The vocoding function on the end user side resides in the respective CPRU 25 of an H.323 terminal 17, and the peer transcoding function resides in the respective H.323 gateways 45. Thus, the CPRU protocol stack 585 and the H.323 gateway protocol stack 605 each comprise respective vocoder layers 586 and 587.

In an embodiment, the wireless access system 10 uses a GSM (Global System for Mobile communication) half-rate vocoder functionality. The encoded voice bearer message stream is transported upstream from a WARP 32 within Real Time Protocol (RTP) packets. The Real Time Protocol is a protocol generally developed for the transmission of real time traffic, such as audio and video. RTP packets of voice messages can be carried over an unreliable channel, and thus, the User Datagram Protocol (UDP)/Internet Protocol (IP) is used.

The Real Time Protocol (RTP)/User Datagram Protocol (UDP)/Internet Protocol (IP) functions used for voice message packetizing and transmission reside in the WARPs 32 and H.323 gateways 45 of a system 10. Therefore, the WARP protocol stack 595 comprises an RTP layer 588, a UDP layer 589 and an IP layer 591, for managing the transmission of packetized IP-based voice bearer messages on a UDP/IP channel between the respective WARP 32 and an H.323 gateway 45. Too, the H.323 gateway protocol stack 605 comprises an RTP layer 592, a UDP layer 593 and an IP layer 594, for managing the transmission of packetized IP-based voice bearer messages on a UDP/IP channel between the respective H.323 gateway 45 and a WARP 32.

The IP layer 596 of the access router protocol stack 600 supports the transmission of IP-based voice bearer messages between an H.323 gateway 45 and a WARP 32.

The physical layer 613 of the CPRU protocol stack 585 and the physical layer 614 of the base station protocol stack 590 each support a GSM/GPRS (Global System for Mobile communication/General Packet Radio Service) radio interface. In an alternative embodiment, the physical layers 613 and 614 each support a GSM/Edge (Global System for Mobile communication/Enhanced Data rates for GSM Evolution) radio interface. The respective physical layers 613 and 614 each conceptually consist of two sub-layers, defined by their respective functionality.

The first sub-layer, the physical RF sub-layer, performs the modulation of the physical waveform signals for voice bearer traffic, for subsequent transmission on the over-the-air interface 27 between a CPRU 25 and a base station 30. The modulation is based on the sequence of bits received from the second sub-layer, the physical link sub-layer. The physical RF sub-layer also performs the demodulation of received waveform signals for voice bearer traffic into sequences of bits, which are then transferred to the physical link sub-layer for interpretation.

The second sub-layer, the physical link sub-layer, provides the services for the actual voice bearer traffic transmissions over a physical, wireless channel between a CPRU 25 and a base station 30. The physical link sub-layer utilizes the services of the respective physical RF sub-layer to perform its functions.

In an embodiment, for managing the transmission of voice bearer messages between a base station 30 and a WARP 32, the wireless access system 10 uses standard T1/E1 and 08.61 wireline transmission protocols. Thus, the base station protocol stack 590 comprises an 08.61 protocol layer 597 and a T1/E1 layer 598. Likewise, the WARP protocol stack 595 comprises an 08.61 protocol layer 599 and a T1/E1 layer 601.

The physical layers 602 and 603 of the respective WARP protocol stack 595 and access router protocol stack 600 support the functionality for managing voice bearer message transmissions on the physical transmission interface between the respective WARP 32 and access router 35. In an embodiment, the physical transmission interface between a WARP 32 and an access router 35 is a wireline interface.

The subnetwork layers 604 and 606 of the respective WARP protocol stack 595 and access router protocol stack 600 support subnetwork transmission protocols for transmitting IP-based voice bearer messages between the respective WARP 32 and access router 35. In an embodiment, the subnetwork layers 604 and 606 are frame relay layers, which support a frame relay link layer transport protocol between the respective WARP 32 and access router 35. Generally, frame relay is used for the transport, i.e., transmission, of both signaling information and bearer traffic messages. In the voice bearer plane 230, the subnetwork protocol layers 604 and 606 manage frame relay transport of IP-based voice bearer messages between the respective WARP 32 and access router 35.

In an embodiment, for voice bearer message transmissions, permanent virtual circuits (PVCs) are used between a WARP 32 and an access router 35, and the frame relay protocols are run under the overlying Internet Protocol (IP).

The physical interface layers 607 and 608 of the respective access router protocol stack 600 and H.323 gateway protocol stack 605 support the functionality for managing the physical transmission interface between the respective access router 35 and H.323 gateway 45. In an embodiment, the physical transmission interface between an access router 35 and an H.323 gateway 45 is a wireline interface. In an embodiment, the physical transmission interface between an access router 35 and an H.323 gateway 45 is a standard 10BaseT wireline communications interface.

The subnetwork protocol layers 609 and 610 of the respective access router protocol stack 600 and H.323 gateway protocol stack 605 support subnetwork transmission protocols for transmitting IP-based voice bearer messages between the respective access router 35 and H.323 gateway 45. In an embodiment, the subnetwork protocol layers 609 and 610 are ethernet layers, which support an ethernet transport protocol between the respective access router 35 and H.323 gateway 45.

An H.323 gateway 45 performs the transcoding between the H.323 transmission format used throughout the system 10 and the switched circuit format used by the switched circuit network 50.

On the switched circuit network side, the H.323 gateway protocol stack 605 comprises a G.711 (Pulse Code Modulation (PCM) of voice frequencies) protocol layer 611 and a physical interface layer 612. In an embodiment, the physical interface between an H.323 gateway 45 and a switched circuit network 50 is a wireline interface. The physical interface layer 612 of the H.323 gateway protocol stack 605 supports the functionality for managing voice bearer message transmissions on the physical wireline interface between the respective H.323 gateway 45 and a switched circuit network 50.

The G.711 protocol layer 611 of the H.323 gateway protocol stack 605 supports G.711 protocol management of voice bearer messages sent to and received from a switched circuit network 50.

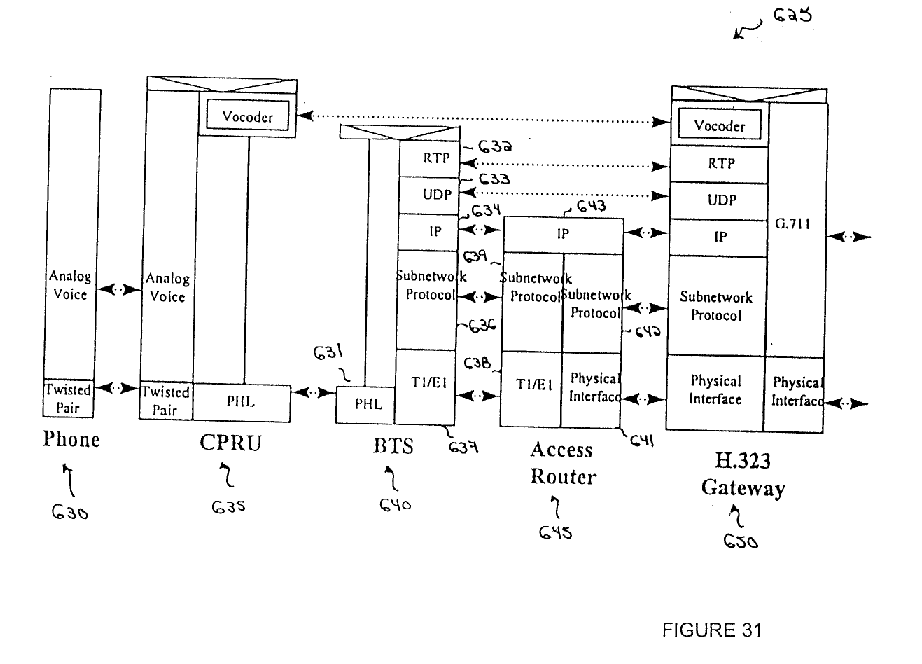

In an alternative embodiment, system 100, as shown in FIG. 5, has a base station 101, and does not use Wireless Adjunct inteRnet Platforms (WARPs) 32. An embodiment of a voice bearer plane architecture 625, as shown in FIG. 31, for use in a system 100, comprises a phone protocol stack 630, a CPRU protocol stack 635, a base station protocol stack 640, an access router protocol stack 645 and an H.323 gateway protocol stack 650.

The phone protocol stack 630 of FIG. 31, for use in a system 100, is equivalent to the phone protocol stack 580 of FIG. 30, for use in a system 10. Further, the CPRU protocol stack 635 of FIG. 31 is equivalent to the CPRU protocol stack 585 of FIG. 30. Too, the H.323 gateway protocol stack 650 of FIG. 31 is equivalent to the H.323 gateway protocol stack 605 of FIG. 30.

The base station protocol stack 640 of FIG. 31 is a combination of the base station protocol stack 590 and WARP protocol stack 595 of FIG. 30. On the end user side, the base station protocol stack 640 comprises a physical layer 631, which is equivalent to the physical layer 614 of the base station protocol stack 590 of FIG. 30.

On the network side, the base station protocol stack 640 comprises a Real Time Protocol (RTP) layer 632, a User Datagram Protocol (UDP) layer 633, an Internet Protocol (IP) layer 634, a subnetwork protocol layer 636 and a T1/E1 layer 637.

The RTP layer 632, the UDP layer 633 and the IP layer 634 of the base station protocol stack 640 are equivalent to the respective RTP layer 588, UDP layer 589 and IP layer 591 of the WARP protocol stack 595, except the RTP layer 632, UDP layer 633 and IP layer 634 functionalities are managed in a base station 101, rather than a WARP 32.

On the end user side, the access router protocol stack 645 comprises a T1/E1 layer 638 and a subnetwork protocol layer 639.

The T1/E1 layers 637 and 638 of the respective base station protocol stack 640 and access router protocol stack 645 each comprise the protocols and procedures for managing a physical T1/E1 communication interface between the respective base station 101 and access router 35. The T1/E1 communication interface is a standard wireline interface. In the voice bearer plane 230, the T1/E1 layers 637 and 638 manage the physical transmission interface for transmitting voice bearer messages between the respective base station 101 and access router 35.

The subnetwork protocol layers 636 and 639 of the respective base station protocol stack 640 and access router protocol stack 645 support the functionality for the subnetwork transmission protocols for voice bearer message transmissions between the respective base station 101 and access router 35. In an embodiment, the subnetwork protocol layers 636 and 639 are frame relay layers, which support a frame relay link layer transport protocol between the respective base station 101 and access router 35.

In an embodiment, for voice bearer message transmissions, permanent virtual circuits (PVCs) are used between a base station 101 and an access router 35, and the frame relay protocols are fun under the overlying Internet Protocol (IP).

On the network side, the access router protocol stack 645 comprises a physical interface layer 641 and a subnetwork protocol layer 642. The physical interface layer 641 and the subnetwork protocol layer 642 of the access router protocol stack 645 are equivalent to the respective physical interface layer 607 and subnetwork protocol layer 609 of the access router protocol stack 600 of FIG. 30.

The access router protocol stack 645 further comprises an Internet Protocol (IP) layer 643, which supports the transmission of IP-based voice bearer messages between an H.323 gateway 45 and a base station 101.

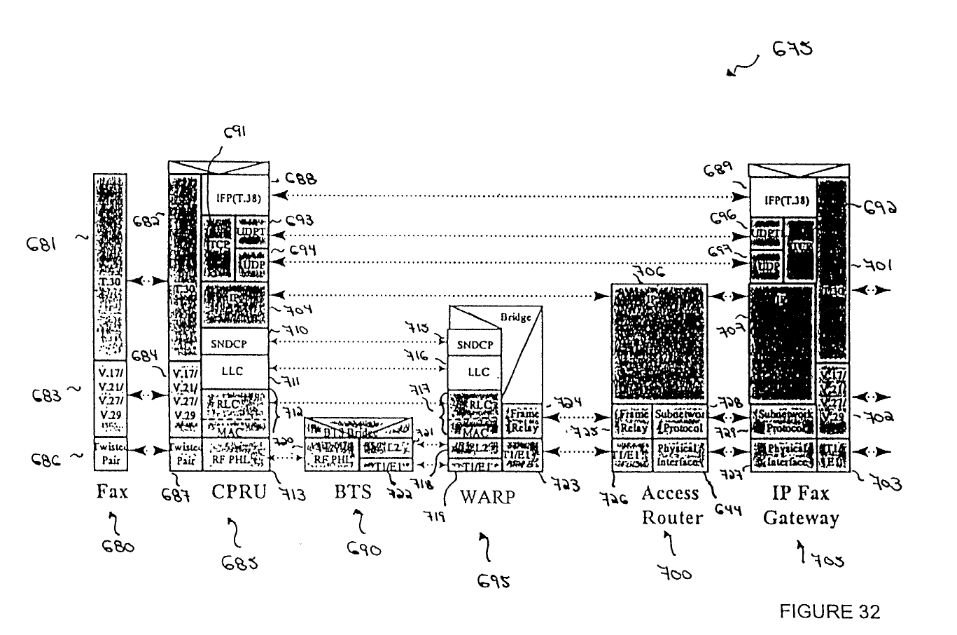

An embodiment of a fax bearer plane architecture 675, as shown in FIG. 32, for use in a system 10, comprises a fax protocol stack 680, a CPRU protocol stack 685, a base station protocol stack 690, a WARP protocol stack 695, an access router protocol stack 700 and a fax gateway protocol stack 705.

In an embodiment, a CPRU 25 of a fax terminal 14 has a fax modem which receives fax bearer message transmissions from a standard fax device 12. In an embodiment, the protocol supported for transmission between a fax device 12 and a CPRU 25 is T.30. Thus, the fax protocol stack 680 comprises a T.30 protocol layer 681 and the CPRU protocol stack 685 comprises a T.30 protocol layer 682, for managing the transmission and reception of fax bearer messages between the respective fax device 12 and CPRU 25.

In an embodiment, a number of transmission protocols are supported on the communications interface between a fax device 12 and a CPRU 25 including, but not limited to, V.17, V.21, V.27 and V.29. Thus, the fax protocol stack 680 comprises a transmission protocol layer 683 for managing one or more of these transmission protocols. The CPRU protocol stack 685 comprises a transmission protocol layer 684 for managing one or more of these transmission protocols.

The fax protocol stack 680 and the CPRU protocol stack 685 comprise respective physical layers 686 and 687. In an embodiment, the physical interface between a fax device 12 and a CPRU 25 is a twisted pair wireline interface. In an embodiment, the physical interface between a fax device 12 and a CPRU 25 is an RJ-11 interface. The physical layers 686 and 687 manage fax bearer message transmissions on the physical interface between the respective fax device 12 and CPRU 25.

In an embodiment, the Internet Fax Protocol (IFP), based on the T.38 standard, is used end-to-end between a CPRU 25 of a fax terminal 14 and a fax gateway 57, to transfer packetized fax bearer messages over the core packet data transmission planes in a system 10.

A CPRU 25 provides fax interworking functionality to generate and transmit IFP T.38 packetized fax bearer messages from a fax device 12 upstream, through a system 10. A CPRU 25 further provides reverse fax interworking functionality to unpacketize, or otherwise reassemble, packetized fax bearer messages from the system 10, for transmission to a fax device 12.

A fax gateway 57 provides fax interworking functionality to generate and transmit IFP T.38 packetized fax bearer messages from a switched circuit network 50 downstream, through a system 10. A fax gateway 57 further provides reverse fax interworking functionality to unpacketize, or otherwise reassemble, packetized fax bearer messages from a fax terminal 14, for transmission to a switched circuit network 50.

Thus, the CPRU protocol stack 685 and the fax gateway protocol stack 705 comprise respective Internet Fax Protocol (IFP) layers 688 and 689 for managing the generation and transmission of IFP T.38 fax bearer messages through the wireless access system 10, and the subsequent unpacketizing of fax bearer messages for transmission to their destination.

In an embodiment, a fax gateway 57 transmits and receives fax bearer messages to and from a switched circuit network 50 using the T.30 protocol and a negotiated underlying transmission protocol, including, but not limited to, V.17, V.21, V.27 and V.29. Thus, the fax gateway protocol stack 705 comprises a T.30 protocol layer 701 and a transmission protocol layer 702 for managing the transmission and reception of fax bearer messages between the respective fax gateway 57 and a switched circuit network 50.

In an embodiment, the physical interface between a fax gateway 57 and a switched circuit network 50 is a T1/E1 wireline interface. Thus, the fax gateway protocol stack 705 comprises a T1/E1 layer 703 for managing fax bearer message transmissions between the respective fax gateway 57 and a switched circuit network 50.

In an embodiment, fax bearer messages are transmitted within the wireless access system 10 as packetized data over the underlying IP packet data network from a CPRU 25 of a fax terminal 14 or a fax gateway 57 to a recipient CPRU 25 of a fax terminal 14 or a fax gateway 57. As the underlying protocol for fax bearer message transmissions is the Internet Protocol (IP), the CPRU protocol stack 685, the access router protocol stack 700 and the fax gateway protocol stack 705 comprise respective IP layers 704, 706 and 707, for supporting the transmission of IP-based fax bearer messages between a CPRU 25 of a fax terminal 14 and a fax gateway 57. A CPRU 25 is an endpoint on the end user side for IP-based fax bearer message transmissions to a fax terminal 14. Thus, a CPRU 25 of a fax terminal 14 is instantiated with an IP address. On the network side, a fax gateway 57 is the endpoint for IP-based fax bearer message transmissions from a fax terminal 14 to a destination switched circuit network 50.

Fax bearer messages may be sent over reliable channels within the wireless access system 10. Thus, the CPRU protocol stack 685 and the fax gateway protocol stack 705 comprise respective Transmission Control Protocol (TCP) layers 691 and 692, that with the respective IP layers 704 and 707, support reliable transmission channel management for fax bearer messages through the wireless access system 10. TCP is designed to provide end-to-end reliability, graceful connection closures, unambiguous transmission connections, handshaking and several quality-of-service operations.

Fax bearer messages may also be sent over unreliable channels within the wireless access system 10. Thus, the CPRU protocol stack 685 comprises a UDPT protocol layer 693 and a User Datagram Protocol (UDP) layer 694 that, with the IP layer 704, support unreliable transmission channel management for fax bearer message transmissions through the wireless access system 10. UDP provides a minimal level of service for message transmissions; with the use of the UDP provisions, the overlying application is generally tasked with performing most of the end-to-end reliability operations that the TCP provisions manage.

The fax gateway protocol stack 705 also comprises a UDPT layer 696 and a UDP layer 697, that with the IP layer 707, support unreliable transmission channel management for fax bearer message transmissions through the wireless access system 10.

The CPRU protocol stack 685 further comprises a Subnetwork Dependent Convergence Protocol (SNDCP) layer 710, a Logical Link Control (LLC) layer 711, a Radio Link Control/Medium Access Control (RLC/MAC) layer 712 and a radio physical layer 713.

On the end user side, the WARP protocol stack 695 comprises an SNDCP layer 715, an LLC layer 716 and an RLC/MAC layer 717.

The RLC/MAC layers 712 and 717 of the respective CPRU protocol stack 685 and WARP protocol stack 695 are equivalent to the RLC/MAC layers 257 and 268 of the respective CPRU protocol stack 255 and WARP protocol stack 265 of FIG. 21, except that the RLC/MAC layers 712 and 717 support the transmission of fax bearer messages rather than packet data signaling messages. Too, the LLC layers 711 and 716 of the respective CPRU protocol stack 685 and WARP protocol stack 695 are equivalent to the LLC layers 258 and 269 of the respective CPRU protocol stack 255 and WARP protocol stack 265 of FIG. 21, except that the LLC layers 711 and 716 support the transmission of fax bearer messages rather than packet data signaling messages.

The SNDCP layers 710 and 715 of the respective CPRU protocol stack 685 and WARP protocol stack 695 each comprise part of the wireless middleware functionality that plugs, or otherwise connects or overlaps, the system functionality onto the system's physical radio interfaces. The SubNetwork Dependent Convergence Protocol (SNDCP) is executed between a CPRU 25 and a WARP 32.

The SNDCP layers 710 and 715 each support the mapping of network level, i.e., Internet Protocol (IP), fax bearer messages onto the underlying network protocols. The respective SNDCP layers 710 and 715 support the adaptation of IP-based fax bearer messages to over-the-air Logical Link Control (LLC) frames for transmission between a CPRU 25 and a WARP 32, via a base station 30. Further, the SNDCP layer 715 of the WARP protocol stack 695 supports the adaptation of LLC frames to respective IP-based fax bearer messages, for subsequent transmission to a fax gateway 57, via an access router 35.

The SNDCP layers 710 and 715 support the compression and decompression of message headers, including, but not limited to, Internet Protocol (IP) message headers, of IP-based fax bearer messages sent and received on the over-the-air interface 27 between the respective CPRU 25 and WARP 32, via a base station 30.

The SNDCP layers 710 and 715 further provide a mechanism for determining the length of a fax bearer message, and its individual packets, for subsequent use in the compression/decompression message header algorithms. Too, the SNDCP layers 710 and 715 support functionality for providing the packet type, including, but not limited to, normal IP packet, full header packet and context state packet, to the requisite compression and decompression algorithms.

The SNDCP layers 710 and 715 also support the Quality of Service (QoS) functionality for fax bearer message transmissions. In an embodiment, the QoS profile for fax bearer message transmissions is a non real-time profile.

On the end user side, the base station protocol stack 690 comprises a radio physical layer 720. The radio physical layers 713 and 720 of the respective CPRU protocol stack 685 and base station protocol stack 690 support the functionality for managing the physical over-the-air, i.e., radio, transmission interface between the respective CPRU 25 and base station 30.

In an embodiment, for managing the transmission of fax bearer messages between a base station 30 and a WARP 32, the wireless access system 10 uses standard T1/E1 and L2 wireline transmission protocols. Thus, the base station protocol stack 690 comprises an L2 protocol layer 721 and a T1/E1 protocol layer 722. Likewise, the WARP protocol stack 695 comprises an L2 protocol layer 718 and a T1/E1 layer 719.

In an embodiment, for managing the transmission of fax bearer messages between a WARP 32 and an access router 35, the wireless access system 10 uses the T1/E1 and frame relay protocols. Thus, the WARP protocol stack 695 comprises a T1/E1 layer 723 and a frame relay layer 724. Too, the access router protocol stack 700 comprises a T1/E1 layer 726 and a frame relay layer 725.

The T1/E1 layers 723 and 726 of the respective WARP protocol stack 695 and access router protocol stack 700 support the functionality for managing the transmission of fax bearer messages on the physical transmission interface between the respective WARP 32 and access router 35.

Generally, frame relay is used for the transport, i.e., transmission, of both signaling information and bearer traffic messages. In the fax bearer plane 235, the frame relay layers 724 and 725 of the respective WARP protocol stack 695 and access router protocol stack 700 manage frame relay transport of IP-based fax bearer messages between the respective WARP 32 and access router 35.

In an embodiment, for fax bearer message transmissions, permanent virtual circuits (PVCs) are used between a WARP 32 and an access router 35, and the frame relay protocols are run under the overlying Internet Protocol (IP).

On the network side, the access router protocol stack 700 comprises a physical interface layer 644 and a subnetwork protocol layer 728. On the end user side, the fax gateway protocol stack 705 comprises a physical interface layer 727 and a subnetwork protocol layer 729.

The physical interface layers 644 and 727 of the respective access router protocol stack 700 and fax gateway protocol stack 705 support the functionality for managing the physical transmission interface between the respective access router 35 and fax gateway 57. In an embodiment, the physical transmission interface between an access router 35 and a fax gateway 57 is a wireline interface. In an embodiment, the physical transmission interface between an access router 35 and a fax gateway 57 is a standard 10BaseT wireline communications interface.

The subnetwork protocol layers 728 and 729 of the respective access router protocol stack 700 and fax gateway protocol stack 705 support the functionality for managing the underlying transmission protocol for IP-based fax bearer messages transmitted between the respective access router 35 and fax gateway 57. In an embodiment, the subnetwork protocol layers 728 and 729 are ethernet layers, which support an ethernet transport protocol between the respective access router 35 and fax gateway 57.

The BTS bridge functionality in the fax bearer plane architecture 675 allows a base station 30 to operate as a transmission link layer bridge, obviating the need for IP data transmission routing within the base station 30. Too, the WARP bridge functionality in the fax bearer plane architecture 675 allows a WARP 32 to operate as a transmission link layer bridge, obviating the need for IP data transmission routing within the WARP 32.

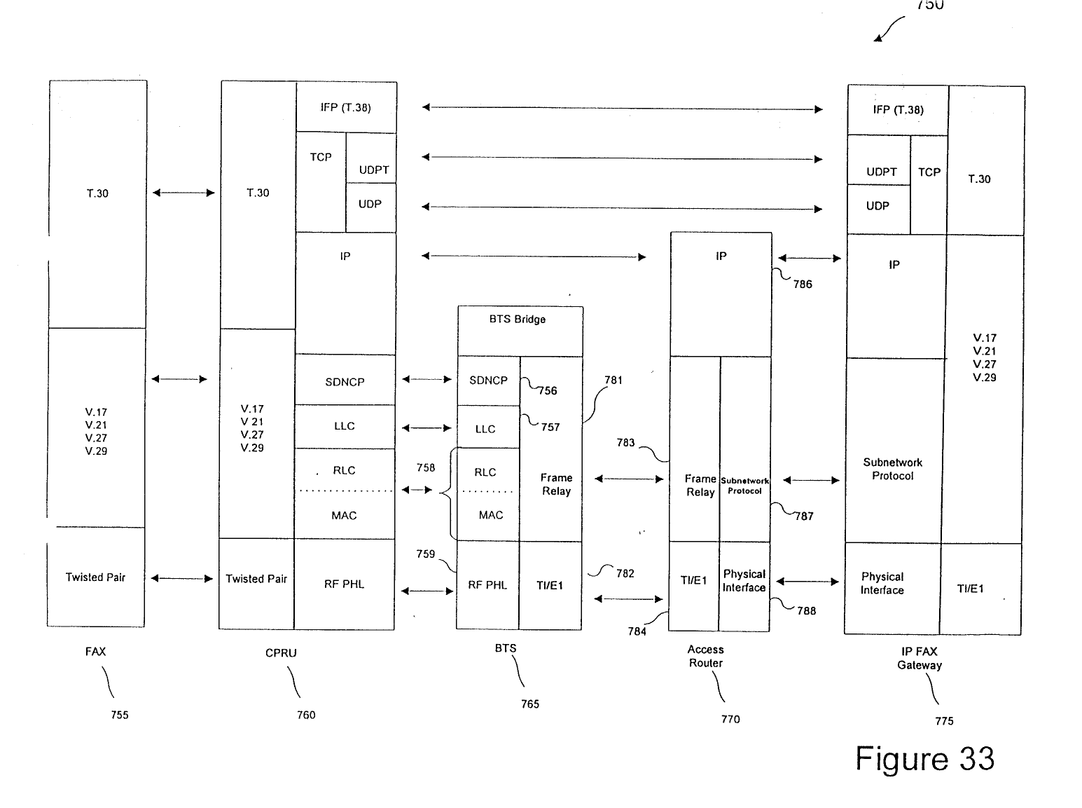

As previously discussed, in an alternative embodiment, a wireless access system 100, as shown in FIG. 5, has a base station 101, and does not use Wireless Adjunct inteRnet Platforms (WARPs) 32. An embodiment of a fax bearer plane architecture 750, as shown in FIG. 33, for use in a system 100, comprises a fax protocol stack 755, a CPRU protocol stack 760, a base station protocol stack 765, an access router protocol stack 770 and a fax gateway protocol stack 775.

The fax protocol stack 755 of FIG. 33, for use in a system 100, is equivalent to the fax protocol stack 680 of FIG. 32, for use in a system 10. The CPRU protocol stack 760 of FIG. 33 is equivalent to the CPRU protocol stack 685 of FIG. 32. Too, the fax gateway protocol stack 775 of FIG. 33 is equivalent to the fax gateway protocol stack 705 of FIG. 32.

The base station protocol stack 765 of FIG. 33 is a combination of the base station protocol stack 690 and WARP protocol stack 695 of FIG. 32. On the end user side, the base station protocol stack 765 comprises a SubNetwork Dependent Convergence Protocol (SNDCP) layer 756, a Logical Link Control (LLC) layer 757, a Radio Link Control/Medium Access Control (RLC/MAC) layer 758 and a radio physical layer 759.

The radio physical layer 759 of the base station protocol stack 765 is equivalent to the radio physical layer 720 of the base station protocol stack 690 of FIG. 32.

The SNDCP layer 756, the LLC layer 757 and the RLC/MAC layer 758 of the base station protocol stack 765 are equivalent to the respective SNDCP layer 715, LLC layer 716 and RLC/MAC layer 717 of the WARP protocol stack 695 of FIG. 32, except the SNDCP layer 756, LLC layer 757 and RLC/MAC layer 758 are managed in a base station 101 rather than a WARP 32.

On the network side, the base station protocol stack 765 comprises a frame relay layer 781 and a T1/E1 layer 782. On the end user side, the access router protocol stack 770 comprises a frame relay layer 783 and a T1/E1 layer 784.

The T1/E1 layers 782 and 784 of the respective base station protocol stack 765 and access router protocol stack 770 support the functionality for managing T1/E1 wireline transmission protocols, for the transmission of fax bearer messages between a respective base station 101 and access router 35.

The frame relay layers 781 and 783 of the respective base station protocol stack 765 and access router protocol stack 770 manage frame relay transport of IP-based fax bearer messages between the respective base station 101 and access router 35.

In an embodiment, for fax bearer message transmissions, permanent virtual circuits (PVCS) are used between a base station 101 and an access router 35, and the frame relay protocols are run under the overlying Internet Protocol (IP).

On the network side, the access router protocol stack 770 comprises a physical interface layer 788 and a subnetwork protocol layer 787. The physical interface layer 788 and the subnetwork protocol layer 787 of the access router protocol stack 770 are equivalent to the respective physical interface layer 644 and subnetwork protocol layer 728 of the access router protocol stack 700 of FIG. 32.

The access router protocol stack 770 further comprises an Internet Protocol (IP) layer 786, which is equivalent to the IP protocol layer 706 of the access router protocol stack 700 of FIG. 32.

The BTS bridge functionality in the fax bearer plane architecture 750 allows a base station 101 to operate as a transmission link layer bridge, obviating the need for IP data transmission routing within the base station 101.

While embodiments are disclosed herein, many variations are possible which remain within the spirit and scope of the inventions. Such variations are clear upon inspection of the specification, drawings and claims herein. The inventions therefore are not to be restricted except by the scope of the appended claims.

What is claimed is as follows:

1. A telecommunications system supporting wireless access, comprising:
a computing device;
a Customer Premise Radio Unit (CPRU) connected to said computing device;
a base station, said base station and said Customer Premise Radio Unit communicating via an over-the-air interface, said over-the-air interface supporting a wide area wireless protocol;
a Wireless Adjunct InteRnet Platform (WARP), said WARP and said base station communicating via a first interface;
an access router, said access router and said WARP communicating via a second interface; and
a gateway, said gateway and said access router communicating via a third interface, said gateway further communicating with a data network via a fourth interface.

2. The telecommunications system of claim 1, wherein said computing device comprises a personal computer and said computing device and said Customer Premise Radio Unit comprise a network subscriber terminal.

3. The telecommunications system of claim 2, further comprising said network subscriber terminal allocated a first internet protocol (IP) address for communicating within said telecommunications system and said Wireless Adjunct InteRnet Platform (WARP) allocated a second internet protocol (IP) address for communicating within said telecommunications system.

4. The telecommunications system of claim 2, in which said gateway transmits a packet data message from said data network to said access router, said access router transmits said packet data message to said Wireless Adjunct InteRnet Platform (WARP), said WARP transmits said packet data message to said base station and said base station transmits said packet data message to said network subscriber terminal.

5. The telecommunications system of claim 1, wherein said first interface comprises a wireline interface, said second interface comprises a wireline interface, said third interface comprises a wireline interface and said fourth interface comprises a wireline interface.

6. The telecommunications system of claim 1, in which said data network comprises the Internet.

7. The telecommunications system of claim 1, further comprising a telephone connected to said Customer Premise Radio Unit, said telephone and said Customer Premise Radio Unit comprising an H.323 terminal.

8. The telecommunications system of claim 7, further comprising an H.323 gateway, said H.323 gateway comprising the capability to transmit a voice bearer message from a switched circuit network to said access router, said access router comprising the capability to transmit said voice bearer message to said Wireless Adjunct InteRnet Platform (WARP), said WARP comprising the capability to transmit said voice bearer message to said base station and said base station comprising the capability to transmit said voice bearer message to said H.323 terminal.

9. The telecommunications system of claim 8, in which said switched circuit network comprises a Public Switched Telephone Network (PSTN).

10. The telecommunications system of claim 1, further comprising a facsimile device connected to said Customer Premise Radio Unit, said facsimile device and said Customer Premise Radio Unit comprising a fax terminal.

11. The telecommunications system of claim 10, further comprising a fax gateway, said fax gateway comprising the capability to transmit a fax bearer message from a switched circuit network to said access router, said access router comprising the capability to transmit said fax bearer message to said Wireless Adjunct InteRnet Platform (WARP), said WARP comprising the capability to transmit said fax bearer message to said fax terminal.

12. A telecommunications system supporting wireless access, said telecommunications system comprising:
a computing device;
a telephone;
a Customer Premise Radio Unit capable of receiving packet transmissions on an over-the-air interface, said Customer Premise Radio Unit connected to said computing device and said Customer Premise Radio Unit connected to said telephone; and
a wireless access network capable of communicating with a packet data network, said wireless access network further capable of communicating with a switched circuit network, said wireless access network comprising the capability to communicate with said Customer Premise Radio Unit via a wireless interface, said wireless interface comprising the capability to support a wide area wireless protocol.

13. The telecommunications system of claim 12, in which said packet data network comprises the Internet.

14. The telecommunications system of claim 12, in which said switched circuit network comprises an external Public Switched Telephone Network (PSTN).

15. The telecommunications system of claim 12, in which said packet transmissions comprise packet data message transmissions.

16. The telecommunications system of claim 12, in which said packet transmissions comprise Internet Protocol (IP) packet voice message transmissions.

17. The telecommunications system of claim 12, further comprising a facsimile device, said facsimile device connected to said Customer Premise Radio Unit.

18. The telecommunications system of claim 12, in which said wireless access network comprises a base station and a Wireless Adjunct InteRnet Platform (WARP), said base station communicating with said Customer Premise Radio Unit via an over-the-air interface, said base station communicating with said WARP via a wireline interface.

19. A wireless access network, said wireless network comprising a Wireless Adjunct InteRnet Platform (WARP), said WARP comprising functionality for managing packet data transmissions, said WARP further comprising functionality for managing IP packet voice transmissions, said IP packet voice transmissions comprising IP packet voice messages.

20. The wireless access network of claim 19, in which said functionality for managing packet data transmissions comprises:
functionality for managing a physical interface between said WARP and a base station in said wireless access network;
functionality for managing transmission protocols for packet data transmissions between said WARP and a base station in said wireless access network;
functionality for managing a base station's radio interface; functionality for managing the transmission of packets of packet data between said WARP and a network subscriber terminal;
functionality for managing the transmission of packet data between said WARP and a network subscriber terminal; and
functionality for managing the reception and transmission of packet data using the Internet Protocol.

21. The wireless access network of claim 20, in which said WARP comprises a protocol stack for managing packet data transmissions, said WARP protocol stack for managing packet data transmissions comprising:
an Abis physical layer for managing a GSM Abis physical interface between said WARP and a base station in said wireless access network;
a PCU Frames layer for managing the transmission protocols for packet data transmissions between said WARP and a base station in said wireless access network;
a Radio Link Control/Medium Access Control (RLC/MAC) layer for managing a base station's radio interface;
a Logical Link Control (LLC) layer for managing the transmission of packets of packet data between said WARP and a network subscriber terminal;
a Subnetwork Dependent Convergence Protocol (SNDCP) layer for managing the transmission of packet data between said WARP and a network subscriber terminal; and
an Internet Protocol (IP) layer for managing the reception and transmission of packet data using the Internet Protocol.

22. The wireless access network of claim 20, said functionality for managing packet data transmissions further comprising:
functionality for managing a physical interface between said WARP and an access router in said wireless access network;
functionality for managing the transmission and reception of packets of packet data transmitted between said WARP and an access router in said wireless access network; and
functionality for managing the transmission interface resources between said WARP and an access router in said wireless access network.

23. The wireless access network of claim 19, in which said functionality for managing IP packet voice transmissions comprises:
functionality for managing a physical interface between said WARP and a base station in said wireless access network;
functionality for managing the transmission protocols for IP packet voice transmissions between said WARP and a base station in said wireless access network;
functionality for managing a physical interface between said WARP and an access router in said wireless access network;
functionality for managing the transmission protocols for IP packet voice transmissions between said WARP and an access router in said wireless access network;
functionality for managing the transmission and reception of IP packet voice messages using the Internet Protocol, said IP packet voice messages transmitted using the Internet Protocol between said WARP and an access router in said wireless access network;
functionality for managing the transmission and reception of IP packet voice messages on a logical transmission channel between said WARP and an H.323 gateway in said wireless access network; and
functionality for managing the transmission and reception of IP packet voice messages between said WARP and an H.323 gateway in said wireless access network using the Real Time Protocol (RTP).

24. The wireless access network of claim 23, in which said WARP comprises a protocol stack for managing IP packet voice transmissions, said WARP protocol stack for managing IP packet voice transmissions comprising:
a T1/E1 layer for managing a T1/E1 physical interface between said WARP and a base station in said wireless access network;
an 08.61 layer for managing the transmission protocols for IP packet voice transmissions between said WARP and a base station in said wireless access network;
a physical layer for managing the physical interface between said WARP and an access router in said wireless access network;
a subnetwork protocol layer for managing the transmission protocols for IP packet voice transmissions between said WARP and an access router in said wireless access network;
an Internet Protocol (IP) layer for managing the reception and transmission of IP packet voice messages using the Internet Protocol, said IP packet voice messages transmitted using the Internet Protocol between said WARP and an access router in said wireless access network;
a User Datagram Protocol (UDP) layer for managing the transmission and reception of IP packet voice messages using the User Datagram Protocol, said IP packet voice messages transmitted using the User Datagram Protocol on a unsecure logical channel between said WARP and an H.323 gateway in said wireless access network; and
a Real Time Protocol (RTP) layer for managing the transmission and reception of IP packet voice messages using the Real Time Protocol, said IP packet voice messages transmitted using the Real Time Protocol between said WARP and an H.323 gateway in said wireless access network.

25. The wireless access network of claim 19, in which said WARP further comprises functionality for managing IP packet fax transmissions, said IP packet fax transmissions comprising IP packet fax messages.

26. The wireless access network of claim 25, in which said functionality for managing IP packet fax transmissions comprises:
functionality for managing a physical interface between said WARP and a base station in said wireless access network;
functionality for managing the transmission protocols for IP packet fax transmissions between said WARP and a base station in said wireless access network;
functionality for managing a base station's radio interface;
functionality for managing the transmission of packets of IP packet fax messages between said WARP and a fax terminal;
functionality for managing the transmission of IP packet fax messages between said WARP and a fax terminal;
functionality for managing the physical interface between said WARP and an access router in said wireless access network; and
functionality for managing the transmission protocols for IP packet fax transmissions between said WARP and an access router in said wireless access network.

27. The wireless access system of claim 26, in which said WARP comprises a protocol stack for managing IP packet fax transmissions, said WARP protocol stack for managing IP packet fax transmissions comprising:
a first T1/E1 layer for managing a T1/E1 physical interface between said WARP and a base station in said wireless access network;
an L2 layer for managing the transmission protocols for IP packet fax transmissions between said WARP and a base station in said wireless access network;
a Radio Link Control/Medium Access Control (RLC/MAC) layer for managing a base station's radio interface;
a Logical Link Control (LLC) layer for managing the transmission of packets of IP packet fax messages between said WARP and a fax terminal;
a Subnetwork Dependent Convergence Protocol (SNDCP) layer for managing the transmission of IP packet fax messages between said WARP and a fax terminal;
a second T1/E1 layer for managing the T1/E1 physical interface between said WARP and an access router in said wireless access network; and
a frame relay layer for managing frame relay transmission protocols for transmitting IP packet fax messages between said WARP and an access router in said wireless access network.

28. A Customer Premise Radio Unit (CPRU), said CPRU comprising functionality for managing packet data transmissions between a computing device and a wireless access network, said CPRU further comprising functionality for managing voice message transmissions between a telephone and a wireless access network.

29. The CPRU of claim 28, in which said CPRU communicates with a base station in a wireless access network via an over-the-air interface between said CPRU and said base station.

30. The CPRU of claim 28, in which said functionality for managing packet data transmissions comprises:
functionality for managing a physical interface between said CPRU and a computing device;
functionality for managing point-to-point transmission protocols for packet data transmissions between said CPRU and a computing device;
functionality for managing a radio physical interface between said CPRU and a base station in the wireless access network;
functionality for managing access to radio channels for packet data transmissions between said CPRU and a base station in the wireless access network;
functionality for managing the transmission of packets of packet data between said CPRU and the wireless access network; and
functionality for managing the transmission of packet data between said CPRU and the wireless access network.

31. The CPRU of claim 30, in which said CPRU comprises a protocol stack for managing packet data transmissions, said CPRU protocol stack for managing packet data transmissions comprising:
a physical layer for managing the physical interface between said CPRU and a computing device;
a point-to-point layer for managing point-to-point transmission protocols for packet data transmissions between said CPRU and a computing device;
a radio physical layer for managing the radio physical interface between said CPRU and a base station in the wireless access network;
a Radio Link Control/Medium Access Control (RLC/MAC) layer for managing said CPRU's access to radio channels for packet data transmissions between said CPRU and a base station in the wireless access network;
a Logical Link Control (LLC) layer for managing the transmission of packets of packet data between said CPRU and the wireless access network; and
a Subnetwork Dependent Convergence Protocol (SNDCP) layer for managing the transmission of packet data between said CPRU and the wireless access network.

32. The CPRU of claim 28, in which said functionality for managing voice message transmissions comprises:
functionality for managing a physical interface between said CPRU and a telephone;
functionality for managing analog transmission protocols for the transmission of voice messages between said CPRU and a telephone;
functionality for managing a radio physical interface between said CPRU and a base station in the wireless access network; and
functionality for managing vocoder functionality for the transmission of vocoded voice messages between said CPRU and the wireless access network.

33. The CPRU of claim 32, in which said CPRU comprises a protocol stack for managing voice message transmissions, said CPRU protocol stack for managing voice message transmissions comprising:
a first physical layer for managing the physical interface between said CPRU and a telephone;
an analog layer for managing analog transmission protocols for the transmission of voice messages between said CPRU and a telephone;
a second physical layer for managing the radio physical interface between said CPRU and a base station in the wireless access network; and
a vocoder layer for managing the transmission and reception of vocoded voice messages transmitted between said CPRU and the wireless access network.

34. The CPRU of claim 28, further comprising functionality for managing IP packet fax transmissions between a facsimile device and a wireless access network, said IP packet fax transmissions comprising IP packet fax messages.

35. The CPRU of claim 34, in which said functionality for managing IP packet fax transmissions comprises:
functionality for managing a radio physical interface between said CPRU and a base station in the wireless access network;
functionality for managing access to radio channels for IP packet fax message transmissions between said CPRU and a base station in the wireless access network;
functionality for managing the transmission of packets of IP packet fax messages between said CPRU and the wireless access network;
functionality for managing the transmission of IP packet fax messages between said CPRU and the wireless access network;
functionality for managing the reception and transmission of IP packet fax messages between said CPRU and the wireless access network using the Internet Protocol;
functionality for managing the transmission and reception of IP packet fax messages on an unsecure logical transmission channel between said CPRU and the wireless access network;
functionality for managing the transmission and reception of IP packet fax messages on a secure logical transmission channel between said CPRU and the wireless access network; and
functionality for managing the transmission and reception of IP packet fax messages between said CPRU and the wireless access network using the Internet Fax Protocol (IFP) T.38 protocols.

36. The CPRU of claim 35, in which said CPRU comprises a protocol stack for managing IP packet fax transmissions, said CPRU protocol stack for managing IP packet fax transmissions comprising:
a radio physical layer for managing the radio physical interface between said CPRU and a base station in the wireless access network;
a Radio Link Control/Medium Access Control (RLC/MAC) layer for managing the protocols for access to radio channels for IP packet fax message transmissions between said CPRU and a base station in the wireless access network;
a Logical Link Control (LLC) layer for managing the transmission of packets of IP packet fax messages between said CPRU and the wireless access network;
a Subnetwork Dependent Convergence Protocol (SNDCP) layer for managing the transmission of IP packet fax messages between said CPRU and the wireless access network;
an Internet Protocol (IP) layer for managing the reception and transmission of IP packet fax messages between said CPRU and the wireless access network using the Internet Protocol;
a User Datagram Protocol (UDP) layer for managing the transmission and reception of IP packet fax messages using the User Datagram Protocol on an unsecure logical transmission channel between said CPRU and the wireless access network;
a Transmission Control Protocol (TCP) layer for managing the transmission and reception of IP packet fax messages using the Transmission Control Protocol on a secure logical transmission channel between said CPRU and the wireless access network; and
an Internet Fax Protocol (IFP) layer for managing the transmission and reception of IP packet fax messages using the Internet Fax Protocol T.38 protocols between said CPRU and the wireless access network.

37. The CPRU of claim 35, in which said IP packet fax messages comprise fax messages, said functionality for managing fax message transmissions comprising:
functionality for managing the physical interface between said CPRU and a facsimile device; and
functionality for managing the transmission protocols for the transmission of fax messages between said CPRU and a facsimile device.

38. A subscriber management platform for managing the nodes of a wireless access system, said subscriber management platform comprising:
a gateway management platform for managing gateways of a wireless access system;
a router management platform for managing access routers of a wireless access system;
a terminal management platform for managing Customer Premise Radio Units (CPRUs) of a wireless access system; and
a base station system management platform for managing base stations and Wireless Adjunct InteRnet Platforms (WARPs) of a wireless access system.

39. The subscriber management platform of claim 38, in which said gateway management platform further manages H.323 gatekeepers of a wireless access system.

40. The subscriber management platform of claim 38, in which said base station system management platform comprises functionality for managing the Simple Network Management Protocol (SNMP) for transmission of management data between said base station system management platform and a WARP in the wireless access system, said base station system management platform further comprising functionality for managing the Transmission Control Protocol (TCP) for the transmission of management data on a secure logical channel between said base station system management platform and a WARP in the wireless access system and the User Datagram Protocol (UDP) for the transmission of management data on an unsecure logical channel between said base station system management platform and a WARP in the wireless access system.

41. The subscriber management platform of claim 38, in which said terminal management platform comprises functionality for managing the Simple Network Management Protocol (SNMP) for transmission of management data between said terminal management platform and a CPRU in the wireless access system, said terminal management platform further comprising functionality for managing the Transmission Control Protocol (TCP) for the transmission of management data on a secure logical channel between said terminal management platform and a CPRU in the wireless access system and the User Datagram Protocol (UDP) for the transmission of management data on an unsecure logical channel between said terminal management platform and a CPRU in the wireless access system.
